(19) United States
(12) Patent Application Publication
(10) Pub. No.: US 2012/0005121 A1
(43) Pub. Date: Jan. 5, 2012

(54) SYSTEMS AND METHODS FOR DETERMINING AN AVERAGE RETIREMENT AGE INDEX

(75) Inventors: Harry Alan Newman, Fair Lawn, NJ (US); Richard A. Colombo, Riverside, CT (US); Mary Hegarty Colombo, Riverside, CT (US)

(73) Assignee: NEWMAN COLOMBO FINANCIAL RESEARCH LLC, Fair Lawn, NJ (US)

(21) Appl. No.: 13/164,436

(22) Filed: Jun. 20, 2011

Related U.S. Application Data
(63) Continuation-in-part of application No. 12/977,678, filed on Dec. 23, 2010.
Application No. 12/977,678 is a continuation-in-part of application No. 12/828,610, filed on Jul. 1, 2010.

(51) Int. Cl. G06Q 40/00

(52) U.S. Cl. 705/36 R

(57) ABSTRACT

Systems and methods for determining an average retirement age index, the index including a year and week. The method determines a wealth at death of an average couple for a first retirement age. If wealth at death is greater than zero, the retirement age is decreased by one and the wealth at death value is recalculated. This process continues until the wealth at death value is less than zero, at which point the year of the retirement age index is determined by adding one to the current year of the retirement age. The week of the retirement age index is determined by: dividing the opposite of a wealth at death value for the year prior to the year of the average retirement age index by a wealth delta and multiplying the result by fifty-two.

### CROSS-REFERENCE TO RELATED APPLICATIONS

This application claims the benefit of and is a continuation-in-part of the U.S. non-provisional patent application entitled “Systems and Methods for Determining a United States Average Retirement Age Index”, having Ser. No. 12/977,678, filed Dec. 23, 2010, which is a continuation-in-part of the U.S. non-provisional patent application entitled “Systems and Methods for Determining a United States Average Retirement Age Index”, having Ser. No. 12/828,610, filed Jul. 1, 2010, both of which are hereby incorporated by reference in their entirety as if fully set forth herein.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright whatsoever.

### INCORPORATION-BY-REFERENCE OF MATERIAL SUBMITTED VIA .PDF FILES

The computer program listing appendix attached hereto is incorporated by reference in its entirety as if fully set forth herein and it includes two .pdf files entitled formulas.pdf (84 pp., 252 KB) and values.pdf (16 pp., 179 KB) depicting the formulas and values, respectively, included in each cell of an Excel spreadsheet depicting one embodiment of the present invention.

### BACKGROUND OF THE INVENTION

Embodiments of the present invention generally relate to systems and methods for determining an average retirement age index. More specifically, the present invention relates to systems and methods for determining an average retirement age index such as a U.S. average retirement age index. Such an index would serve as an indicator of economic conditions in the U.S. (or other country) and would provide an important benchmark to be closely watched by investors, economists, firms, and the general public for use in making economic decisions.

Economic indicators are known. One such economic indicator is the Consumer Price Index (“CPI”). The CPI is a measure of inflation and is updated on a monthly basis. Specific data about the cost of thousands of products are included in the analysis of inflation. Rising costs for such products result in an increase in the CPI. Another such indicator is the Employment Cost Index (“ECI”). This indicator is also used as a prediction tool for inflation. The ECI is calculated based upon the cost to employ an individual including wages, benefits, and bonuses. An increase in the ECI often precipitates a rise in inflation because rising employer costs are generally passed to consumers in the form of higher prices.

Another known economic indicator is the Gross Domestic Product (“GDP”) indicator. The GDP is the widest measure of the economy and represents the aggregated monetary value of all goods and services produced by the entire U.S. economy. The GDP is updated on a quarterly basis. The data included in the calculation of the GDP includes personal expenditures, investments in capital by businesses and individuals, and government expenditures for final goods and services.

### BRIEF SUMMARY OF THE INVENTION

Briefly stated, in one aspect of the present invention, a method for calculating an average retirement age index is provided. This method includes the following steps: calculating, using a microprocessor, a wealth at death of an average couple living in a country for a first retirement age, the determining including the sub-steps of: setting, using a microprocessor, an average employment age of the average couple to a first age value; setting, using a microprocessor, an average retirement age of the average couple to a second age value; setting, using a microprocessor, an age of death of the average couple to a third age value; calculating, using a microprocessor, a cumulative combined pension of the average couple for each age of the average couple beginning with the first age value and ending with the third age value, the calculating performed upon cumulative combined pension data, at least a portion of the cumulative combined pension data selected from the group consisting of a contribution to the pension of the average couple, a growth rate of the pension, withdrawals from the pension, and combinations thereof, at least a portion of the cumulative combined pension data derived from statistical data for an average family living in the country; and calculating, using a microprocessor, a wealth at death value at the third age value based upon the calculated cumulative combined pension and the statistical data for an average family living in the country; and decreasing the retirement age by one; repeating the calculating the wealth at death value step and the decreasing the retirement age by one step until the wealth at death value is less than zero to determine a year prior to a year of the average retirement age index; and determining the year of the average retirement age index by adding one to the year prior to the year of the average retirement age index, wherein an initial value of the second age value is equal to the third age value.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings and computer program listing. For the purpose of illustrating the invention, there is shown in the drawings embodiments which are presently preferred. It should be understood, however, that the invention is not limited to the precise arrangements and instrumentalities shown. In the drawings:

FIGS. 1A and 1B depict a flowchart of the steps of a process for determining a U.S. Average Retirement Age Index in accordance with one embodiment of the present invention;

FIG. 2 depicts a flowchart of the steps of a process for determining a Pension Growth Rate in accordance with one embodiment of the present invention;

FIGS. 3A-3B depict a flowchart of the steps of a process for determining a Contribution to Pension in accordance with one embodiment of the present invention;

FIGS. 4A-4D depict a flowchart of the steps of a process for determining Wages in accordance with one embodiment of the present invention;

FIG. 5 depicts a flowchart of the steps of a process for determining Wage Inflation Rates in accordance with one embodiment of the present invention;

FIGS. 6A-6B depict a flowchart of the steps of a process for determining Pension Withdrawals in accordance with one embodiment of the present invention;

FIGS. 7A-7B depict a flowchart of the steps of a process for determining Current Year's Beginning of Year Savings/Debt in accordance with one embodiment of the present invention;

FIG. 8 depicts a flowchart of the steps of a process for determining a Current Year's Cash Surplus or Deficit in accordance with one embodiment of the present invention;

FIGS. 9A-9C depict a flowchart of the steps of a process for determining Pretax Income in accordance with one embodiment of the present invention;

FIGS. 10A-10C depict a flowchart of the steps of a process for determining a Marginal Tax on Pension Income in accordance with one embodiment of the present invention;

FIG. 11 depicts a flowchart of the steps of a process for determining Social Security Benefits in accordance with one embodiment of the present invention;

FIG. 12 depicts a flowchart of the steps of a process for determining Social Security and Medicare Taxes in accordance with one embodiment of the present invention;

FIGS. 13A-13B depict a flowchart of the steps of a process for determining Inflation Adjusted Expenditures in accordance with one embodiment of the present invention;

FIG. 14 depicts a flowchart of the steps of a process for determining the sum of Pension Contributions and Social Security Taxes in accordance with one embodiment of the present invention;

FIG. 15 depicts a flowchart of the steps of a process for determining Non-Pension Taxable Income in accordance with one embodiment of the present invention;

FIG. 16 depicts a flowchart of the steps of a process for determining the Interest Income or Expense in accordance with one embodiment of the present invention;

FIG. 17 depicts a flowchart of the steps of a process for determining Federal and State Taxes on Non-Pension Income in accordance with one embodiment of the present invention;

FIG. 18 depicts a flowchart of the steps of a process for determining the Total Income After Taxes in accordance with one embodiment of the present invention;

FIG. 19 depicts a flowchart of the steps of a process for determining a State Tax Rate in accordance with one embodiment of the present invention;

FIG. 20 depicts a flowchart of the steps of a process for determining a Consumer Price Index Inflation Rate in accordance with one embodiment of the present invention;

FIG. 21 depicts a flowchart of the steps of a process for determining Taxes Payable for each tax bracket in accordance with one embodiment of the present invention;

FIG. 22 is a block diagram of an example of a computing environment within which various embodiments of the present invention may be implemented;

FIGS. 23A-23B depict a flowchart of the steps of a process for determining Pension Withdrawals in accordance with an alternate embodiment of the present invention;

FIGS. 24A-24B depict a flowchart of the steps of a process for determining Current Year's Beginning of Year Savings/Debt in accordance with an alternate embodiment of the present invention; and

FIGS. 25A-25B depict a flowchart of the steps of a process for determining a Pension Growth Rate in accordance with an alternate embodiment of the present invention.

### DETAILED DESCRIPTION OF THE INVENTION

Where a term is provided in the singular, the inventors also contemplate aspects of the invention described by the plural of that term. As used in this specification and in the appended claims, the singular forms “a”, “an” and “the” include plural references unless the context clearly dictates otherwise, e.g., “a step” may include a plurality of steps. Thus, for example, a reference to “a method” includes one or more methods, and/or steps of the type described herein and/or which will become apparent to those persons skilled in the art upon reading this disclosure.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods, constructs and materials are now described. All publications mentioned herein are incorporated herein by reference in their entirety. Where there are discrepancies in terms and definitions used in references that are incorporated by reference, the terms used in this application shall have the definitions given herein.

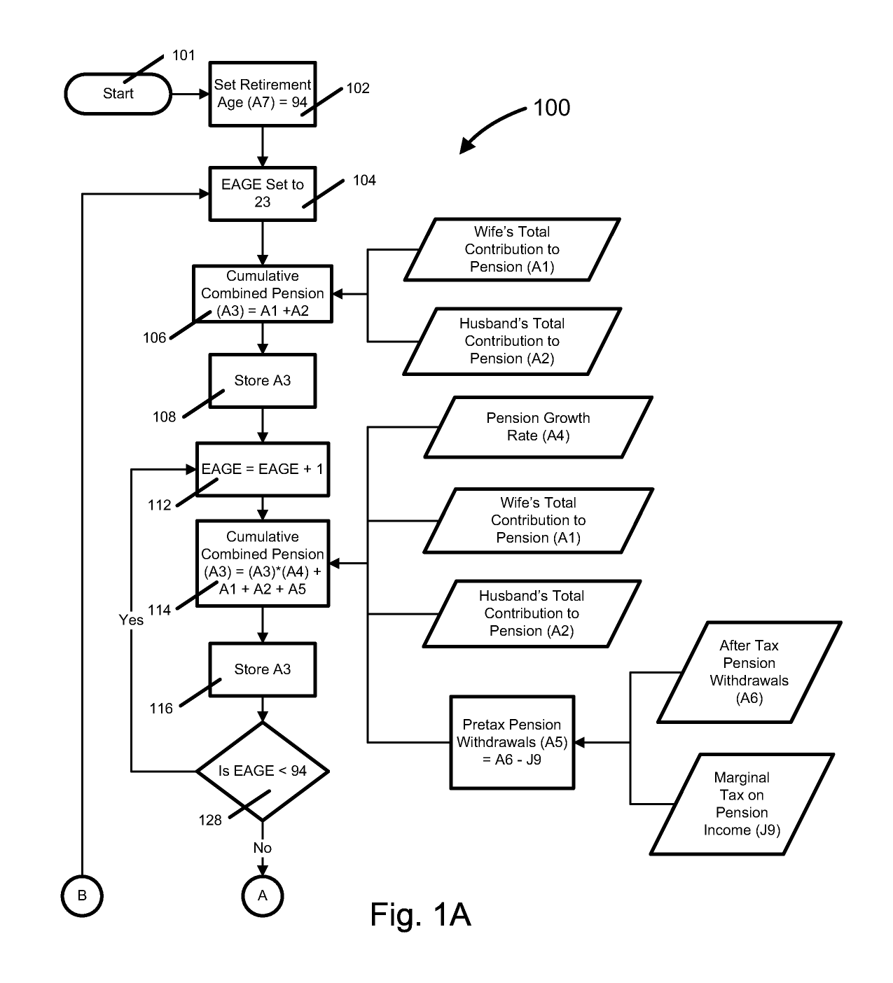

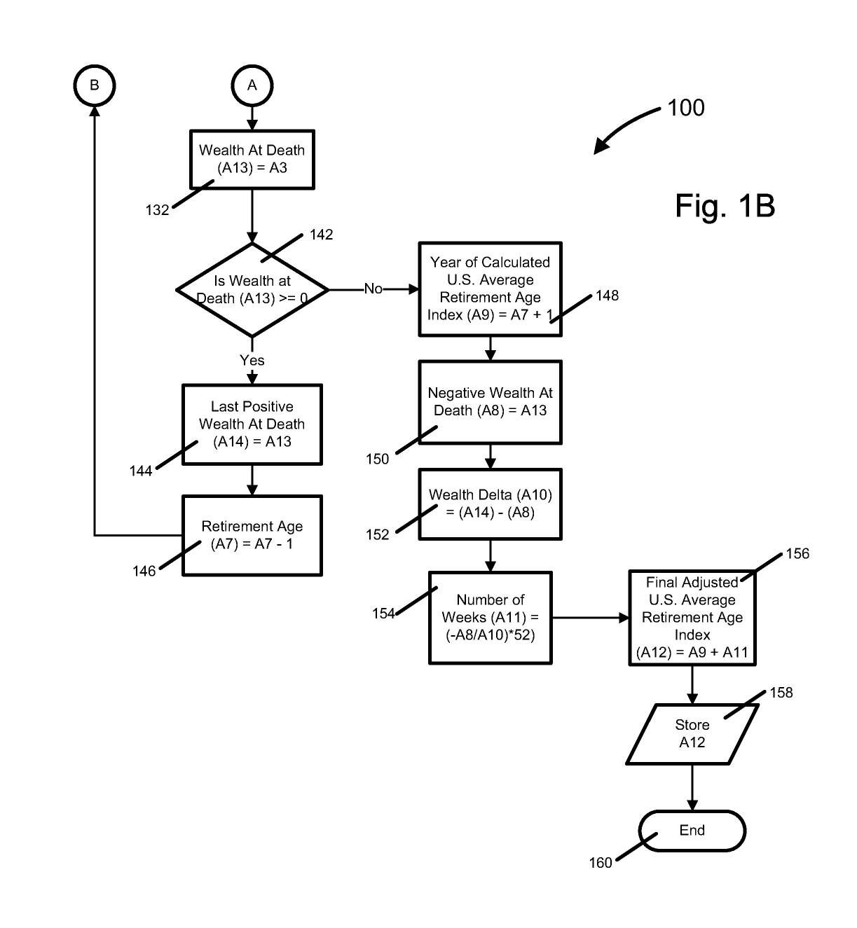

Referring first to FIGS. 1A and 1B, depicted is a method for determining a U.S. Average Retirement Age Index in accordance with one embodiment of the present invention. Process 100 begins at 101, at which a user wishes to determine the U.S. Average Retirement Age Index. Process 100, for example, may occur on a monthly basis and may be published as an economic indicator similar to the Consumer Price Index (“CPI”). The CPI is published on a monthly basis by the Bureau of Labor Statistics and is closely monitored as a measure of inflation. Increased cost of goods to consumers is reflected by an increase in the CPI. Similarly, the U.S. Average Retirement Age Index may be published on a periodic basis as an indicator of the economic conditions in the U.S. For example, an upward trend in a periodically published U.S. Average Retirement Age Index may indicate a negative economic condition in which increases in wages are expected to be lower than previously expected or, due to changes in stock market performance, pensions are expected to grow at a slower rate than previously expected. Conversely, a downward trend in a periodically published U.S. Average Retirement Age Index may indicate a positive economic condition in which increases in wages are expected to be greater than previously expected or, due to changes in stock market performance, pensions are expected to grow at a greater rate than previously expected. Process 100 for determining such an index is capable of evaluating both positive and negative economic conditions simultaneously.

At 102, a user of process 100 sets the average Retirement Age of the couple (i.e., variable A7) to a fixed value. In our exemplary embodiment, variable A7 will be set to 94; however, other values may be inputted. That is, process 100 begins at the highest anticipated retirement age and continually reduces the retirement age by one until the U.S. average retirement age is found. This U.S. average retirement age is the average age at which a couple living in the U.S. may retire with sufficient pension to live at a maintained standard of living until death. The present invention assumes that the couple's wealth is depleted to zero at the age of their death. A retirement age of 94 is considered to be a worst case value because it assumes no retirement for the couple as death is assumed to occur when they are 94 years old, just prior to their 95^{th} birthday. This age is determined based on the age to which approximately 10% of the U.S. population survives as determined by the National Center for Health Statistics' United States Life. Tables, 2003, Table 1.

At 104, a user inputs the average age at which a couple completes college and becomes employed, or the average age of the couple during their first year of employment. The employment age variable (i.e., “EAGE”) is set to this value. This value may be estimated as the age at which the average person finishes college. In the exemplary embodiment of the present invention, the EAGE variable is set to a value of twenty-three (23). Process then proceeds to 106.

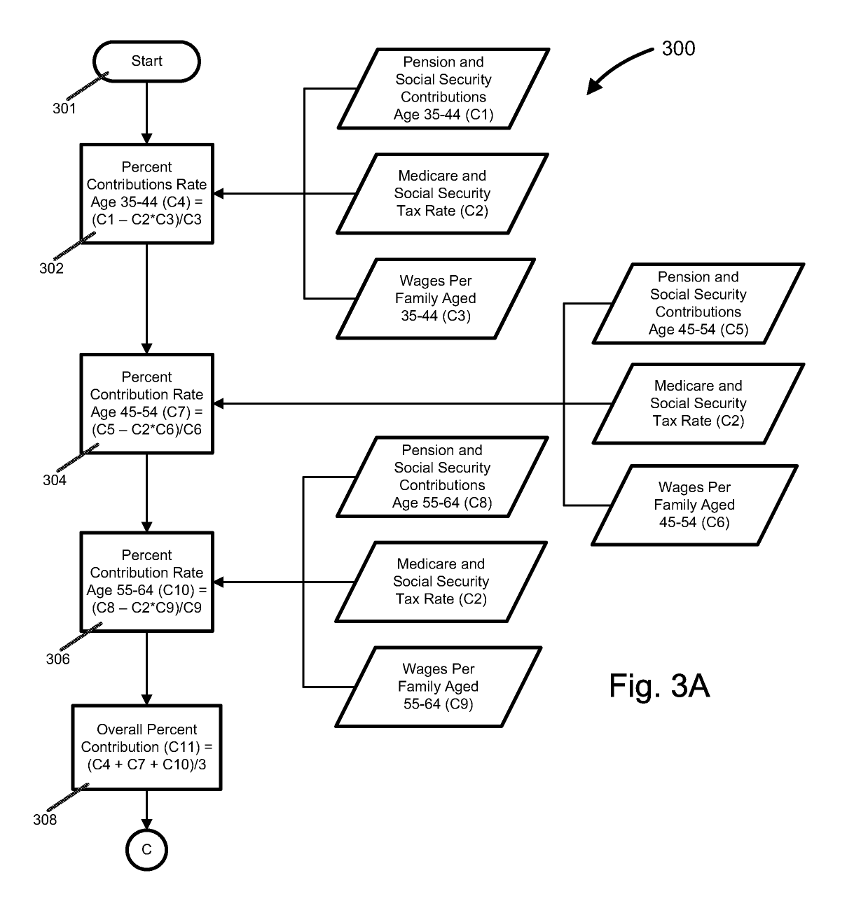

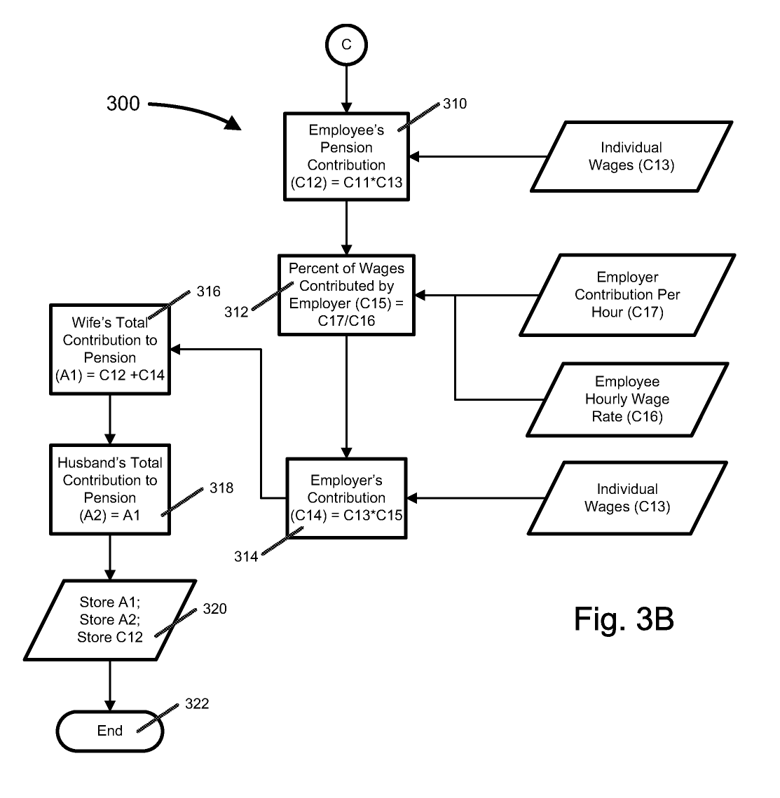

Next, at 106, the cumulative combined pension (i.e., variable A3) is determined. The cumulative combined pension is the total value of the pension (earned, saved, contributed by employer, etc.) by the husband and the wife when their age is equal to the value of EAGE. It is calculated by summing the wife's annual pension contribution including pension contributed by the wife as well as pension contributed by the wife's employer (i.e., variable A1) and the husband's annual pension contribution including pension contributed by the husband as well as pension contributed by the husband's employer (i.e., variable A2). The values of variables A1 and A2 are determined via the flowchart depicted in FIGS. 3A and 3B, respectively, as discussed in greater detail below. Variable A3 is then set to the summed value of variables A1 and A2, which equals the couple's total cumulative combined pension at the end of their first year of contribution at age EAGE. Process 100 then proceeds to 108, at which variable A3 is stored in a table corresponding to the current value of EAGE. Next, process 100 proceeds to 112, at which the EAGE variable is incremented by one, and process 100 proceeds to step 114.

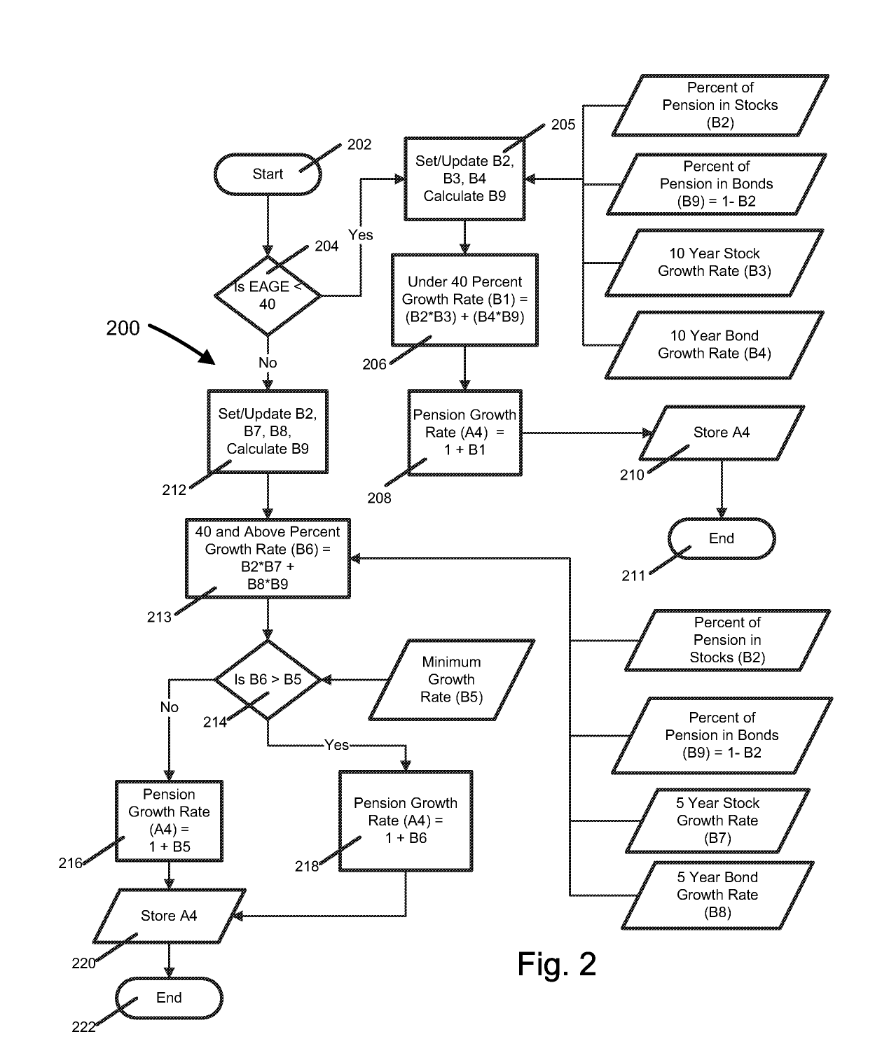

At step 114, the value of the cumulative combined pension at the end of the year in which the age of the couple is equal to EAGE is determined. In the exemplary embodiment depicted in FIG. 1, EAGE is now 24. The cumulative combined pension at the new EAGE is determined by first reading the current cumulative combined pension variable A3 and multiplying it by the pension growth rate (i.e., variable A4). The pension growth rate represents the return rate for stocks and bonds and it is determined via the flowchart depicted in FIG. 2 as discussed in greater detail below. This multiplication accounts for growth in the couple's pension due to interest, dividends, and stock price fluctuations for the stocks and bonds in their portfolio.

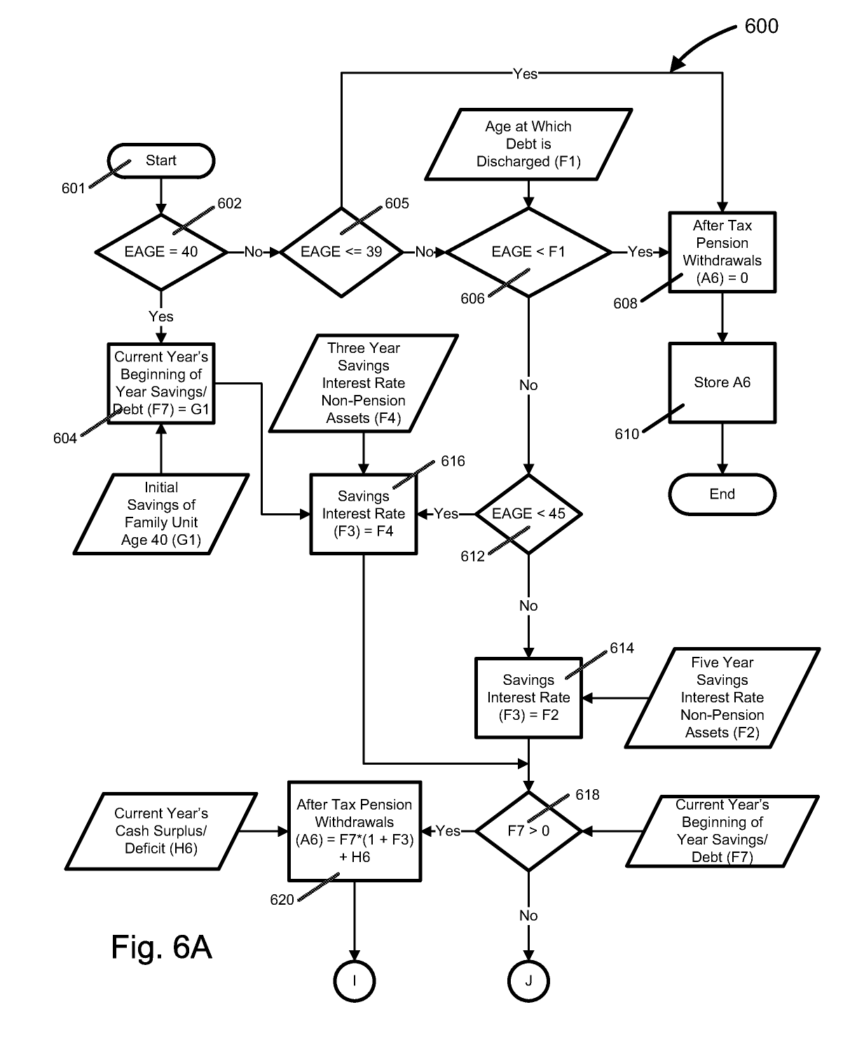

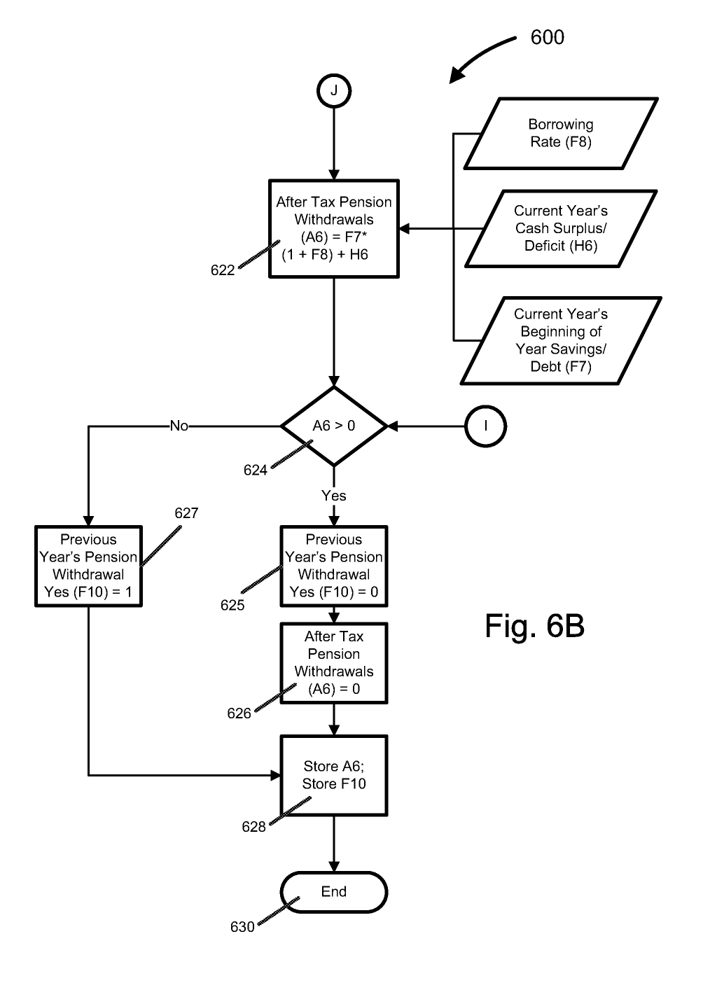

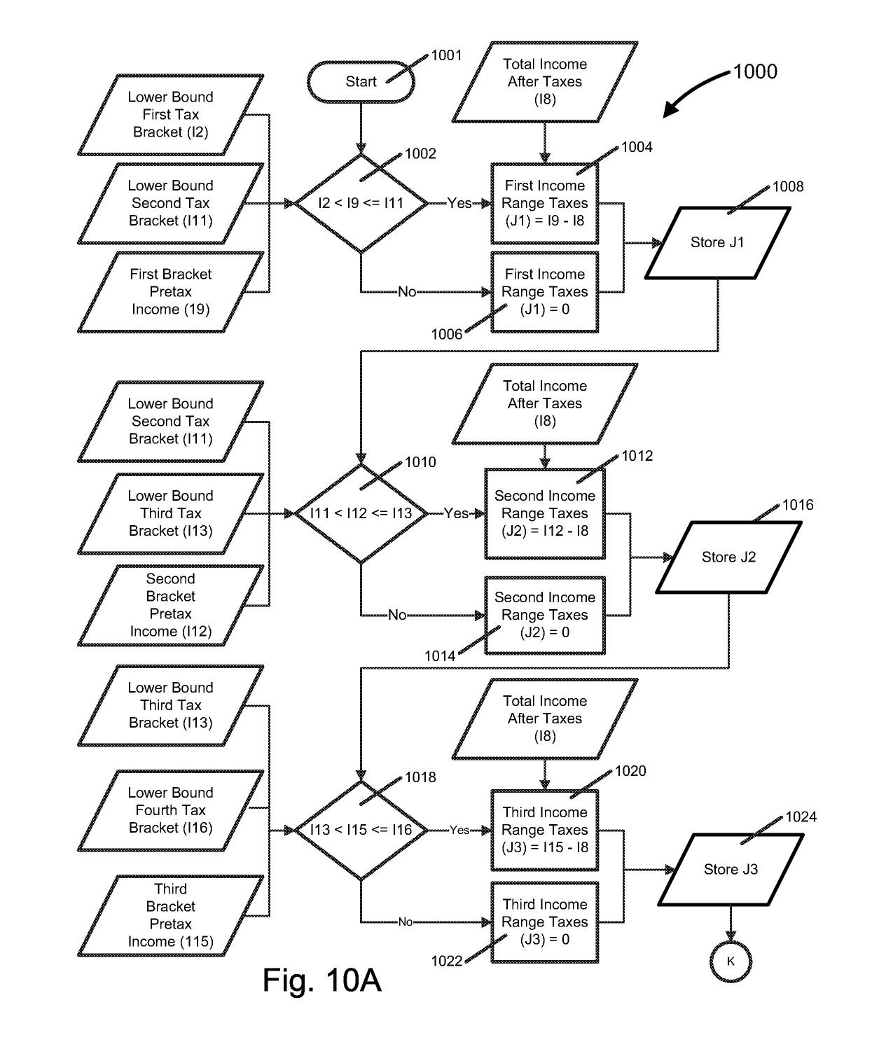

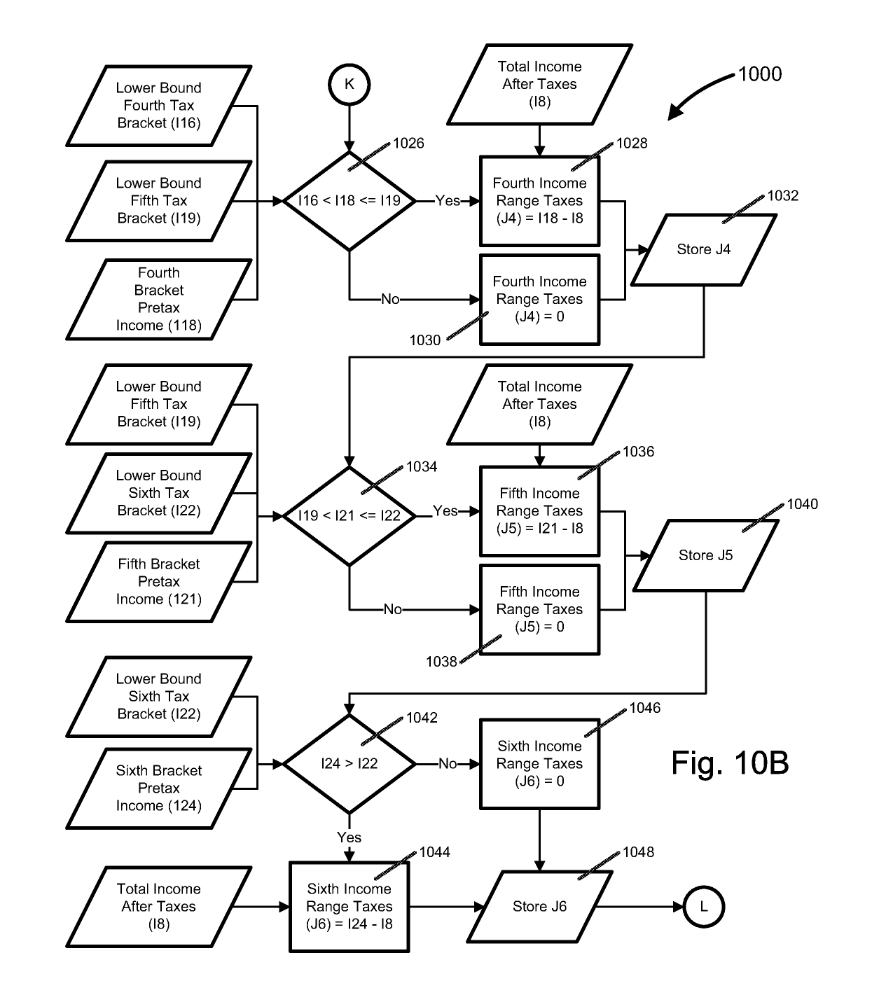

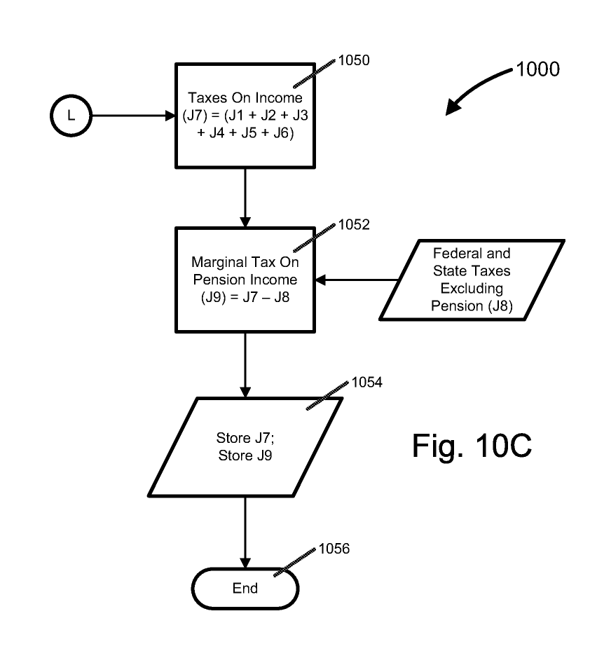

The product is then added to the wife's total contribution to pension variable A1 and the husband's total contribution to pension variable A2 for the year in which the couple's age is equal to the value of the EAGE variable. Again, the values of variables A1 and A2 are determined via the flowchart depicted in FIGS. 3A and 3B, respectively, as discussed in greater detail below. As EAGE is manipulated, the values of variables A1 and A2 are also changed; necessitating recalculation of A1 and A2 each time they are utilized. From this value, the value of any pretax pension withdrawals (i.e., variable A5, wherein said variable is a negative number) is added. Variable A5 is determined by subtracting marginal tax on pension income (i.e., J9) from after tax pension withdrawals (i.e., A6), which are determined by calculations depicted in FIGS. 10A-10C and 6A-6B, respectively, as further discussed below. Process 100 then proceeds to 116, at which the newly calculated value of variable A3 is stored in a table corresponding to the current value of EAGE. Although the depicted embodiment stores the value of the current cumulative combined pension variable A3 in a table, other methods of storing such values may be substituted (e.g., a database).

Next, at step 128, process 100 queries the EAGE variable and, if it is less than 94, process 100 returns to step 112 and repeats steps 112 through 116 until EAGE is greater than or equal to 94. Every iteration of steps 112 through 116 increases the value of variable A3 for each successive year prior to the age at which debt discharged, as discussed in greater detail below, and stores this value in a table in a manner in which the value corresponds to the current value of EAGE. For each successive year after the age at which debt is discharged for which the couple is retired, every iteration of steps 112 through 116 decreases the value of variable A3 for all EAGE values through age 94. All values for A3 are stored in a table in a manner in which the value corresponds to the associated value of EAGE.

If, at 128, the value of the EAGE variable is not less than 94, then the value of the EAGE variable has increased to equal the age to which the couple is expected to die. At this point, the table of cumulative combined pension values (i.e., variable A3) has been populated for each value of EAGE from 23 to 94. Process 100 then proceeds to 132 (FIG. 1B). At step 132, the wealth at death variable (i.e., A13) is set to equal the value of the cumulative combined pension variable (i.e., A3) when the value of EAGE is 94 (i.e., the age at which the couple is expected to die). In the first iteration of steps 102 through 132, the retirement age is equal to the assumed age at death. That is, in the first iteration of these steps, the value of the wealth at death variable A13 represents the amount of money a couple will have left at death if they work for their entire lives without any retirement. Each successive iteration of steps 102 through 132, if any, will decrease the retirement age by one. Successive iterations occur until the value of the wealth at death variable A13 is less than zero.

At 142, process 100 queries the value of the wealth at death variable A13 and, if it is greater than or equal to zero, process 100 proceeds to 144 at which the value of a last positive wealth at death variable (i.e., variable A14) is set to the current value of the wealth at death variable A13. This variable is used later in the process in step 152. Process 100 then proceeds to 146, at which the value of the retirement age variable A7 is reduced by one. Reducing the retirement age by one allows the couple to work and contribute to their pension for one year less, thus reducing the value of their wealth at death. Process 100 then returns to step 104 (FIG. 1A), at which the value of the EAGE variable is reset to 23, or some other variable selected by the user or an automated processing unit as discussed above. Process 100 then repeats steps 106 through 132 to re-populate the table of cumulative combined pension values (i.e., variable A3) for each value of EAGE from 23 to 94. The new values of variable A3 will differ from the previous values of variable A3 due to the change in the value of the retirement age variable A7 made at step 146.

Process 100 then proceeds to step 142 and again determines whether the value of the wealth at death variable A13 is greater than or equal to zero. If yes, the value of the last positive wealth at death variable A14 is set to the value of the wealth at death variable A13 (at step 144) and the retirement age variable A7 is decremented (at step 146), and process 100 returns to step 104 as discussed above. Process 100 continues in this fashion until the value of the wealth at death variable A13 is less than zero when queried at 142.

When, at 142, the value of the wealth at death variable A13 is less than zero, process 100 proceeds to step 148, at which the year of the calculated U.S. average retirement age index (i.e., variable A9) is set to equal the current value of the retirement age variable A7 plus one (i.e., the calculated U.S. average retirement age is set to equal the year after the current value of variable A7 to allow the couple to avoid having a negative wealth at death). The current value of variable A7 is the first retirement age for which process 100 yields a negative value for wealth at death. Process 100 then proceeds to 150 at which the value of the negative wealth at death (i.e., variable A8) is set to equal the current value of the wealth at death variable A13.

Next, process 100 proceeds to 152, at which the value of the wealth delta variable (i.e., variable A10) is determined. The wealth delta value is calculated by subtracting the value of the negative wealth at death variable A8 from the value of the last positive wealth at death variable A14. This facilitates calculation of the weeks portion of the U.S. average retirement age. That is, this average retirement age is comprised of a year plus some number of weeks, wherein the year is based upon the age at which wealth was last positive at death and the weeks is influenced by the last positive wealth at death value and the first negative wealth at death value. Process 100 then proceeds to step 154, at which it determines the number of weeks (i.e., variable A11) past the year of the calculated U.S. average retirement age index (i.e., the value of variable A9) at which a couple may retire, maintain their standard of living, and deplete their wealth by the age of death. At 154, the number of weeks is calculated by dividing the negative value of variable A8 by A10 and multiplying the product by 52. Process 100 then proceeds to 156.

At 156, the final calculated U.S. average retirement age index (i.e., A12) is determined by adding the calculated number of weeks A11 to the year of the calculated U.S. average retirement age index (i.e., the value of variable A9). At this step, the calculated U.S. average retirement age may be read by the user or an automated processing unit and/or outputted in some other manner (e.g., displayed on a computer screen, printed, e-mailed, etc.) via commonly known methods. Process 100 then proceeds to 158 at which the final adjusted U.S. average retirement age index A12 is stored. Process 100 then proceeds to 160 at which it ends.

Turning now to FIG. 2, a process 200 for the determining pension growth rate is depicted. As previously discussed, the pension growth rate is indicative of the return rate on stocks and bonds. Process 200 begins at 202 from which it proceeds to 204. At 204, process 200 queries the EAGE variable to determine if it is less than forty. If yes, process 200 proceeds to 205, at which the variables B2, B3, and B4 are initially set or are updated with the latest available data, as described in greater detail below, and the value of B9 is calculated.

In the exemplary embodiment of the present invention, the percent of pension in stocks variable B2 is estimated to be 0.5, or 50%, however, alternate data may be used for variable B2 without departing from the scope of the present invention. The percent of pension in bonds variable (i.e., variable B9) is calculated by subtracting the percent of pension in stocks variable B2 from 1. It should also be noted that differing values for variable B2 (and consequently variable B9) may be used for differing values of the EAGE variable. For example, in one alternate embodiment of the present invention, the value of variable B2 may equal 0.5, or 50%, whenever the value of the EAGE variable is less than seventy and the value of the B2 variable may equal 0.3, or 30%, whenever the value of the EAGE variable is greater than seventy.

Since the exemplary embodiment of the present invention assumes the initial employment age to be 23, the pension growth rate below forty is determined based on the average return rate for the prior ten years. These values for the growth rate are initially inputted by the user or an automated processing unit and are updated every month. The average return rate for the last ten years can be found on the Internet via http://www.tiaa-cref.org/public/performance/retirement/index.html. This Web page provides the user with the information required for the B3 and B4 variables. This information may be manually entered by the user or an automated processing unit via a personal computer or the like or process 200 may be programmed to automatically read the data from the Web page using known methods. Process 200 will set the 10 Year Stock Growth Rate variable (i.e., variable B3) to the value provided by the Web Page for the “Equity Index” value for the 10 year Average Annual Total Returns. Process 200 will set the 10 Year Bond Growth Rate variable (i.e., variable B4) to the value provided by the Web Page for the “Bond Market” for the 10 year Average Annual Total Returns. Although the depicted embodiment uses a ten (10) year time period for the values of variables B3 and B4, shorter or longer time periods may be substituted without departing from the scope of the present invention including, but not limited to, fifteen (15) years.

Once the data variables B2, B3, and B4 have been set, or updated, and B9 has been calculated, process 200 proceeds to step 206. At 206, the value of the under 40 percent growth rate (i.e., variable B1) is calculated by summing weighted stock and bond growth rates. The weighted value for stock growth is determined by multiplying the percent of pension in stocks variable B2 by the 10 year stock growth rate variable B3. The weighted value for bond growth is determined by multiplying the percent of pension in bonds variable B9 by the 10 year bond growth rate variable B4.

After the under 40 percent growth rate is determined at 206, process 200 proceeds to 208 at which the value of the pension growth rate variable A4 is calculated by adding 1 to the value of the under 40 percent growth rate B1. Process 200 then proceeds to 210, at which the value of variable A4 is stored in a memory location for future use and process 200 ends at 211.

If step 204 queries the EAGE variable and determines that it is greater than or equal to forty, process 200 proceeds to 212. At 212, the variables B2, B7, and B8 are initially set or are updated with the latest available data, as described in greater detail below, and the value of B9 is calculated.

In the exemplary embodiment of the present invention, the percent of pension in stocks variable B2 is estimated to be 0.5, or 50%, however, alternate data may be used for variable B2 without departing from the scope of the present invention. The percent of pension in bonds variable (i.e., variable B9) is calculated by subtracting the percent of pension in stocks variable B2 from 1. Process 200 proceeds to 213.

At 213, the 40 and above percent growth rate value is calculated similar to the manner in which the under 40 percent growth rate value is calculated. However, the 40 and above percent growth rate utilizes 5 year data averages in lieu of 10 year data averages.

These values for the growth rate are initially inputted by the user or an automated processing unit and are updated every month. The average return rate for the last five years can be found on the Internet via http://www.tiaa-cref.org/public/performance/retirement/index.html. This Web page provides the user with the information required for the B7 and B8 variables. This information may be manually entered by the user via a personal computer or the like or process 200 may be programmed to automatically read the data from the Web page using known methods. Process 200 will set the 5 Year Stock Growth Rate variable (i.e., variable B7) to the value provided by the Web Page for the “Equity Index” value for the 5 year Average Annual Total Returns. Process 200 will set the 5 Year Bond Growth Rate variable (i.e., variable B8) to the value provided by the Web Page for the “Bond Market” for the 5 year Average Annual Total Returns. Although the depicted embodiment uses a five (5) year time period for the values of variables B7 and B8, shorter or longer time periods may be substituted without departing from the scope of the present invention including, but not limited to, twenty (20) years.

Once the data variables B2, B7, and B8 have been set, or updated, and B9 has been calculated, process 200 proceeds to step 213. At 213, the value of the 40 and above percent growth rate (i.e., variable B6) is calculated by summing weighted stock and bond growth rates. The weighted value for stock growth is determined by multiplying the percent of pension in stocks variable B2 by the 5 year stock growth rate variable B7. The weighted value for bond growth is determined by multiplying the percent of pension in bonds variable B9 by the 5 year bond growth rate variable B8.

After the 40 and above percent growth rate is determined at 213, process 200 proceeds to 214 at which the value of the 40 and above percent growth rate variable B6 is compared to the value of a minimum growth rate variable (i.e., variable B5). In the exemplary embodiment of the present invention, the value of the minimum growth rate for persons forty and above is set to 0.03, or 3%. This value is used to prevent an unrealistic pension plan growth rate from being applied by process 200 whenever EAGE is greater than or equal to forty. Such an unrealistic growth rate could occur if the stock market were to decrease dramatically. Although 3% is used in the exemplary embodiment, other minimum growth rates may be substituted without departing from the scope of the present invention.

If, at 214, the 40 and above percent growth rate is less than or equal to the minimum growth rate, process 200 proceeds to 216, at which the value of the pension growth rate variable A4 is calculated by adding 1 to the value of the minimum growth rate variable B5. Alternatively, if, at 214, the 40 and above percent growth rate is greater than the minimum growth rate, process 200 proceeds to 218, at which the value of the pension growth rate variable A4 is calculated by adding 1 to the value of the 40 and above percent growth rate variable B6. Process 200 then proceeds to 220, at which the value of variable A4 is stored in a memory location for future use and, process 200 ends at 222. It should be noted that a single average, rather than a five and ten average, may be substituted without departing from the scope of the present invention.

Now referring to FIGS. 3A and 3B, depicted is a method 300 for determining annual contribution to a pension by a pair of individuals, or couple, for example, a “wife” and a “husband”. The present invention determines the U.S. average retirement age based upon a couple equally contributing to their pension each year. Method 300 begins at 301 and proceeds to step 302, at which percent of wages contributed to pension for people aged 35-44 (i.e., variable C4) is determined. Variable C4 is calculated by subtracting the product of Medicare and Social Security tax rate (i.e., variable C2) and wages per family aged 35-44 (i.e., variable C3) from the pension and Social Security contributions for ages 35-44 (i.e., variable C1). The difference is then divided by variable C3 to create a percent contribution rate for ages 35-44 (i.e., variable C4). The Medicare and Social Security tax rate (i.e., variable C2) is set by the user or an automated processing unit to reflect the current tax rates as stipulated by law. The wages per family aged 35-44 (i.e., variable C3) is to be updated annually and can be found online at http://www.bls.gov/cex/. Currently, this value is found in a PDF document accessed by clicking the “CE Tables” link and then the PDF link to “Age of reference person”. In the PDF document, the user can find the necessary data under “Wages and salaries” for people aged 35-44. Variable C1 is also updated annually and can be found in the same document as variable C2 under the 35-44 age range for “Pensions and Social Security”.

It should be understood that for all values referenced throughout this document that are required to be input by the user or an automated processing unit and/or updated on a periodic basis, this information may be manually entered by the user via a personal computer, specialized computer, or the like. Or, when such information is available via computerized means (e.g., via the Internet), process 100 may be programmed to automatically read the data via the Internet using known methods.

Method 300 then proceeds to step 304, at which percent of wages contributed to pension for people aged 45-54 (i.e., variable C7) is determined. Variable C7 is calculated by subtracting the product of Medicare and Social Security tax rate (i.e., variable C2) and wages per family aged 45-54 (i.e., variable C6) from the pension and Social Security contributions for ages 45-54 (i.e., variable C5). The difference is then divided by variable C6 to create a percent contribution rate for ages 45-54. Variable C2 is discussed above. The wages per family unit ages 45-54 (i.e., variable C6) is to be updated annually and can be found online at http://www.bls.gov/cex/. This value is found in a PDF document accessed by clicking the “CE Tables” link and then the PDF link to “Age of reference person”. In the PDF document, the user can find the necessary data under “Wages and salaries” for people aged 45-54. Variable C5 is also updated annually and can be found in same document as variable C6 under the 45-54 age range for “Pensions and Social Security”.

Process 300 then proceeds to step 306, at which percent of wages contributed to pension for people aged 55-64 (i.e., variable C10) is determined. Variable C10 is calculated by subtracting the product of Medicare and Social Security tax rate (i.e., variable C2) and wages per family aged 55-64 (i.e., variable C9) from the pension and Social Security contributions for ages 55-64 (i.e., variable C8). The difference is then divided by variable C9 to create a percent contribution rate for ages 55-64. Variable C2 is discussed above. The wages per family unit ages 55-64 (i.e., variable C9) is to be updated annually and can be found online at http://www.bls.gov/cex/. This value is found in a PDF document accessed by clicking the “CE Tables” link and then the PDF link to “Age of reference person”. In the PDF document, the user can find the necessary data under “Wages and salaries” for people aged 55-64. Variable C8 is also updated annually and can be found in same document as variable C9 under the 55-64 age range for “Pensions and Social Security”.

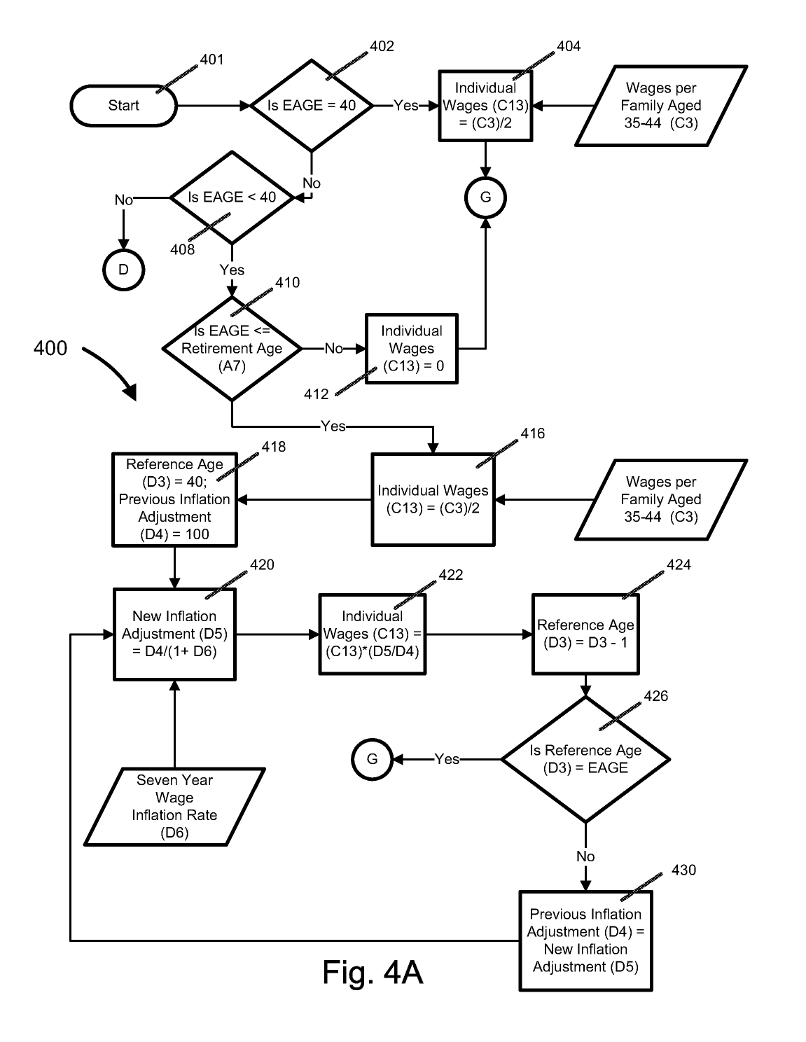

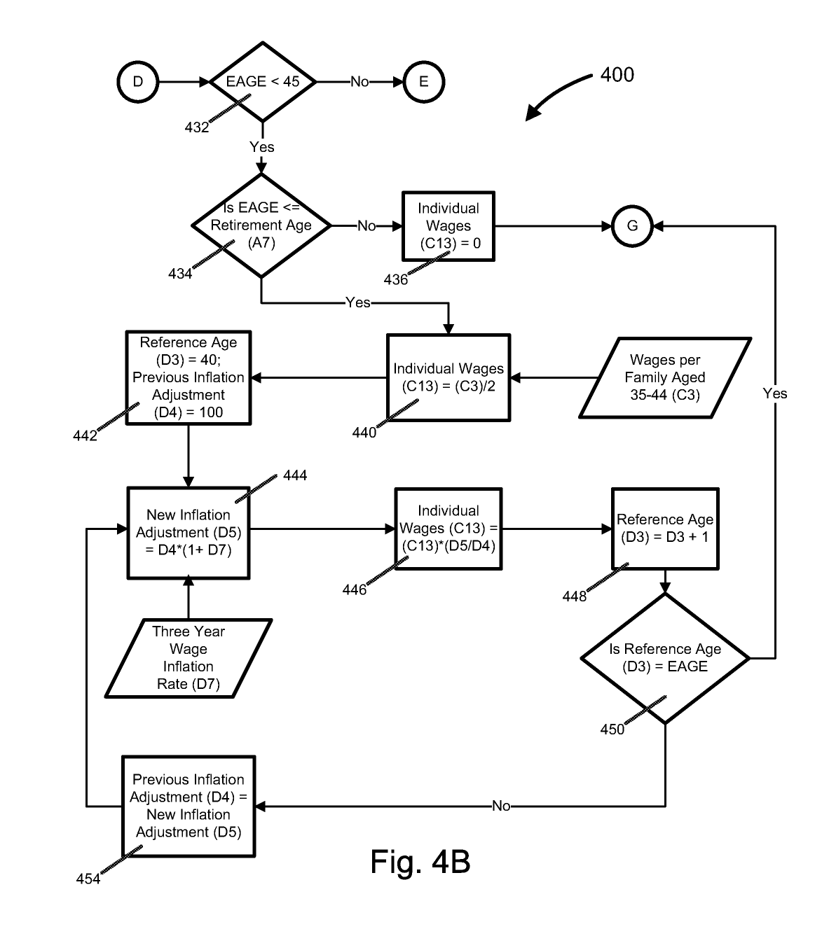

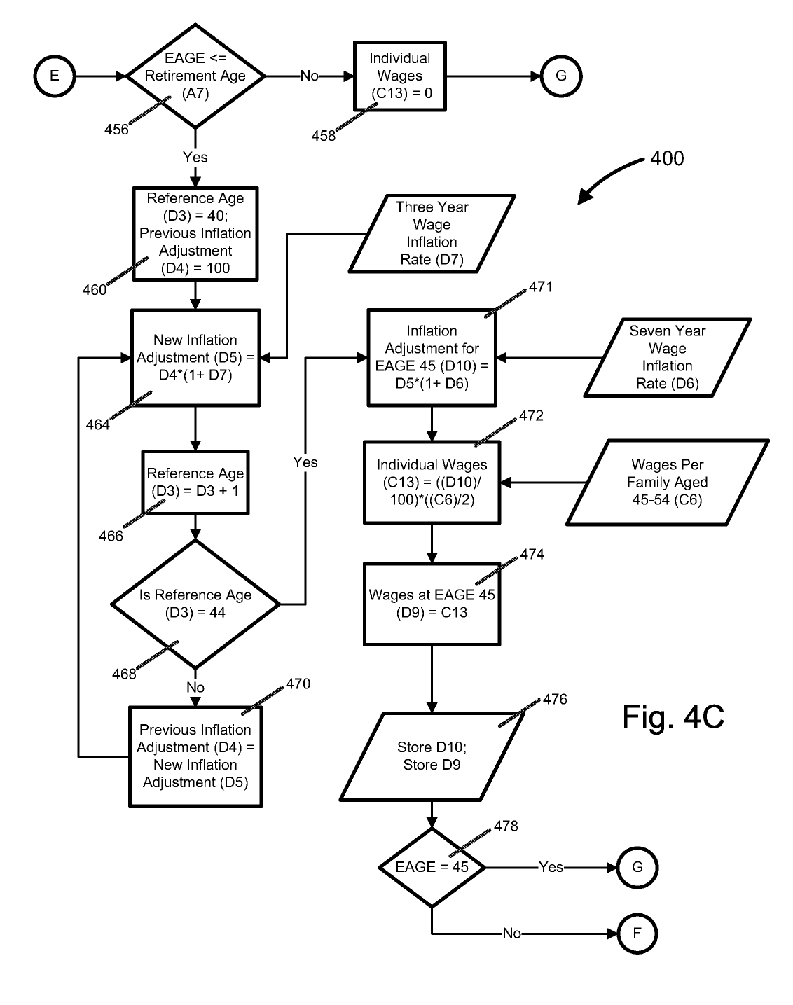

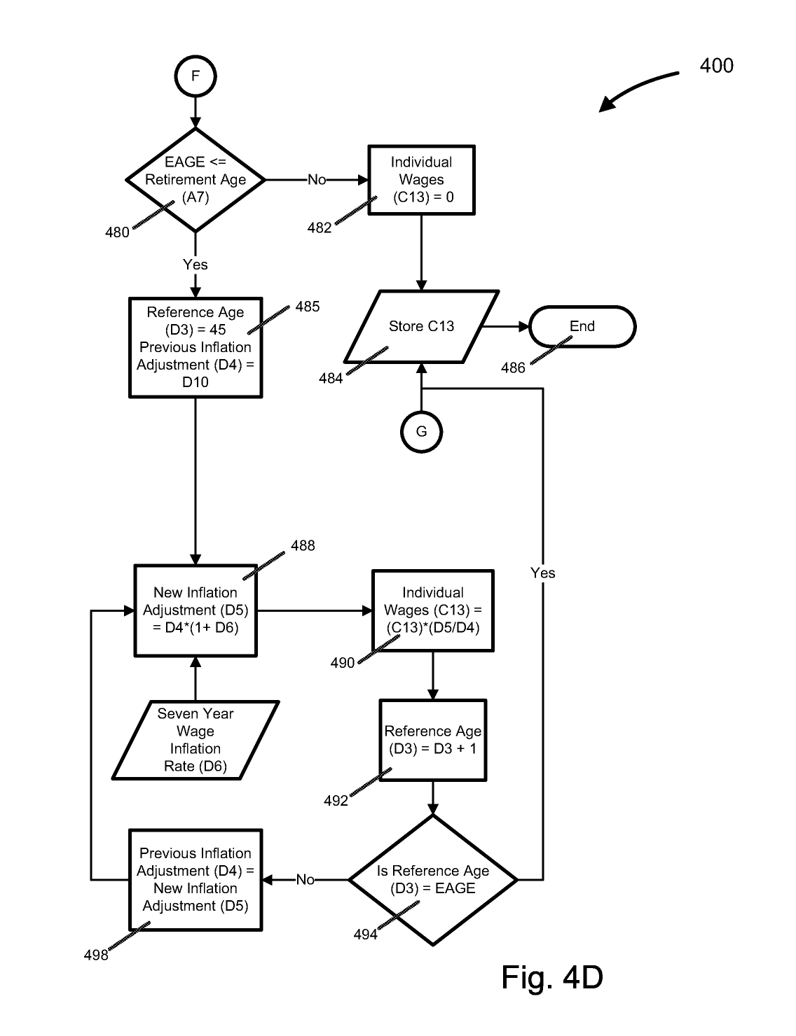

The overall percent contribution (i.e., variable C11) is determined at step 308. C11 is calculated by summing variables C4, C7, and C10 and dividing the sum by three (3) to produce an average. Process 300 then continues to 310 (FIG. 3B). At 310, the employee's pension contribution (i.e., variable C12) is calculated as a percentage of their wages by multiplying individual wages (i.e., variable C13) by C11. The method for calculating wages is depicted in FIGS. 4A-D and is further discussed below.

Step 312 then calculates the percent of wages contributed by an employer (i.e., variable C15). The value of variable C15 is determined by dividing the employer contribution per hour (i.e., variable C17) by an employee hourly wage rate (i.e., variable C16). The values of the C16 and C17 variables should be updated quarterly and are determined by the Bureau of Labor Statistics. They can currently be found on the Employer Costs for Employee Compensation (“ECEC”) Web page located at http://www.bls.gov/ncs/ect/. In order to retrieve the most current values, the user should choose the “ECT Tables” link and then the “ECEC Historical Listing, 2004 to present” PDF version. It should be noted that the title of this document will change as new documents are published and the most recent ECEC listing should be chosen. In the resulting PDF document, the user should select the most recent value on the first table under “Wages and salaries” and input it as the value of variable C16. The most recent value for variable C17 can be found lower in the same table under “Retirement and savings”.

Although reference is made to specific entities, Web pages, PDF documents and the like to provide examples of sources for information to be input to the systems and methods of the present invention, it should be understood that the same data may be obtained from alternate sources, documents, and means without departing from the scope of the present invention.

Process 300 then proceeds to 314, at which the value of the employer's contribution variable (i.e., variable C14) is calculated by multiplying the value of the individual wages variable C13 by the value of the percent of wages contributed by the employer variable C15. Process 300 then proceeds to 316.

The wife's total contribution to the pension (i.e., variable A1) is determined in step 316 by summing the values of variables C12 and C14. Next, process 300 proceeds to step 318, at which the husband's total contribution to pension (i.e., variable A2) is then set to the same value as A1. The present invention assumes that the husband and wife will contribute the same amount to their pension and earn the same wages throughout the couple's lifetime. Thereafter, process 300 proceeds to 320 at which the values of variables A1, A2 and C12 are stored and process 300 ends at 322.

Now referring to FIGS. 4A-4D, depicted is a method 400 for calculating an employee's wages considering inflation and age. The present invention assumes that the average person earns a different wage depending on their age and that wages will increase as the employee's age increases based upon factors including, but not limited to, inflation.

Method 400 begins at step 401 and proceeds to 402, at which the current value of the EAGE variable is queried. If the value is equal to forty, process 400 continues to step 404, at which the wage of a first individual of the couple (i.e., variable C13) is determined to be half of the Wages per Family Aged 35-44 (i.e., variable C3). The value of variable C3 is provided by the Bureau of Labor Statistics. Method 400 is based upon an assumption that, on average, the family unit includes two adults and one or more children. Therefore, the average value of the wages of an employee is determined by dividing this value by two. After calculating the value of the individual wages variable C13, process 400 proceeds to step 484 (FIG. 4D), at which variable C13 is stored for use in other calculations such as the previously described method for calculating employee contribution to pension. Process 400 then proceeds to 486 at which it ends.

If, at 402, the value of the EAGE variable is not equal to 40, method 400 proceeds to step 408, at which it determines whether the value of the EAGE variable is less than 40. If no, process 400 continues to 432 as depicted in FIGS. 4B-4D as discussed in greater detail below. If yes, process 400 proceeds to step 410 at which it determines whether EAGE is less than or equal to the value of the retirement age variable A7. If the value of the EAGE variable is greater than the value of the retirement age variable, process 400 proceeds to step 412, at which the value of the individual wages variable C13 is set to zero since the employee is not expected to earn wages after retirement. Process 400 then proceeds to step 484 (FIG. 4D), at which variable C13 is stored for use in other calculations. Process 400 then proceeds to 486 at which it ends.

If, at step 410, the value of the EAGE variable is determined to be less than or equal to the value of the retirement age variable A7, process 400 proceeds to step 416. At 416, the value of the individual wages variable C13 is set to equal half of the Wages per Family Aged 35-44 (i.e., variable C3). Process 400 then proceeds to step 418, at which the value of the reference age variable (i.e., variable D3) is set to 40 and the value of the previous inflation adjustment variable is set to 100. Since the data is used for a couple aged 35-44, the age of 40 is used as a starting point for wages. However, the present invention assumes a person starts to work at the initial value of the EAGE variable (i.e., in this example, 23) so the discrepancy in wages between the age of 40 and the current value of the EAGE variable is accounted for by decreasing the wage at 40 based on the inflation rate until the current value of the EAGE variable is reached. This is accomplished in the following steps.

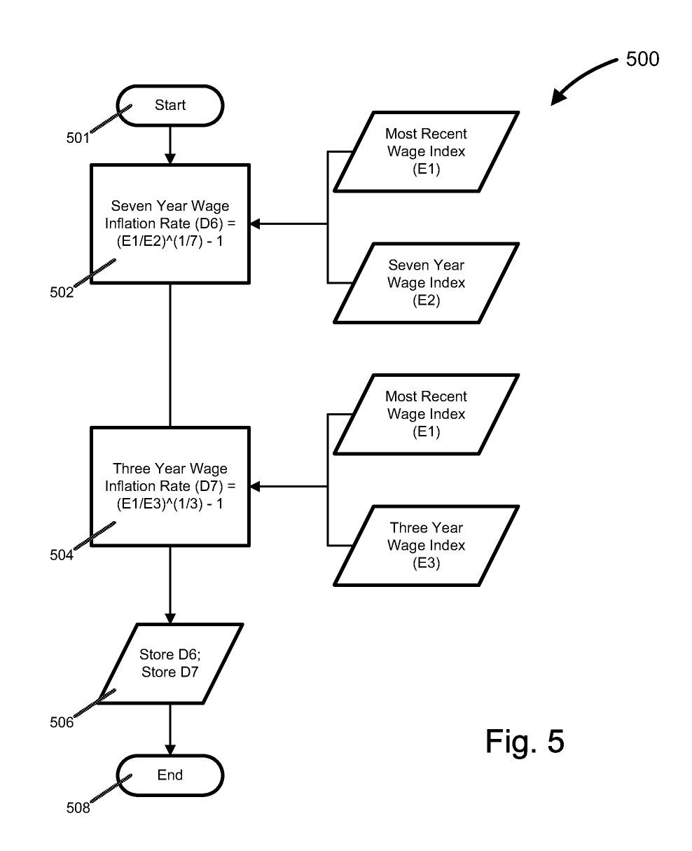

Step 420 determines the value of the new inflation adjustment variable (i.e., variable D5) by dividing D4 by the sum of one and the value of the seven year wage inflation rate variable (i.e., variable D6). Variable D6 is determined via process 500 as depicted in FIG. 5 and as further discussed below. The wages are determined at step 422 to be the product of the value of the individual wages variable C13 (i.e., the previous value of the individual wages variable) and the result of D5 divided by D4.

Process 400 then proceeds to step 424, at which the value of the reference age variable is decreased by one. Step 426 then determines whether the value of the reference age variable is equal to the value of the EAGE variable. If yes, process 400 proceeds to step 484 (FIG. 4D), at which variable C13 is stored for use in other calculations. Process 400 then proceeds to 486 at which it ends.

If, at 426, the value of the reference age variable is not equal to the value of the EAGE variable, process 400 proceeds to step 430. This step replaces the previous value for the previous inflation adjustment variable with the value for the new inflation adjustment variable in order to continue reducing the wage in following calculations. Process 400 then returns to step 420 and repeats steps 420 through 430 until the value of the reference age variable D3 is equal to the value of the EAGE variable. When this occurs, process 400 proceeds to step 484 (FIG. 4D), at which variable C13 is stored for use in other calculations. Process 400 then proceeds to 486 at which it ends.

At step 408, if process 400 determines that the value of the EAGE variable is greater than 40, it proceeds to step 432 (FIG. 4B). If the value of the EAGE variable is greater than or equal to 45, process 400 continues as depicted in FIGS. 4C-4D. As previously discussed, the value for the wages per family aged 45-54 is extracted from the Bureau of Labor Statistics website. Therefore, when the EAGE is above 44, the value of the wages per family aged 45-54 is used to calculate wages. This is accomplished as depicted in FIGS. 4C and 4D and further discussed below.

If, at 432, the value of the EAGE variable is less than 45, process 400 proceeds to step 434. At 434, process 400 determines whether the value of the EAGE variable is less than or equal to the value of the retirement age variable. If the value of the EAGE variable is greater than the retirement age, step 436 sets the value of the individual wages variable C13 to zero. Process 400 then proceeds to step 484 (FIG. 4D), at which variable C13 is stored for use in other calculations. Process 400 then proceeds to 486 at which it ends.

If, at step 434, the value of the EAGE variable is less than or equal to the value of the retirement age variable, process 400 proceeds to step 440. At 440, the value of the individual wages variable C13 is initially set to equal the half of the value of the wages per family aged 35-44 variable C3, which is set by the user or an automated processing unit as discussed in greater detail above.

Process 400 then proceeds to step 442, at which the values for the reference age variable D3 and the previous inflation adjustment variable D4 are set to 40 and 100, respectively. Process 400 then proceeds to step 444. Step 444 determines the value of the new inflation adjustment variable D5 by multiplying D4 by the sum of one and the value of the three year wage inflation rate variable (i.e., variable D7). This calculation creates increasing values for the inflation adjustment variables, which will provide an increasing value for wages above 40. Variable D7 is determined via process 500 as depicted in FIG. 5 and as further discussed below. The value of the individual wages variable C13 is determined at step 446 to be the product of the value of the individual wages variable C13 (i.e., the previous value of the individual wages variable) and the result of D5 divided by D4.

Process 400 then proceeds to step 448, at which the value of the reference age variable D3 is increased by one. Step 450 then determines whether the value of the reference age variable D3 is equal to the value of the EAGE variable. If yes, process 400 proceeds to step 484 (FIG. 4D), at which variable C13 is stored for use in other calculations. Process 400 then proceeds to 486 at which it ends.

If, at 450, the value of the reference age variable D3 is not equal to the value of the EAGE variable, process 400 proceeds to step 454. This step replaces the previous value for the previous inflation adjustment variable with the value for the new inflation adjustment variable in order to continue increasing the wage in following calculations. Process 400 then returns to step 444 and repeats steps 444 through 454 until the value of the reference age variable D3 is equal to the value of the EAGE variable. When this occurs, process 400 proceeds to step 484 (FIG. 4D), at which variable C13 is stored for use in other calculations. Process 400 then proceeds to 486 at which it ends.

At step 432, if process 400 determines that the value of the EAGE variable is greater than or equal to 45, it proceeds to step 456 (FIG. 4C). If, at 456, the value of the EAGE variable is greater than the value of the retirement age variable, process 400 proceeds to step 458 at which the value of the individual wages variable C13 is set to 0. Process 400 then proceeds to 484 (FIG. 4D), at which variable C13 is stored for use in other calculations. Process 400 then proceeds to 486 at which it ends.

Alternatively, if, at 456, the value of the EAGE variable is less than or equal to the value of the retirement age variable A7, process 400 proceeds to 460. At 460, the values for the reference age variable D3 and the previous inflation adjustment variable D4 are set to 40 and 100, respectively. Next, step 464 determines the value of the new inflation adjustment variable D5 by multiplying D4 by the sum of one and the value of the three year wage inflation rate variable (i.e., variable D7). Variable D7 is determined via process 500 as depicted in FIG. 5 and as further discussed below.

Process 400 then proceeds to step 466, at which the value the reference age variable D3 is increased by one. Step 468 then determines whether the value of the reference age variable D3 is equal to 44. If yes, process 400 proceeds to step 471, at which the inflation adjustment for EAGE 45 (i.e., variable D10) is calculated by multiplying variable D5 by the sum of one plus the seven year wage inflation rate (i.e., variable D6). For EAGE values of 41 through 44, a three year wage inflation rate is utilized to calculate individual wages (i.e., variable C13). For EAGE values of 45 and above, a seven year inflation rate is utilized to calculate wages. However, the inflation adjustment at EAGE 45 requires incorporation of both the three and seven year inflation rates as reflected in step 471. Additionally, EAGE values above 45 utilize variable D10 as a starting value in calculating inflation adjustments as further discussed below. Next, at step 472, the value of the individual wages variable C13 is calculated by multiplying the results of two divisions: the division of the value of the new inflation adjustment variable D10 by 100 and the division of the value of the wages per family aged 45-54 variable C6 by 2. Process 400 then proceeds to 474, at which the value of the wages at EAGE 45 variable (i.e., variable D9) is set to the value of the variable C13. Process 400 then proceeds to 476, at which the values of variables D10, and D9 are stored for use in other calculations. Process 400 then proceeds to 478, at which it determines whether the value of the EAGE variable is equal to 45. If yes, process 400 proceeds to 484 (FIG. 4D), at which C13 is stored for use in other calculations. Process 400 then proceeds to 486 at which it ends. If no, process 400 proceeds to 480 (FIG. 4D).

At 480, process 400 determines whether the value of the EAGE variable is less than or equal to the value of the retirement age variable A7. If no, the value of the individual wages variable C13 is set to zero in step 482 and then stored for use in other calculations in step 484. Process 400 then proceeds to 486 at which it ends.

If, at 480, process 400 determines that the value of the EAGE variable is less than or equal to the value of the retirement age variable A7, process 400 proceeds to 485. At 485, the value for the reference age variable D3 is set to 45. The previous inflation adjustment variable D4 is set to equal the value of the inflation adjustment for EAGE 45 D10. Variables D3 and D4 are therefore set for values of EAGE of 45 and above. Process 400 then proceeds to step 488. Step 488 determines the value of the new inflation adjustment variable D5 by multiplying D4 by the sum of one and the value of the seven year wage inflation rate variable (i.e., variable D6). Variable D6 is determined via process 500 as depicted in FIG. 5 and as further discussed below. The value of the individual wages variable C13 is determined at step 490 to be the product of the value of the individual wages variable C13 (i.e., the previous value of the individual wages variable) and the result of D5 divided by D4.

Process 400 then proceeds to step 492, at which the value the reference age variable D3 is increased by one. Step 494 then determines whether the value of the reference age variable D3 is equal to the value of the EAGE variable. If yes, process 400, process 400 then proceeds to step 484, at which variable C13 is stored for use in other calculations. Process 400 then proceeds to 486 at which it ends.

If, at 494, the value of the reference age variable D3 is not equal to the value of the EAGE variable, process 400 proceeds to step 498. This step replaces the previous value for the previous inflation adjustment variable D4 with the value for the new inflation adjustment variable D5 in order to continue increasing the wage in following calculations. Process 400 then returns to step 488 and repeats steps 488 through 498 until the value of the reference age variable D3 is equal to the value of the EAGE variable. When this occurs, process 400 proceeds to step 484, at which variable C13 is stored for use in other calculations. Process 400 then proceeds to 486 at which it ends.

Turning now to FIG. 5, depicted is a method 500 for calculating three year and seven year wage inflation rates. Process 500 begins with step 501 after which it proceeds to 502. At 502, the seven year wage inflation rate variable (i.e., variable D6) is calculated using the value of the most recent wage index variable (i.e., variable E1) and the value of the seven year wage index variable (i.e., variable E2). Variable D6 is calculated by taking the geometric average of the wage index over the past seven years. That is, the value of variable E1 is divided by the value of variable E2 and the resulting value is raised to the one-seventh ( 1/7) power and then reduced by one. Although the depicted embodiment uses a seven (7) year time period to calculate the value of variable D6, averages calculated over shorter or longer time periods may be substituted without departing from the scope of the present invention.

Process 500 then proceeds to step 504, at which the value of the three year wage inflation rate variable (i.e., variable D7) is calculated by taking the geometric average of the wage index over the past three years. That is, the value of variable E1 is divided by the value of the variable E3 and the resulting value is raised to the one-third (⅓) power and then reduced by one. Although the depicted embodiment uses a three (3) year time period to calculate the value of variable D7, averages calculated over shorter or longer time periods may be substituted without departing from the scope of the present invention including, but not limited to, five years.

In the above calculations of wages, the three year wage inflation rate is used to adjust wages for an EAGE variable having a value of 40 through 44. In contrast, when the EAGE variable has a value below 40 or above 44, the seven year wage inflation rate is used to adjust wages. Step 506 stores variables D6 and D7 for future use and process 500 then terminates at 508.

The data for variables E1, E2, and E3 are inputted by the user or an automated processing unit and are updated on a quarterly basis. Data can be found on the internet at http://www.bls.gov/ncs/. The user may find the information by navigating to this link and then clicking the following: “NCS Tables”, “ECI Current Dollar Historical Listings”, and “NAICS Basis” PDF. In this PDF document, to obtain the value of the variable E1, the user may view Table 2's data for the most current month under the indexes for “Civilian workers”. Data for the variable E2 may be extracted from the value under indexes for “Civilian workers” seven years before the most current month. Finally, data for the variable E3 may be extracted from the value under indexes for “Civilian workers” three years before the current month.

Depicted in FIGS. 6A and 6B is a method for calculating After Tax Pension Withdrawals (i.e., variable A6) as required for process 100. Process 600 begins at step 601 after which it proceeds to 602. At 602, process 600 determines whether the value of the EAGE variable is equal to 40. If, at 602, the value of the EAGE variable is equal to 40, the value of the current year's beginning of year savings/debt variable (i.e., F7) is set to equal the value of the initial savings of family unit Age 40 variable (i.e., variable G1) at step 604. While it is understood that savings for family units under age 40 do not have a savings of zero, these values are unnecessary in this model. The average savings at age 40 can be reasonably estimated, and it is used as an estimate for variable F7. The value of variable G1 is initially set by the user or an automated processing unit to a value obtained from the Web site http://www.federalreserve.gov/pubs/bulletin/2006/financesurvey.pdf. Currently, the data to be input for variable G1 is found on page 14, table 5, under Age of Head (years) for ages 35-44. Variable G1 should be inputted as the sum of the values for Transaction accounts, Certificates of deposit, Savings bonds, Bonds, Stocks, and Pooled investment funds for the 35-44 age group. This information is based on the Federal Reserve Board's Survey of Consumer Finances for 2001 and 2004. More updated information is not currently available, but the data should be updated when the Federal Reserve Board reports the results of a new Survey of Consumer Finances. The process then continues as depicted in FIG. 6B and further discussed below.

Conversely, if, at 602, the value of the EAGE variable is not equal to 40, process 600 proceeds to 605, At 605, process 600 determines whether the value of the EAGE variable is less than or equal to 39. If the value of the EAGE variable is less than or equal to 39, then after tax pension withdrawals (i.e., variable A6) is set equal to zero. If EAGE is not less than or equal to 39, process 600 proceeds to 606. At 606, process 600 determines whether the value of the EAGE variable is less than the value of the age at which debt is discharged variable (i.e., variable F1). The present invention assumes that the value of the age at which debt is discharged variable F1 is 67. The present invention assumes that the average American will withdraw funds from his or her pension account to accomplish this. The present invention accounts for these withdrawals as After Tax Pension Withdrawals. Although the value of variable F1 is set to 67 in the exemplary embodiment, other values may be substituted without departing from the scope of the present invention.

If the value of the EAGE variable is less than the value of the age at which debt is discharged variable F1, process 600 proceeds to 608, at which the value of the after tax pension withdrawal variable is set to zero. At 610, process 600 then stores the value of variable A6 in a table corresponding to the current value of EAGE.

Conversely, if the EAGE is greater than or equal to the value of the age at which debt is discharged variable F1, process 600 proceeds to step 612. At 612, process 600 determines whether the value of the EAGE variable is less than 45. If no, step 614 sets the value of the saving interest rate variable (i.e., variable F3) to the value of the five year savings interest rate non-pension assets variable (i.e., variable F2) and process 600 proceeds to 618. If, at 612, the value of the EAGE variable is less than 45, step 616 sets the value of variable F3 to the value of the three year savings interest rate non-pension assets variable (i.e., variable F4). In doing this, the average 40 year old American is expected to earn a three year interest rate until he or she reaches the age of 44, after which, he or she is expected to earn a five year interest rate on their non-pension assets. It should be noted that a single average rather than a three and/or five year average may be substituted without departing from the scope of the present invention.

Variable F2 is inputted by the user or an automated processing unit and updated on a monthly basis from data found on the following Web site: http://www.tiaa-cref.org/public/performance/mutual_funds/index.html. The user navigates to this link and finds the data on the annual return data listed for a “Money Market” under “Average Annual Total Returns” for five years. Similarly, the data for the values of the three year savings interest rate non-pension assets variable F4 is found in the data listed for a “Money Market” under “Average Annual Total Returns” for three years. Although the depicted embodiment uses a five (5) year time period for the value of variable F2 and a three (3) year time period for the value of variable F4, shorter or longer time periods for each variable may be substituted without departing from the scope of the present invention.

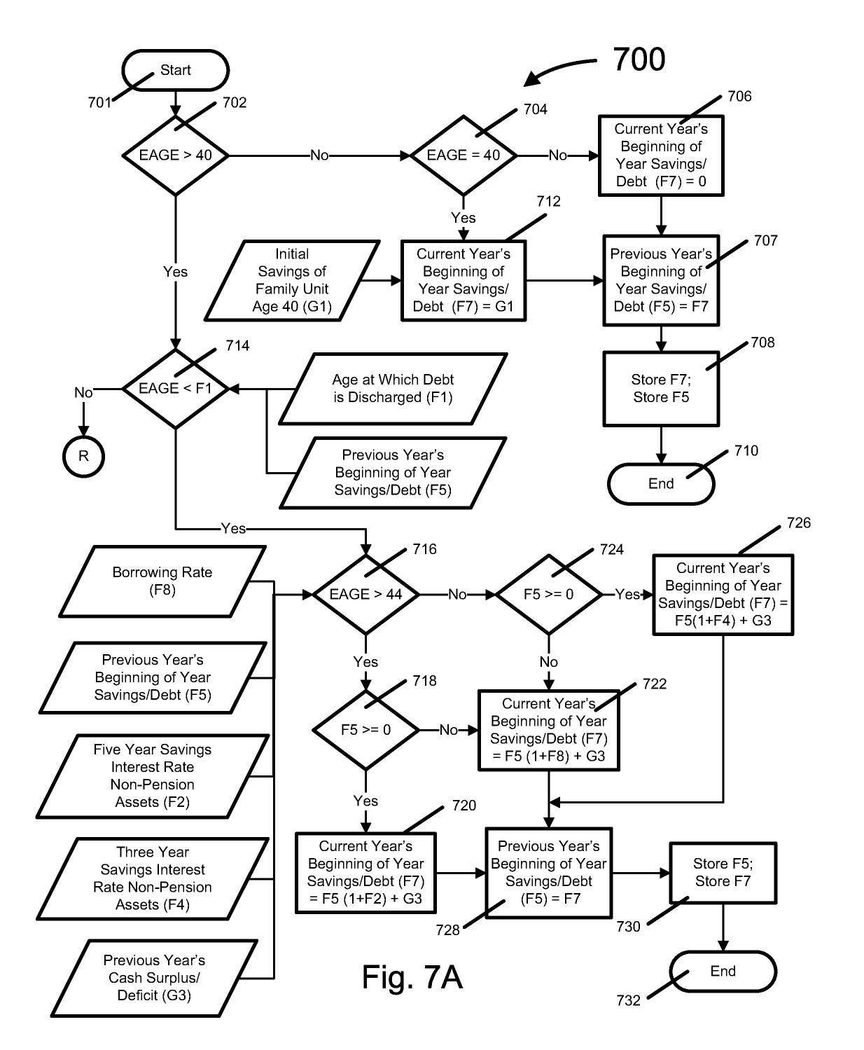

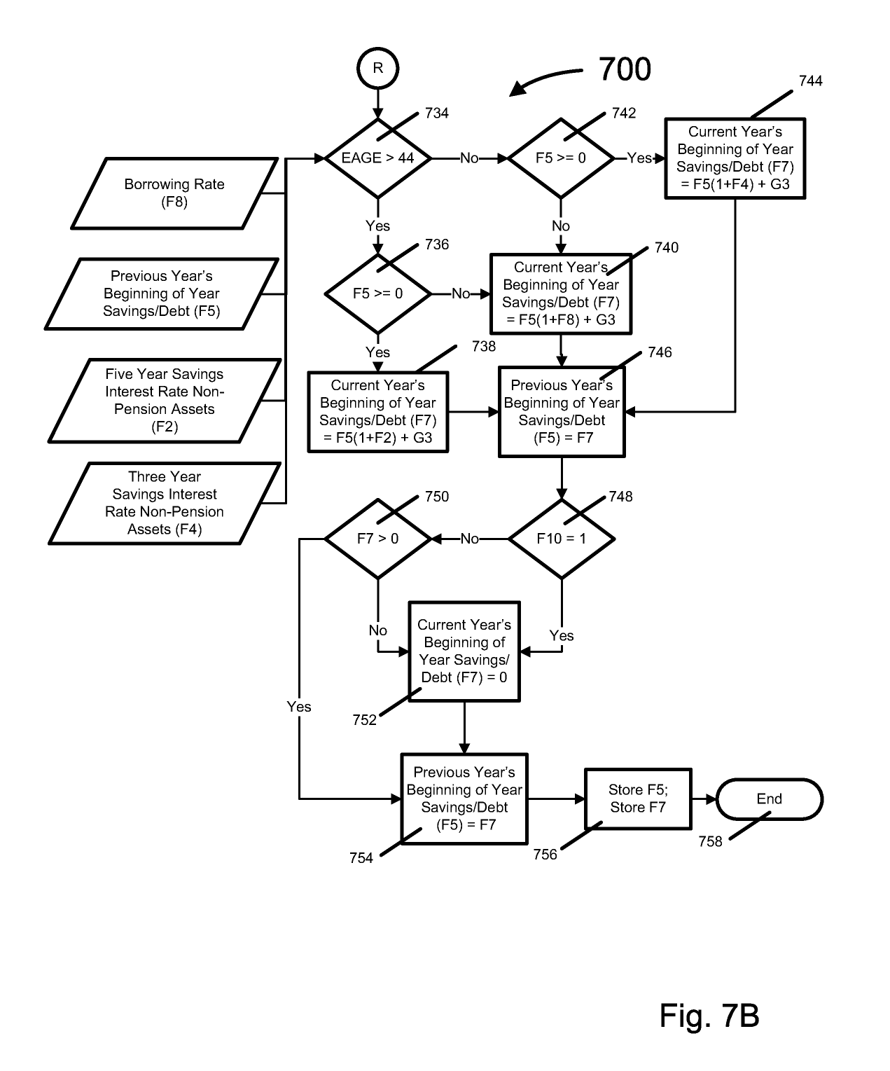

After a value has been set for variable F3, process 600 then proceeds to step 618, at which process 600 determines whether the value of the current year's beginning of year savings/debt variable (i.e., variable F7) is greater than zero. The value of variable F7 is determined by the method shown in FIGS. 7A and 7B as discussed in greater detail below. If the value of the current year's beginning of year savings/debt variable F7 is equal to or less than zero, process 600 then proceeds to 622 as depicted in FIG. 6B and further discussed below.

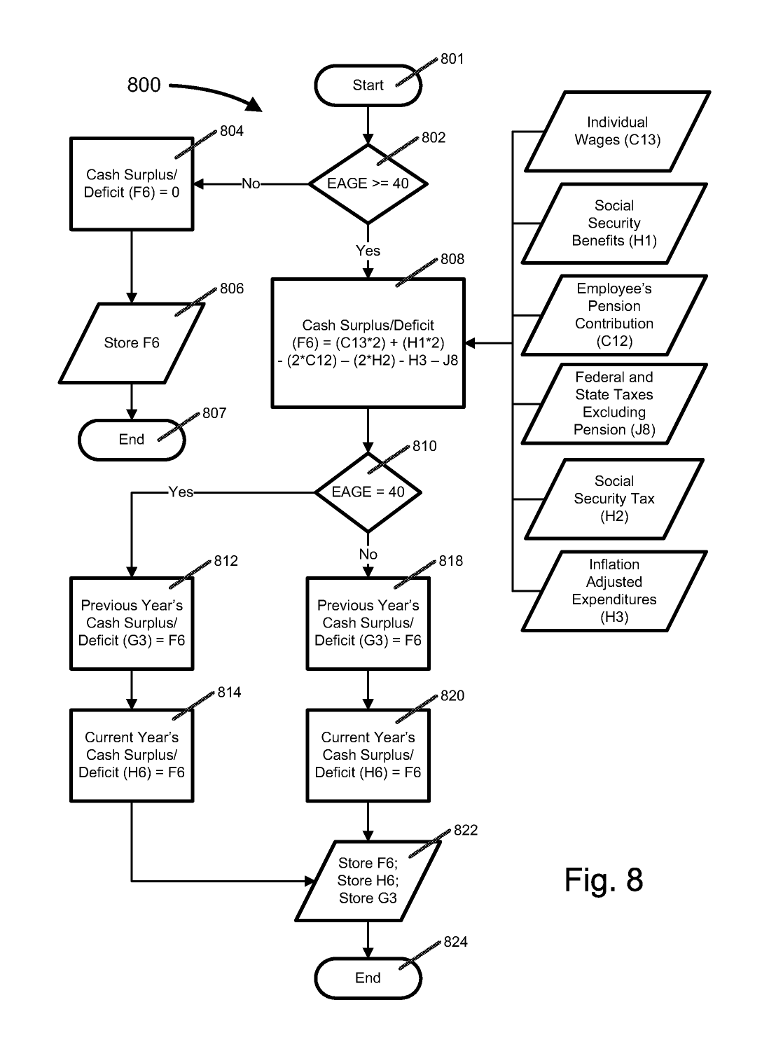

If the value of variable F7 is greater than zero, step 620 calculates a preliminary value for after tax pension withdrawals (i.e., variable A6) by adding one to the value of the savings interest rate variable F3, multiplying this sum by the value of the current year's beginning of year savings/debt variable F7, and adding the value of the current year's cash surplus/deficit variable (i.e., variable H6). This results in a value for A6 that is based on the couple's beginning of year savings and the savings interest rate as adjusted for a surplus/deficit in cash for the current year. The value of the current year's cash surplus/deficit variable H6 is calculated as per the method depicted in FIG. 8 as discussed in greater detail below. Process 600 then proceeds as depicted in FIG. 6B.

The value of the savings interest rate variable F3 varies based upon the value of EAGE. For an EAGE having a value of 44 and below, the value of the three year savings interest rate on non-pension assets variable F4 is used. If the value of the EAGE variable is above age 44, the value of the five year savings interest rate on non-pension assets variable F2 is used. For individuals below age 45, the three year rate is used because it is a reasonable estimate of the interest rate over the following few years. Above age 45, a longer five year savings interest rate is a more reasonable estimate.

Conversely, if, at 618, the value of the current year's beginning of year savings/debt variable F7 is equal to or less than zero, step 622 (FIG. 6B) calculates the value of variable A6 by adding one to the value of the borrowing rate variable (i.e., variable F8), multiplying this sum by the value of the current year's beginning of year savings/debt variable F7, and adding the value of the current year's cash surplus/deficit variable H6. The value of the borrowing rate variable F8 is initially input by the user or an automated processing unit and updated on a monthly basis via the Web site http://www.bankrate.com/home-equity.aspx. The recommended data to be used for variable F8 is the interest rate value listed for a $30,000 home equity loan. If a family has debt prior to age 67, the present invention assumes this is the interest rate they will receive on any such debt. However, this interest rate value may be obtained from a different source and/or may be based upon a varying loan amount without departing from the scope of the present invention.

After step 622, process 600 continues via step 624. At 624, if the value of the after tax pension withdrawals variable A6 is greater than zero, process 600 continues to step 625, at which it sets the value of the Previous Year's Pension Withdrawal Yes variable F10 to zero. Next, at 626, the value of the after tax pension withdrawals variable (i.e., variable A6) is set to zero. After tax pension withdrawals represent the money that a couple must withdraw from their pension for the given year. If a positive value for after tax pension withdrawals is initially determined (i.e., as calculated in steps 620 and 622), then this indicates that no money must be withdrawn from a couple's pension and the value of A6, therefore, must be set to zero. Next, at 628, the value of the variable A6 is stored in a table of values corresponding to the current EAGE for use in other calculations. The process then terminates at 630. Alternatively, if step 624 determines that the value of variable A6 is not greater than zero, process 600 proceeds to 627, at which the value of the Previous Year's Pension Withdrawal Yes variable F10 is set to one. Thereafter, process 600 proceeds to step 628 for storage of variables A6 and F10 and then terminates at 630.

Turning now to FIG. 7, a method 700 for calculating the value of the current year's beginning of year savings/debt variable (i.e., variable F7) is depicted. Method 700 begins at step 701 and proceeds to 702, at which the value of the EAGE variable is queried. If it is less than or equal to 40, process 700 proceeds to step 704, at which the value of the EAGE variable is queried to determine if it is equal to 40. If, at step 704, EAGE is not equal to 40, step 706 sets the value of the current year's beginning of year savings/debt variable (i.e., variable F7) equal to zero. Process 700 then proceeds to step 707, at which the value of the previous year's beginning of year savings/debt variable (i.e., variable F5) is set to equal the value of variable F7. Next, at step 708 the values of variables F7 and F5 are stored in a table of values corresponding to the current EAGE for use in other calculations. Finally, process 700 proceeds to 710, at which it ends. That is, the values of variables F7 and F5 are set to zero at steps 706 and 707, respectively. This is because the invention assumes that savings are zero for all values of EAGE less than 40. While it is understood that family units under age 40 do not have a savings of zero, these values are unnecessary in the model. The average savings at age 40 can be reasonably estimated, and it is used as an estimate for variable F7 in step 712 as discussed in greater detail below.

Alternatively, if, at 704, the value of the EAGE variable is equal to 40, process 700 proceeds to step 712, at which the value of the current year's beginning of year savings/debt variable F7 is set to equal the value of the initial savings of family unit aged 40 variable (i.e., variable G1) to establish a starting value for savings. The value of variable G1 is inputted by the user or an automated processing unit as further discussed above with reference to FIG. 6. Process 700 then proceeds to 707, at which the value of the previous year's beginning of year savings/debt variable F5 is set to equal the value of variable F7. Next, at step 708 the values of variables F7 and F5 are stored in a table of values corresponding to the current EAGE for use in other calculations. Process 700 then proceeds to 710, at which it ends.

Alternatively, if, at step 702, it is determined that EAGE is greater than 40, process 700 proceeds to step 714. Step 714 queries EAGE to determine if it is less than the age at which debt is discharged (i.e., variable F1). If no, process 700 proceeds to 734 as depicted in FIG. 7B and as further discussed below. If the answer is yes, step 716 is completed, at which the EAGE is queried once again. Step 716 determines if the value of the EAGE variable is greater than 44. If EAGE is greater than 44, step 718 is completed. Step 718 queries the value of the previous year's beginning of year savings/debt variable (i.e., variable F5) to determine if it is greater than or equal to zero. If yes, step 720 calculates the value of the current year's beginning of year savings/debt variable (i.e., variable F7) as the product of the value of the previous year's beginning of year savings/debt (i.e., variable F5) times the value of one plus the five year savings interest rate for non-pension assets (i.e., variable F2) after which the result of the multiplication is added to the value of the previous year's cash surplus/deficit variable G3. However, if step 718 determines that the value of variable F5 is less than zero, step 722 calculates the value of variable F7 in the same manner as step 720 with the exception that the value of variable F5 is multiplied by the sum of one plus the value of the borrowing rate variable (i.e., variable F8) and added to the value of variable G3. That is, when variable F5 is negative (i.e., the couple has debt rather than savings), it is multiplied by a borrowing rate rather than a savings interest rate. After either step 720 or step 722, process 700 proceeds to step 728 as further discussed below. The values of variables F2 and F8 are inputted by the user or an automated processing unit as further discussed above with reference to FIG. 6. Variable G3 is calculated as depicted in FIG. 8 and discussed in further detail below.

However, if step 716 determines that the value of the EAGE variable is not greater than 44, step 724 is performed, at which the value of the previous year's beginning of year savings/debt variable F5 is queried to determine if it is greater than or equal to zero. If variable F5 is less than zero, step 722 is completed as discussed above. However, if variable F5 is greater than or equal to zero, step 726 calculates variable F7 in the same manner as step 720 with the exception that the value of variable F5 is multiplied by the sum of one plus the value of the three year savings interest rate for non-pension assets variable (i.e., variable F4) and then added to the value of variable G3. In doing this, the average 40 year old American is expected to earn a three year interest rate until he or she reaches the age of 44, after which, he or she is expected to earn a five year interest rate on his or her non-pension assets. The value of variable F4 is inputted by the user or an automated processing unit as further discussed above with reference to FIG. 6.

Process 700 then completes step 728, at which the value of the previous year's beginning of year savings/debt variable is set to equal the value of variable F7. Next, at step 730, the values of variables F5 and F7 are stored in a table of values corresponding to the current EAGE. Process 700 then proceeds to step 732, at which it ends.

Referring back to step 714 of FIG. 7A, if, at step 714, it is determined that the value of the EAGE variable is not less than the age at which debt is discharged (i.e., variable F1) process 700 proceeds to step 734 as depicted in FIG. 7B. Process 700 then completes steps 734 through 746 in substantially the same manner as discussed with respect to steps 716 through 728, respectively. That is, the manner in which current year's beginning of year savings/debt (i.e., variable F7) is calculated is based upon the age of the couple and whether they have previous savings or previous debt.

Next, process 700 proceeds to step 748, at which the value of the Previous Year's Pension Withdrawal Yes variable F10 is queried to determine if F10 is equal to one. If it is not equal to one, process 700 proceeds to 750, at which the value of variable F7 is queried to determine if it is greater than zero. If the value of variable F7 is less than or equal to zero, step 752 sets the value of the current year's beginning of year savings/debt variable (i.e., variable F7) to zero. The current model sets the value of the current year's beginning of year savings/debt variable to zero since no debt is allowed at or after the age at which debt is discharged. Hence the value of variable F7 is not allowed to be negative. That is, after savings are depleted, the couple pays for their living expenses through pension withdrawals rather than accruing debt. However, alternate embodiments of the present invention are envisioned in which the couple may have a positive value for savings after an after tax pension withdrawal has occurred. For instance, in the event that a large sum of money is received by the couple, for example, due to an inheritance gift, savings could become positive.

If, at 750, the value of variable F7 is greater than zero, step 754 sets the value of the previous year's beginning of year savings/debt variable equal to the value of variable F7. It should be noted that step 754 is completed after steps 752 and 750. Process 700 then completes step 756, at which the values of variables F5 and F7 are stored in a table of values corresponding to the current value of the EAGE variable. Process 700 then proceeds to step 758, at which it ends.

Alternatively, if at step 748, the value of the F10 variable is equal to one, then process 700 proceeds to step 752, at which the value of the F7 variable is set to equal zero. The current model sets the value of the current year's beginning of year savings/debt variable to zero after a pension withdrawal has occurred because it is assumed that the couple has previously depleted its savings and the couple is now paying for all living expenses via pension withdrawals. Therefore, the value of the current year's beginning of year savings/debt variable is set to equal zero after a pension withdrawal has occurred. Process 700 then proceeds to step 754, at which it sets the value of the previous year's beginning of year savings/debt variable equal to the value of variable F7. Process 700 then proceeds to step 756, at which the values of variables F5 and F7 are stored in a table of values corresponding to the current value of the EAGE variable. Process 700 then proceeds to step 758, at which it ends.

Turning now to FIG. 8, depicted in a process 800 for calculating the value of the current year's cash surplus/deficit variable (i.e., variable H6). Process 800 begins at step 801 and proceeds to step 802, at which process 800 determines whether the value of the EAGE variable is greater than or equal to 40. If no, the value of variable F6 is set to equal zero, since savings at age 40 have already been estimated and any cash surpluses prior to age 40 have been indirectly taken into account. Then process 800 proceeds to step 806, at which the value of variable F6 is stored in a memory location for future use. Process 800 then proceeds to 807, at which it ends.

Conversely, if, at step 802, the value of the EAGE variable is greater than or equal to 40, process 800 proceeds to step 808, at which it calculates the value of variable F6 to be the sum of two times the value of variable C13 and two times the value of the social security benefits variable H1 minus the following: two times the value of the employee's pension contribution variable C12 (i.e., the value of the wife and husband's pension contributions); two times the value of the social security tax variable H2; the value of the inflation adjusted expenditures variable H3; and the value of the federal and state taxes excluding pension variable J8. This calculation combines all non-pension and non-interest income (i.e., the income received from wages and social security benefits) and deletes all non-interest expenses to determine whether a surplus or deficit in cash exists for incorporation in the savings calculation. It should be noted that although variable J8 includes state taxes in the depicted embodiment, this variable may include any non-federal taxes including, without limitation, one or more of state, town, city, county, local, province, and territory taxes.

Process 800 then proceeds to step 810, at which the value of the EAGE variable is compared to 40. If it is equal to 40, process 800 proceeds to step 812, at which the value of the previous year's cash surplus/deficit variable (i.e., variable G3) is set to equal the value of variable F6. Process 800 then proceeds to step 814, at which the value of the current year's cash surplus/deficit variable H6 is set to equal the value of variable F6. Then process 800 proceeds to 822, at which the values of variables F6, H6, and G3 are stored in a memory location for future use. Process 800 then proceeds to 824, at which it ends.

Conversely, if, at step 810, the value of the EAGE variable is not equal to 40, then process 800 proceeds to step 818, at which the value of the previous year's cash surplus/deficit variable G3 is set to equal the value of variable F6. Process 800 then proceeds to step 820, at which the value of the current year's cash surplus/deficit variable is set to equal to the value of variable F6. Then process 800 proceeds to 822, at which the values of variables F6, H6, and G3 are stored in a memory location for future use. Process 800 then proceeds to 824, at which it ends.

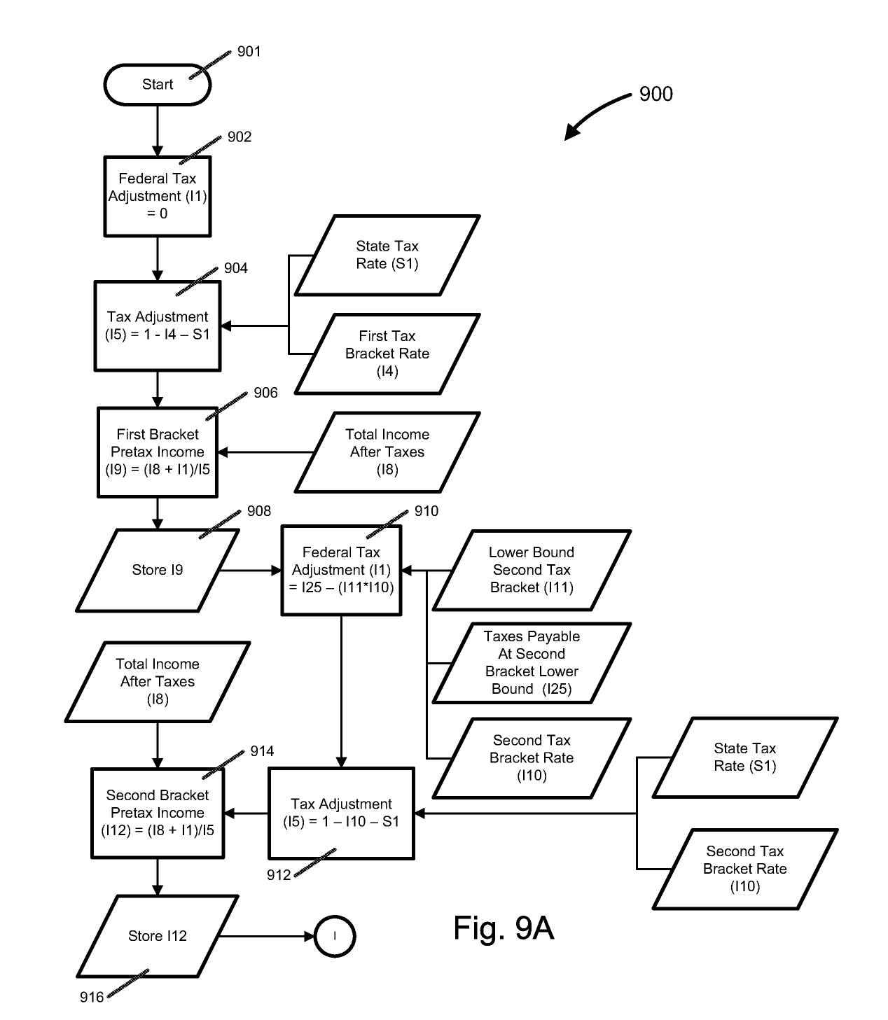

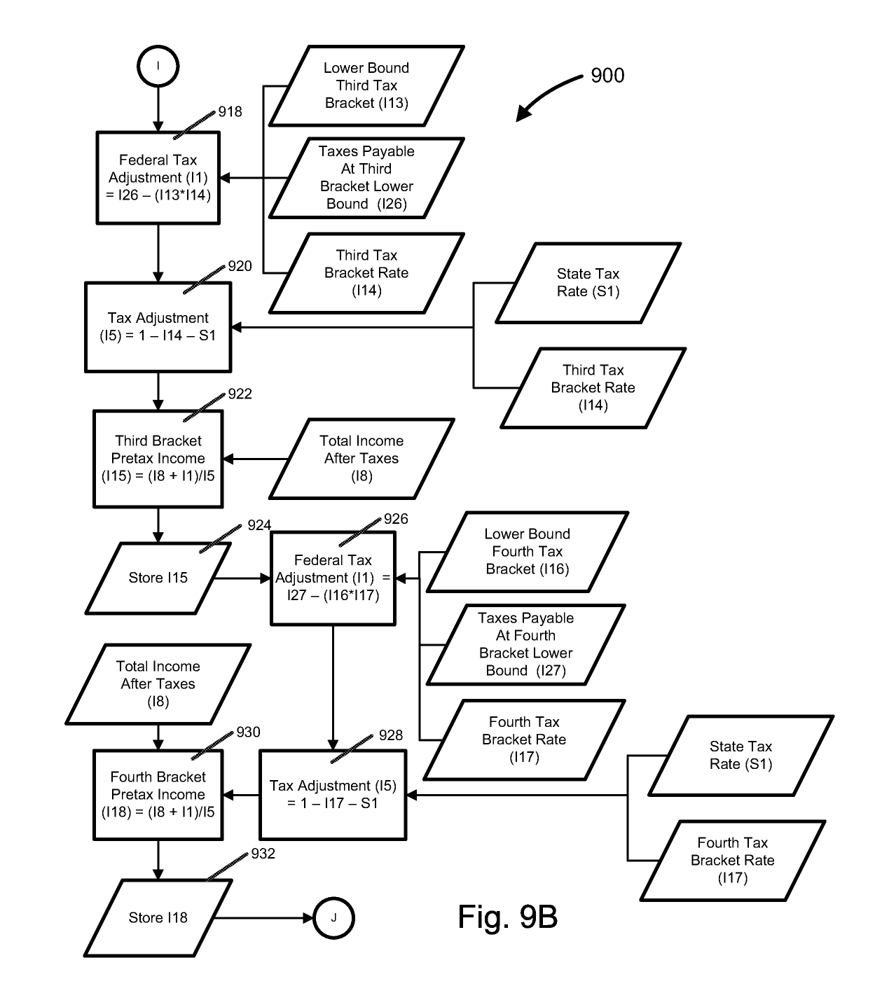

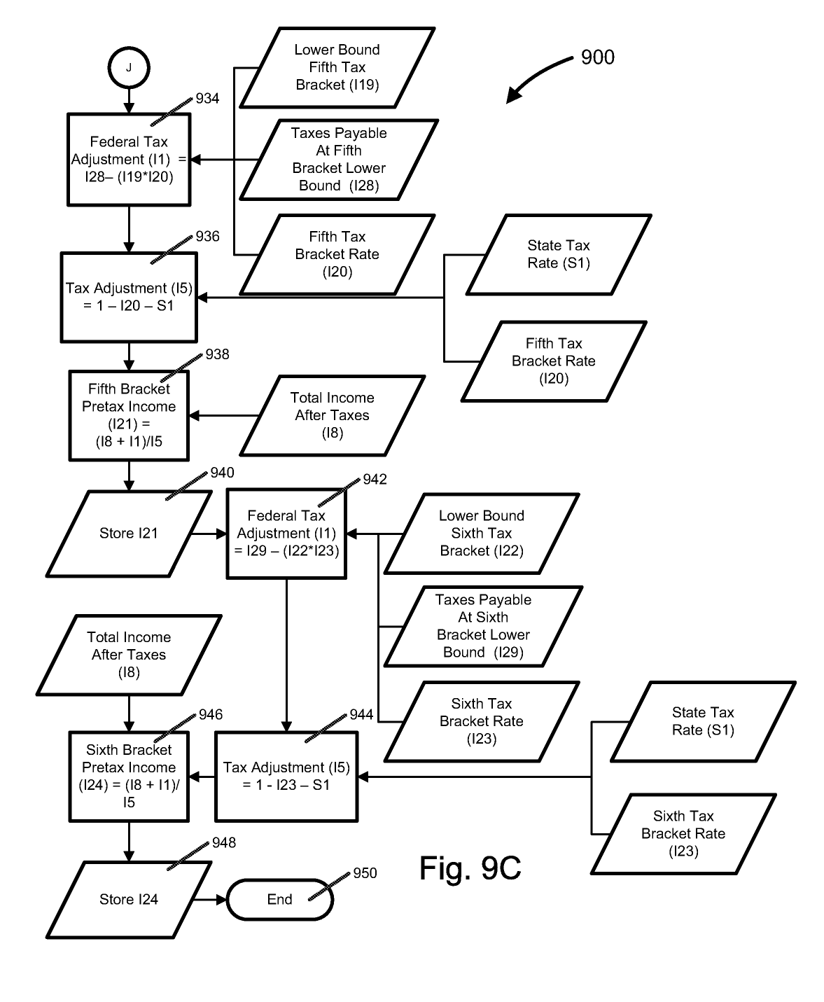

Turning now to FIGS. 9A, 9B, and 9C, depicted is a process 900 for calculating pretax income for all tax brackets. The values calculated in this process are then used in process 1000 to determine Marginal Tax on Pension Income as depicted in FIGS. 10A, 10B, and 10C and as further discussed below. A pretax income is determined for each tax bracket because process 1000 calculates the tax by evaluating the pretax income for each bracket to determine if the income is in the range for the corresponding tax bracket.

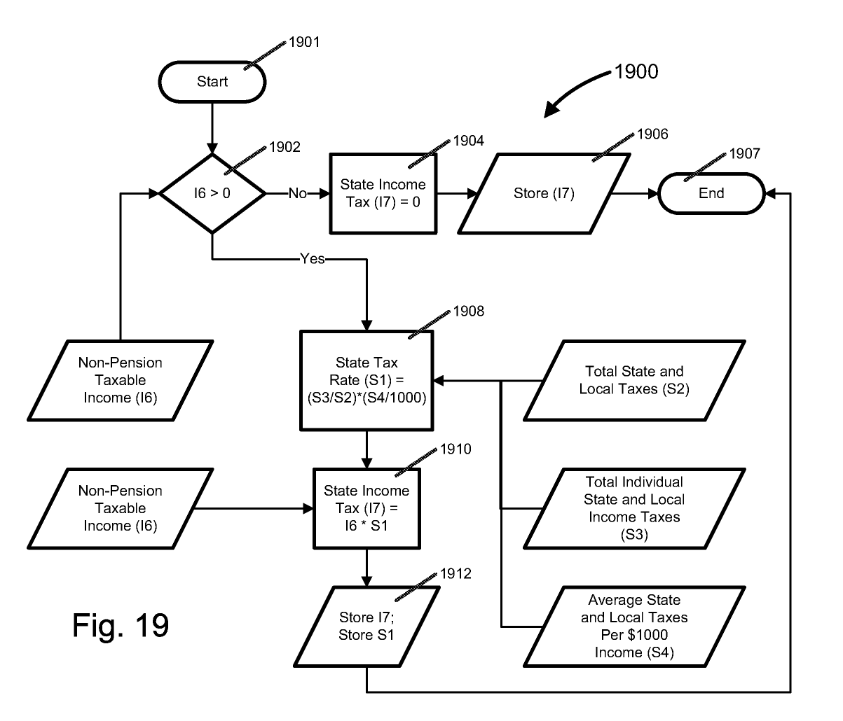

Process 900 begins at step 901 after which it proceeds to 902. At 902, the value of the federal tax adjustment variable (i.e., variable I1) for the first tax bracket is set to zero. After step 902, process 900 proceeds to step 904, at which the value of the Tax Adjustment variable (i.e., variable I5) is determined as a percent of income. The Tax Adjustment variable grosses up after tax income to be pre-tax income. The value of the variable I5 is calculated by starting with a value of one and subtracting the value of variable I4 and then subtracting the value of variable S1, which is calculated as shown in FIG. 19 and as further discussed below. The resulting value of the tax adjustment variable I5 is expressed as a decimal.

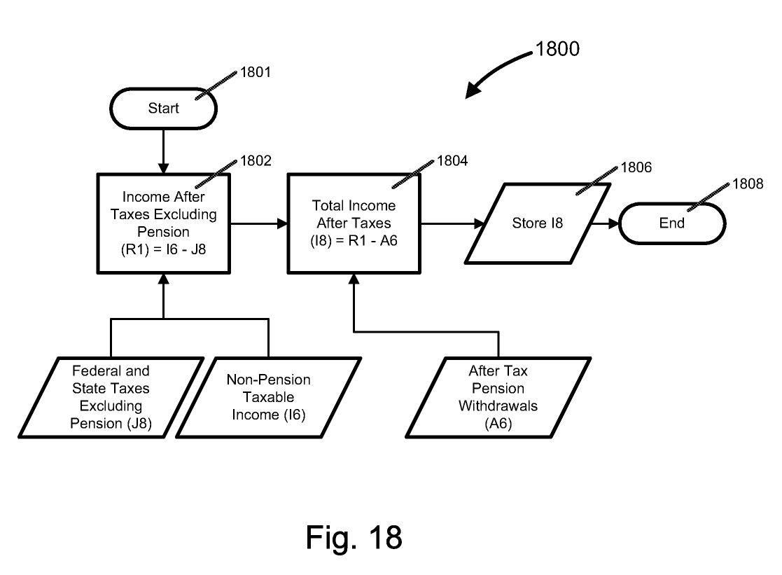

Process 900 then proceeds to 906, at which the value of the first bracket pretax income variable (i.e., variable I9) is calculated. Variable I9 is calculated by adding the value of variable I1 to the value of variable I8 and dividing the result by the value of variable I5. The value of the total income after taxes variable (i.e., variable I8) is calculated as depicted in FIG. 18 and as further discussed below. Process 900 then proceeds to step 908, at which the value of variable I9 is stored for future use.

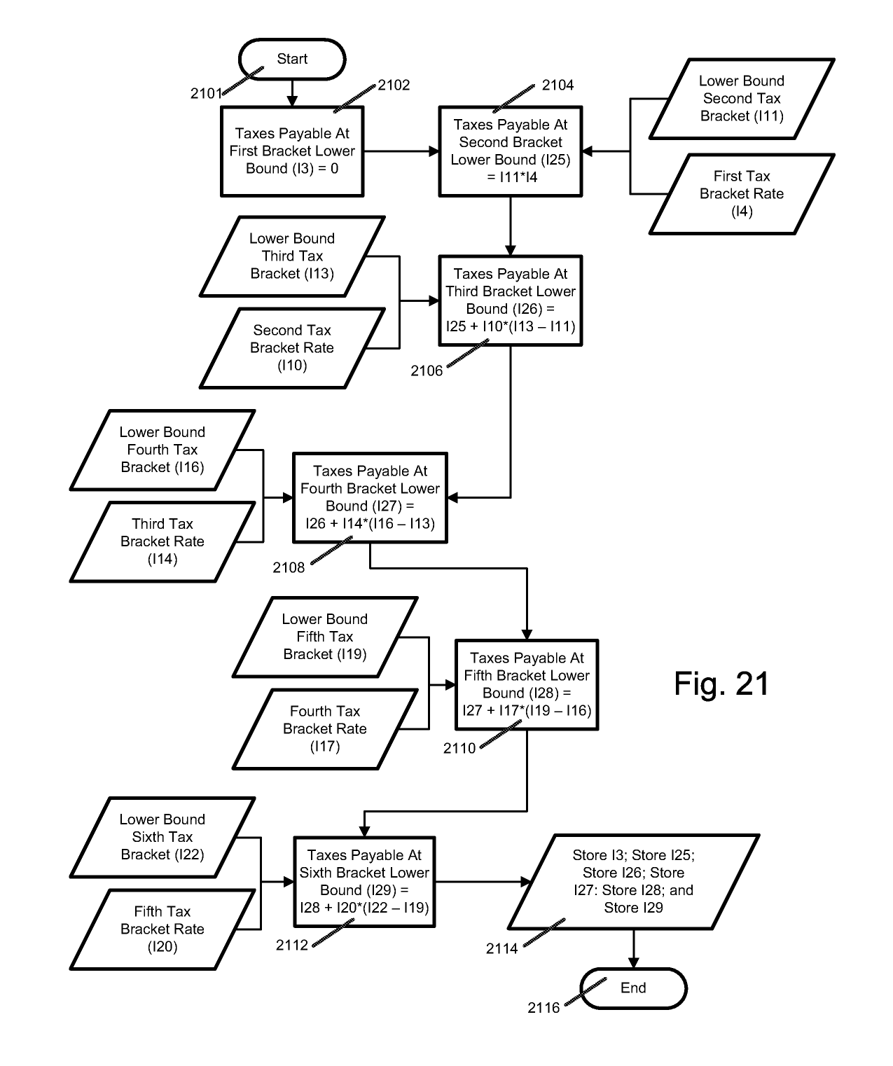

Process 900 then proceeds to step 910, at which the value of the federal tax adjustment variable I1 is recalculated for the second tax bracket. Variable I1 is calculated by multiplying the value of the lower bound second tax bracket variable I11 by the value of the second tax bracket rate variable I10 and subtracting the result from the value of the taxes payable at second bracket lower bound variable I25. The value of variable I25 is calculated as depicted in FIG. 21 and as further discussed below. The values of variables 1I11 and I10 are initially input by the user or an automated processing unit and are updated on an annual basis. The data for these values is found in the U.S. income tax tables. It should be noted that the user initially inputs and annually updates the values of the lower bound of the second through sixth tax brackets as the values of variables I11, I13, I16, I19, and I22. Similarly, the user initially inputs and annually updates the values of the tax rates of the first through sixth tax brackets as the values of variables I4, I10, I14, I17, I20, and I23. All of these data values are found in the U.S. income tax tables.

After step 910, process 900 proceeds to step 912, at which the value of the tax adjustment variable I5 is recalculated for the second tax bracket. The value of the variable I5 is calculated by starting with a value of one and subtracting the value of variable I10 and then subtracting the value of variable S1, which is calculated as shown in FIG. 19 and as further discussed below.

Process 900 then proceeds to 914, at which the value of the second bracket pretax income variable (i.e., variable I12) is calculated. Variable I12 is calculated by adding the value of variable I1 to the value of variable I8 and dividing the result by the value of variable I5. Process 900 then proceeds to step 916, at which the value of variable I12 is stored for future use.

Process 900 then proceeds to step 918, at which the value of the federal tax adjustment variable I1 is recalculated for the third tax bracket. Variable I1 is calculated by multiplying the value of the lower bound third tax bracket variable I13 by the value of the third tax bracket rate variable I14 and subtracting the result from the value of the taxes payable at third bracket lower bound variable I26. The value of variable I26 is calculated as depicted in FIG. 21 and as further discussed below.

After step 918, process 900 proceeds to step 920, at which the value of the tax adjustment variable I5 is recalculated for the third tax bracket. The value of the variable I5 is calculated by starting with a value of one and subtracting the value of variable I14 and then subtracting the value of variable S1, which is calculated as shown in FIG. 19 and as further discussed below.

Process 900 then proceeds to 922, at which the value of the third bracket pretax income variable (i.e., variable I15) is calculated. Variable I15 is calculated by adding the value of variable I1 to the value of variable I8 and dividing the result by the value of variable I5. Process 900 then proceeds to step 924, at which the value of variable I15 is stored for future use.

Process 900 then proceeds to step 926, at which the value of the federal tax adjustment variable I1 is recalculated for the fourth tax bracket. Variable I1 is calculated by multiplying the value of the lower bound fourth tax bracket variable I16 by the value of the fourth tax bracket rate variable I17 and subtracting the result from the value of the taxes payable at fourth bracket lower bound variable I27. The value of variable I27 is calculated as depicted in FIG. 21 and as further discussed below.

After step 926, process 900 proceeds to step 928, at which the value of the tax adjustment variable I5 is recalculated for the fourth tax bracket. The value of the variable I5 is calculated by starting with a value of one and subtracting the value of variable I17 and then subtracting the value of variable S1, which is calculated as shown in FIG. 19 and as further discussed below.

Process 900 then proceeds to 930, at which the value of the fourth bracket pretax income variable (i.e., variable I18) is calculated. Variable I18 is calculated by adding the value of variable I1 to the value of variable I8 and dividing the result by the value of variable I5. Process 900 then proceeds to step 932, at which the value of variable I18 is stored for future use.

Process 900 then proceeds to step 934, at which the value of the federal tax adjustment variable I1 is recalculated for the fifth tax bracket. Variable I1 is calculated by multiplying the value of the lower bound fifth tax bracket variable I19 by the value of the fifth tax bracket rate variable I20 and subtracting the result from the value of the taxes payable at fifth bracket lower bound variable I28. The value of variable I28 is calculated as depicted in FIG. 21 and as further discussed below.

After step 934, process 900 proceeds to step 936, at which the value of the tax adjustment variable I5 is recalculated for the fifth tax bracket. The value of the variable I5 is calculated by starting with a value of one and subtracting the value of variable I20 and then subtracting the value of variable S1, which is calculated as shown in FIG. 19 and as further discussed below.

Process 900 then proceeds to 938, at which the value of the fifth bracket pretax income variable (i.e., variable I21) is calculated. Variable I21 is calculated by adding the value of variable I1 to the value of variable I8 and dividing the result by the value of variable I5. Process 900 then proceeds to step 940, at which the value of variable I21 is stored for future use.

Process 900 then proceeds to step 942, at which the value of the federal tax adjustment variable I1 is recalculated for the sixth tax bracket. Variable I1 is calculated by multiplying the value of the lower bound sixth tax bracket variable I22 by the value of the sixth tax bracket rate variable I23 and subtracting the result from the value of the taxes payable at sixth bracket lower bound variable I29. The value of variable I29 is calculated as depicted in FIG. 21 and as further discussed below.

After step 942, process 900 proceeds to step 944, at which the value of the tax adjustment variable I5 is recalculated for the sixth tax bracket. The value of the variable I5 is calculated by starting with a value of one and subtracting the value of variable I23 and then subtracting the value of variable S1, which is calculated as shown in FIG. 19 and as further discussed below.

Process 900 then proceeds to 946, at which the value of the sixth bracket pretax income variable (i.e., variable I24) is calculated. Variable I24 is calculated by adding the value of variable I1 to the value of variable I8 and dividing the result by the value of variable I5. Process 900 then proceeds to step 948, at which the value of variable I24 is stored for future use. Process 900 then proceeds to 950, at which it ends.

Turning now to FIGS. 10A, 10B, and 10C, depicted is a process 1000 for determining the value of the Marginal Tax on Pension Income variable (i.e., variable J9). Process 1000 begins at step 1001 and proceeds to 1002. At 1002, the value of the first bracket pretax income variable I9 is queried. If variable I9 is greater than the value of the lower bound first tax bracket variable I2 and less than or equal to the value of the lower bound second tax bracket variable I11, process 1000 continues to step 1004, at which the value of the first income range taxes variable (i.e., variable J1) is calculated by subtracting variable I8 from variable I9. Variable I8 is calculated as depicted in FIG. 18 and as further discussed below. Variable I9 is determined via process 900 as discussed above. Conversely, if, at 1002, the value of variable I9 is not greater than variable I2 or is greater than the value of variable I11, then process 1000 continues to step 1006. At step 1006, the value of the variable J1 is set to equal zero. After the value of variable J1 is determined by either step 1004 or 1006, process 1000 proceeds to step 1008, at which the value of variable J1 is stored in a memory location for future use. Process 1000 then continues the same process for the other five tax brackets as further discussed below. The pretax income for each tax bracket is queried and if it is in the income range for that tax bracket, the taxes are calculated for that income range. However, if the income does not fall within the income range of the current tax bracket, taxes for that tax bracket are set to zero. In this way, taxes are potentially determined for each tax range but only calculated when the correct income range is found.

Process 1000 next proceeds to step 1010. At 1010, the value of the second bracket pretax income variable I12 is queried. If variable I12 is greater than the value of the lower bound second tax bracket variable I11 and less than or equal to the value of the lower bound third tax bracket variable I13, process 1000 continues to step 1012, at which the value of the second income range taxes variable (i.e., variable J2) is calculated by subtracting variable I8 from variable I12. Variable I12 is determined via process 900 as discussed above. Conversely, if, at 1010, the value of variable I12 is not greater than variable I11 or is greater than the value of variable I13, then process 1000 continues to step 1014. At step 1014, the value of the variable J2 is set to equal zero. After the value of variable J2 is determined by either step 1012 or 1014, process 1000 proceeds to step 1016, at which the value of variable J2 is stored in a memory location for future use.

Process 1000 next proceeds to step 1018. At 1018, the value of the third bracket pretax income variable I15 is queried. If variable I15 is greater than the value of the lower bound third tax bracket variable I13 and less than or equal to the value of the lower bound fourth tax bracket variable I16, process 1000 continues to step 1020, at which the value of the third income range taxes variable (i.e., variable J3) is calculated by subtracting variable I8 from variable I15. Variable I15 is determined via process 900 as discussed above. Conversely, if, at 1018, the value of variable I15 is not greater than variable I13 or is greater than the value of variable I16, then process 1000 continues to step 1022. At step 1022, the value of the variable J3 is set to equal zero. After the value of variable J3 is determined by either step 1020 or 1022, process 1000 proceeds to step 1024, at which the value of variable J3 is stored in a memory location for future use.

Referring now to FIG. 10B, process 1000 next proceeds to step 1026. At 1026, the value of the fourth bracket pretax income variable I18 is queried. If variable I18 is greater than the value of the lower bound fourth tax bracket variable I16 and less than or equal to the value of the lower bound fifth tax bracket variable I19, process 1000 continues to step 1028, at which the value of the fourth income range taxes variable (i.e., variable J4) is calculated by subtracting variable I8 from variable I18. Variable I18 is determined via process 900 as discussed above. Conversely, if, at 1026, the value of variable I18 is not greater than variable 116 or is greater than the value of variable I19, then process 1000 continues to step 1030. At step 1030, the value of the variable J4 is set to equal zero. After the value of variable J4 is determined by either step 1028 or 1030, process 1000 proceeds to step 1032, at which the value of variable J4 is stored in a memory location for future use.

Process 1000 next proceeds to step 1034. At 1034, the value of the fifth bracket pretax income variable I21 is queried. If variable I21 is greater than the value of the lower bound fifth tax bracket variable I19 and less than or equal to the value of the lower bound sixth tax bracket variable I22, process 1000 continues to step 1036, at which the value of the fifth income range taxes variable (i.e., variable J5) is calculated by subtracting variable I8 from variable I21. Variable I21 is determined via process 900 as discussed above. Conversely, if, at 1034, the value of variable I21 is not greater than variable I19 or is greater than the value of variable I22, then process 1000 continues to step 1038. At step 1038, the value of the variable J5 is set to equal zero. After the value of variable J5 is determined by either step 1036 or 1038, process 1000 proceeds to step 1040, at which the value of variable I5 is stored in a memory location for future use.

Process 1000 then proceeds to step 1042. At 1042, the value of the sixth bracket pretax income variable I24 is queried. If variable I24 is greater than the value of the lower bound sixth tax bracket variable I22, process 1000 continues to step 1044, at which the value of the sixth income range taxes variable (i.e., variable J6) is calculated by subtracting variable I8 from variable I24. Variable I24 is determined via process 900 as discussed above. Conversely, if, at 1042, the value of variable I24 is not greater than variable I22, then process 1000 continues to step 1046. At step 1046, the value of the variable J6 is set to equal zero. After the value of variable J6 is determined by either step 1044 or 1046, process 1000 proceeds to step 1048, at which the value of variable J6 is stored in a memory location for future use.

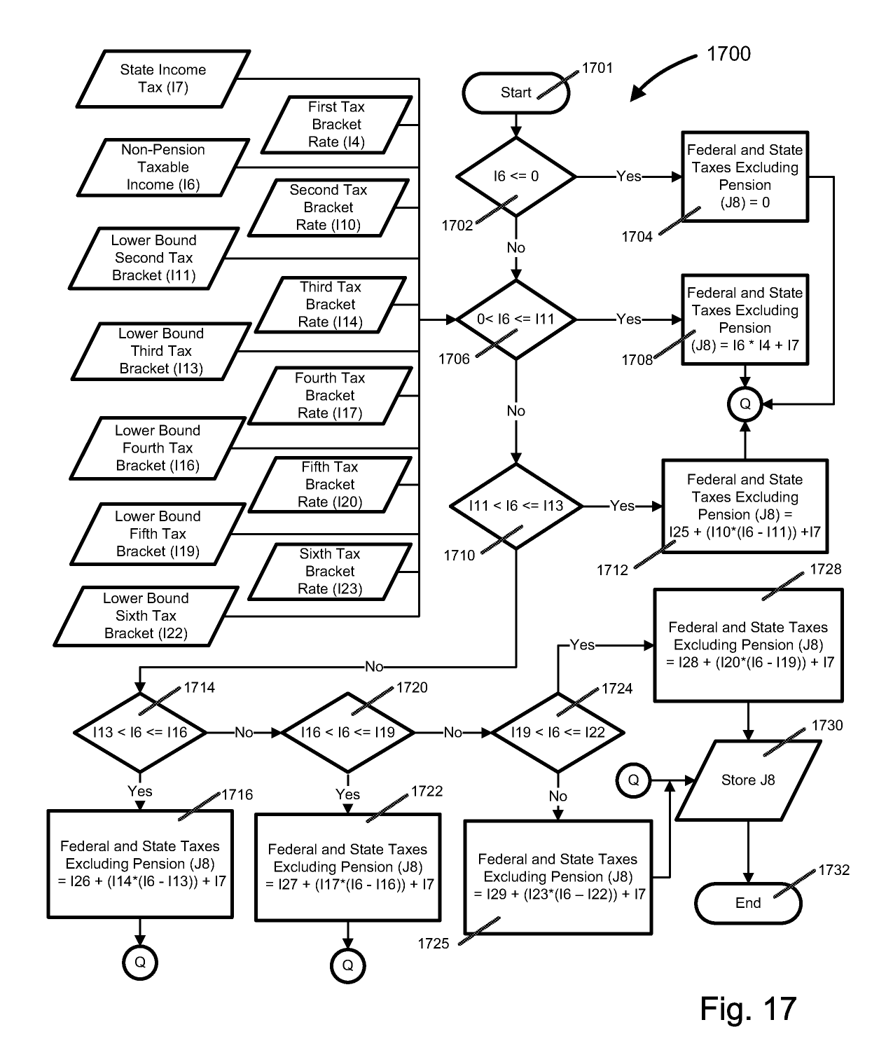

Process then proceeds to 1050 as depicted in FIG. 10C. At 1050, process 1000 calculates the value of the taxes on income variable (i.e., variable J7) by summing the previously calculated variables J1 through J6. By calculating the taxes for each tax bracket separately and then summing the results, method 1000 ensures that the proper tax bracket is used to calculate the total Taxes on Income. Process 1000 then proceeds to step 1052, at which the value of the Marginal Tax on Pension Income variable (i.e., variable J9) is calculated by subtracting the value of the federal and state taxes excluding pension variable (i.e., variable J8) from variable J7. Variable J8 is determined as depicted in FIG. 17 as further discussed below. This calculation takes the value of the total taxes on income variable J7 and subtracts the taxes on non-pension income in order to determine the taxes on pension alone. Process 1000 then proceeds to step 1054, at which the values of variables J7 and J9 are stored in a memory location for future use. Thereafter, process 1000 proceeds to 1056, at which it ends.

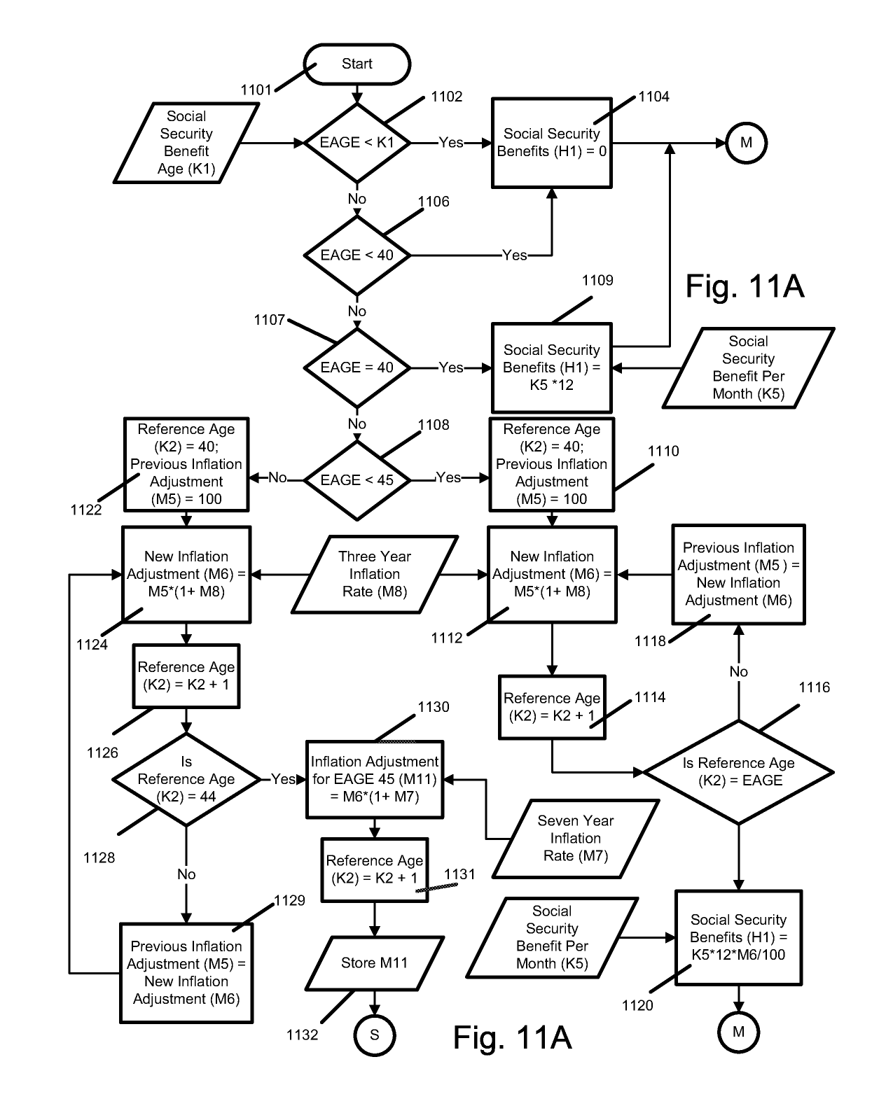

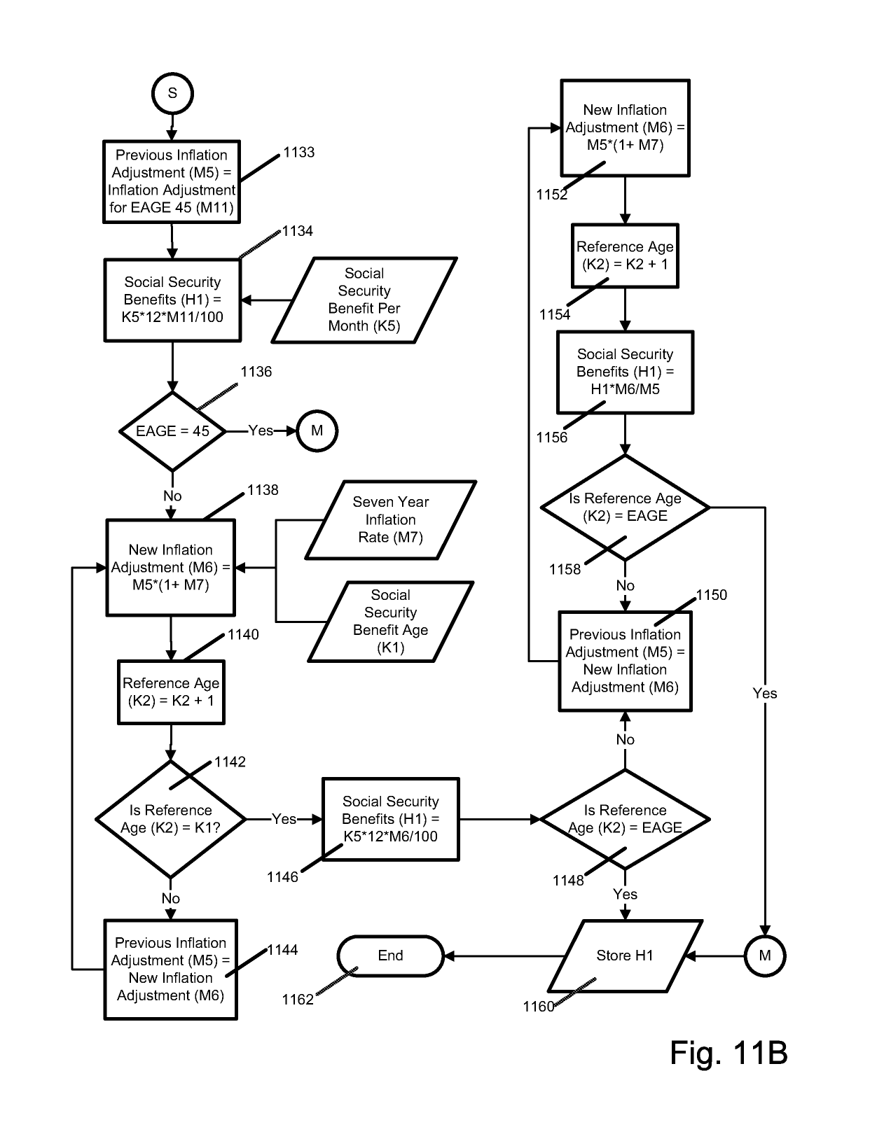

Turning now to FIG. 11, depicted is a process 1100 for determining the value of the social security benefits variable (i.e., variable H1). Process 1100 begins at step 1101 and proceeds to 1102, at which the value of the EAGE variable is queried. If the value of the EAGE variable is less than the value of the social security benefit age variable (i.e., variable K1), then process 1100 proceeds to step 1104, at which the value of variable H1 is set to zero. The value of variable H1 is set to zero in this step because a person who is under the age at which social security benefits begin (i.e., the value of variable K1) is assumed to choose not to collect any social security benefits until reaching the age of K1. The value of the social security benefit age variable K1 is initially input by the user or an automated processing unit. In an exemplary embodiment of the present invention, the value of K1 is set to be 67. However, any age greater than or equal to 62 may be substituted for age 67 without departing from the scope of the present invention. Age 62 is the lowest age at which the current Social Security laws allow for collection of such benefits. Hence, the value of 67 will not need to be updated by the user or an automated processing unit unless desires to do so, for example, due to a significant change in the law that would make it beneficial to begin collecting social security at a different age. Process 1100 then proceeds to step 1160, at which the value of variable H1 is stored in a memory location for future use. Process 1100 then proceeds to 1162, at which it ends.

Conversely, if, at step 1102, the value of the EAGE variable is greater than or equal to the value of variable K1, process 1100 proceeds to step 1106. At step 1106, the value of the EAGE variable is queried to determine if it is less than 40. If yes, process 1100 proceeds to step 1104, at which the value of the variable H1 is set equal to zero. Process 1100 then proceeds to 1160 as depicted in FIG. 11B and as further discussed below. Alternatively, if EAGE is not less than 40, process 1100 proceeds to step 1107. At step 1107, the value of the EAGE variable is queried to determine if it is equal to forty (40). If yes, process 1100 proceeds to 1109, at which the value of the social security benefits variable H1 is calculated to be the product of the value of variable K5 multiplied by twelve (12). Process 1100 then proceeds to 1160 as depicted in FIG. 11B and as further discussed below.

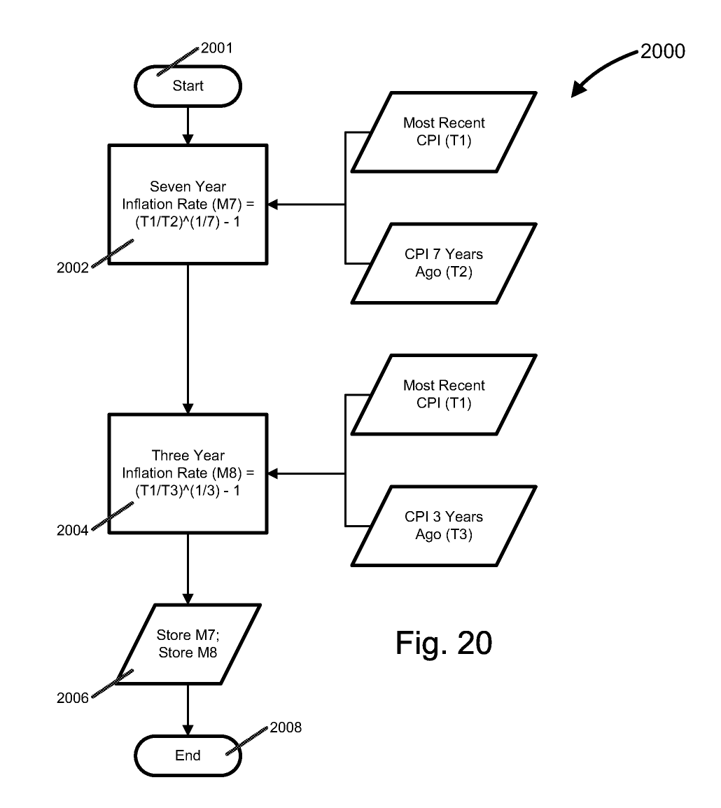

If, at 1107, the value of the EAGE variable is not equal to forty (40), process 1100 proceeds to step 1108. At step 1108, the value of the EAGE variable is compared to 45. If it is found to be greater than or equal to 45, process 1100 proceeds to step 1122. However, if the value of the EAGE variable is less than 45, then process 1100 proceeds to step 1110. The values of variables M7 and M8, which are used in process 1100, are determined as depicted in FIG. 20 and as further discussed below.

If the value of the EAGE variable is less than 45, process 1100 proceeds to step 1110, at which the value of the reference age variable K2 is set to forty and the value of the previous inflation adjustment variable M5 is set to 100. Next, at step 1112, the value of the new inflation adjustment variable M6 is calculated to be the result of the multiplication of variable M5 by the sum of one plus the value of the three year inflation rate variable M8. Process 1100 then proceeds to step 1114, at which the value of the reference age variable K2 is increased by one. Next, at step 1116, the value of the reference age variable K2 is queried to determine if it equals the value of the EAGE variable. If yes, inflation has been properly adjusted, and process 1100 proceeds to step 1120, at which the value of the social security benefits variable (i.e., variable H1) is calculated. Variable H1 is calculated as the product of twelve multiplied by the value of the social security benefit per month variable K5 multiplied by the result of dividing the value of variable M6 by 100. The resulting value represents an inflation adjusted value for social security benefits. Process 1100 then proceeds to step 1160, at which the value of variable H1 is stored in a memory location for future use. The process then terminates at step 1162.

However, if the value of the reference age variable K2 is not equal to the value of the EAGE variable, then process 1100 proceeds to step 1118. Step 1118 sets the value of the previous inflation adjustment variable M5 to be equal to the value of variable M6. The process then repeats until the value of the reference age variable K2 is equal to the value of the EAGE variable.

Conversely, if, at 1108, the value of the EAGE variable is greater than or equal to 45, process 1100 proceeds to step 1122, at which value of the reference age variable K2 is set to forty and the value of the previous inflation adjustment variable is set to 100. Next, at step 1124, the value of the new inflation adjustment variable M6 is calculated to be the result of the multiplication of the value of variable M5 by the sum of one plus the value of the three year inflation rate variable M8. Process 1100 then proceeds to step 1126, at which the value of the reference age variable K2 is increased by one. Next, step 1128 queries the reference age. If it is equal to 44, then inflation has been properly adjusted, and process 1100 proceeds to step 1130, at which inflation adjustment for EAGE 45 (i.e., variable M11) is calculated as the product of the value of variable M6 times one plus the seven year inflation rate (i.e., variable M7). Next, at step 1131, the value of the reference age variable K2 is increased by one. Process 1100 then proceeds to 1132, at which the value of variable M11 is stored for use in future calculations. Process 1100 then proceeds to 1133 as depicted in FIG. 11B and as further discussed below. However, if, at 1128, the value of the reference age variable K2 is not equal to forty four (44), process 1100 proceeds to 1129, at which the value of the previous inflation adjustment variable M5 is set to equal the value of variable M6. The process then repeats steps 1124 through 1129 until the value of the reference age variable K2 is equal to 44 at step 1128.

The value of the social security benefit per month variable K5 is initially input by the user or an automated processing unit and it is updated on a monthly basis. The data for variable K5 may be found at the Web site http://www.ssa.gov/retire2/AnypiaApplet.html. This Web site is a social security benefit calculator that is used to determine benefits. To determine the required data, the user enters a date of birth assuming that they were born forty (40) years ago today. He or she then enters a retirement age of 67. Next, the user must input the wages for each year from which the EAGE variable equals 23 up to the year at which the EAGE variable equals 39 in the annual earnings for the most recent years. The user must input the wages for the year during which EAGE equals 40 in the earnings for the current year. For earnings in the next year and later, the user must input the average wages from the years in which EAGE equals 41 and 66.

The user must input the earliest age at which the value of the wealth at death variable, A13, is positive for the current retirement age. Based on that value, the user determines the average wages between the years in which EAGE equals 41 and 66. The value of wages in one or more of those years (i.e., the years between an EAGE of 41 and an EAGE of 66) can be affected by the value of A13. Hence, the value of A13 can affect the average wages between the years in which EAGE equals 41 and 66.

After all of these values are inputted, the user clicks calculate benefit and enters the calculated value for the monthly retirement benefit as the value of the social security benefit per month variable K5. The user must then check if this updated value has resulted in a change in the value for the earliest age at which the value of the wealth at death variable A13 is positive. If the value for the earliest age at which the value of the wealth at death variable A13 is positive has not changed, the user has completed the computation of the value of the social security benefit per month variable K5. If the value for the earliest age at which the value of the wealth at death variable A13 is positive has changed, then there will be a change in the value of the year of the calculated U.S. average retirement age index variable A9. Consequently, there will be a change in the value of average wages between, an EAGE of 41 and an EAGE of 66. Then the user must update the value for earnings in the Web site to reflect a new average of wages between an EAGE of 41 and an EAGE of 66 based upon the new value of the calculated U.S. average retirement age index variable A9. The user again clicks calculate benefit, enters the resulting monthly retirement benefit for variable K5 and checks again whether a change in the value for the earliest age at which the value of the wealth at death variable A13 is positive has occurred. If the value for the earliest age at which the value of the wealth at death variable A13 is positive has not changed, the user has completed the computation of the value of the social security benefit per month variable K5. If the value for the earliest age at which the value of the wealth at death variable A13 is positive has changed, then there will be a change in the value of the year of the calculated U.S. average retirement age index variable A9. The user must then calculate the average of the two previously calculated values for average of wages between an EAGE of 41 and an EAGE of 66. The user must then update the value for earnings in the Web site to reflect this new average of wages between an EAGE of 41 and an EAGE of 66. The user again clicks calculate benefit and enters the resulting monthly retirement benefit for variable K5. The user has then completed the computation of the social security benefit.

Turning now to FIG. 11B, step 1133 is completed after step 1132 on FIG. 11A. Step 1133 sets the value of the Previous Inflation Adjustment variable M5 equal to the value of the Inflation Adjustment for EAGE 45 variable M11. Next, step 1134 calculates a value for the social security benefits variable H1 as the product of twelve multiplied by the value of the social security benefit per month variable K5 multiplied by the result of dividing the value of variable M11 by 100. The resulting value represents an inflation adjusted value for social security benefits. Next, step 1136 queries the value of the EAGE variable to determine if it is equal to 45. If it is equal to forty five, process 1100 then proceeds to step 1160, at which the value of H1 is stored in a memory location for future use. The process then terminates at step 1162.

Alternatively, if, at 1136, the value of the EAGE variable is not equal to 45, process 1100 proceeds to step 1138, at which the value of the new inflation adjustment variable M6 is calculated to be the result of the multiplication of the value of variable M5 by the sum of one plus the value of the seven year inflation rate variable M7. Process 1100 then proceeds to step 1140, at which the value of the reference age variable K2 is increased by one. Next, at step 1142, the value of the reference age variable K2 is queried to determine if it equals the value of the social security benefit age variable K1. If yes, inflation has been properly adjusted for every year prior to the social security benefit age, and process 1100 proceeds to step 1146, at which the value of the social security benefits variable (i.e., variable H1) is calculated using the same calculation as step 1120 as discussed above. However, if the value of the reference age variable K2 is not equal to the value of variable K1, then process 1100 proceeds to step 1144. Step 1144 sets the value of the previous inflation adjustment variable M5 to be equal to the value of variable M6. The process then repeats steps 1138 through 1144 until the value of the reference age variable K2 is equal to the value of social security benefit age (i.e., variable K1), at which point process 1100 proceeds to 1146.

After step 1146, process 1100 proceeds to step 1148, at which the value of reference age variable K2 is queried to determine if it is equal to the current value of the EAGE variable. If yes, process 1100 proceeds to step 1160, at which the value of variable H1 is stored in a memory location for future use. The process then terminates at step 1162. Conversely, if, at 1148, the value of K2 is not equal to the value of the EAGE variable, step 1150 is performed. In step 1150, the value of the previous inflation adjustment variable M5 is set to equal the value of the new inflation adjustment variable M6. Process 1100 then proceeds to step 1152, at which the value of the new inflation adjustment variable M6 is calculated to be the result of the multiplication of the value of variable M5 by the sum of one plus the value of the seven year inflation rate variable M7. Process 1100 then proceeds to step 1154, at which the value of the reference age variable K2 is increased by one. Next, step 1156 calculates the value of the social security benefits variable H1 as the product of the value of the social security benefits variable times the result of the value of variable M6 divided by the value of variable M5. For EAGE values greater than the age at which social security benefits are started (i.e., variable K1), social security benefits must be projected based upon inflation and therefore must be updated each time the reference age is incremented. For EAGE value equal to the value of variable K1, the value of the social security benefits variable (i.e., variable H1) is calculated based upon the current value of the social security benefit per month variable (i.e., variable K5). Step 1158 then queries the value of the reference age variable. If it is equal to the value of the EAGE variable, then the value of the social security benefits variable has been properly adjusted for inflation, and process 1100 proceeds to step 1160 at which the value of HI is stored in a memory location for future use. The process then terminates at step 1162.

However, if, at 1158, the value of the reference age variable K2 is not equal to the value of the EAGE variable, process 1100 proceeds to 1150, at which the value of the previous inflation adjustment variable M5 is set to equal the value of variable M6. The process then repeats steps 1150 through 1158 until the value of the reference age variable K2 is equal to the value of the EAGE variable, at which point process 1100 proceeds to 1160 as discussed above and terminates at 1162.

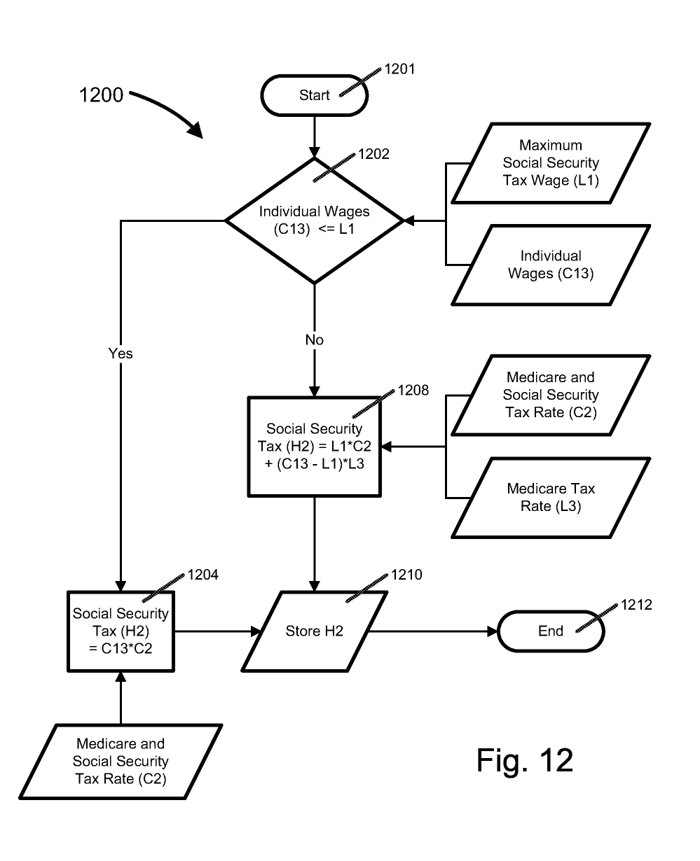

Turning now to FIG. 12, a process 1200 for determining the value of the social security tax variable (i.e., variable H2) is depicted. Process 1200 begins with step 1201 and proceeds to step 1202, at which the value of the individual wages variable (i.e., variable C13) is queried. If the value of variable C13 is less than or equal to the value of the maximum social security tax wage variable (i.e., variable L1), then process 1200 proceeds to step 1204. The value of variable L1 is initially input by the user or an automated processing unit and it is updated on an annual basis. The data for variable L1 may be obtained from the U.S. Social Security Administration.

At step 1204, process 1200 calculates the value of the social security tax variable H2 by multiplying the value of variable C13 by the value of the Medicare and social security tax rate variable C2. The value of the variable C2 is initially input by the user or an automated processing unit and may or may not need to be updated depending upon any legislative changes. The data for variable C2 may be obtained from the U.S. Social Security Administration. If the wages are less than the maximum wage for which social security tax is applied, then the social security tax calculation is merely the tax rate times the wage. Process 1200 then proceeds to step 1210, at which the value of the variable H2 is stored in a memory location for future use. Process 1200 then proceeds to 1212, at which it terminates.

Conversely, if, at step 1202, the value of variable C13 is greater than the value of variable L1, then process 1200 proceeds to step 1208. This step calculates the Social Security and Medicare tax for wages equal to the maximum social security tax wage and then adds the Medicare tax for any wages above the maximum social security tax wage. That is, step 1208 calculates the value of variable H2 by summing the following: the value that results from multiplying the values of variables L1 and C2; and the value that results from multiplying the value of the Medicare tax rate variable L3 by the difference between the values of variable C13 and variable L1. Next, process 1200 proceeds to step 1210, at which the value of the variable H2 is stored in a memory location for future use. Process 1200 then proceeds to 1212, at which it terminates. The value of the variable L3 is initially input by the user or an automated processing unit and may or may not need to be updated depending upon any legislative changes. The data for variable L3 may be obtained from the U.S. Social Security Administration.

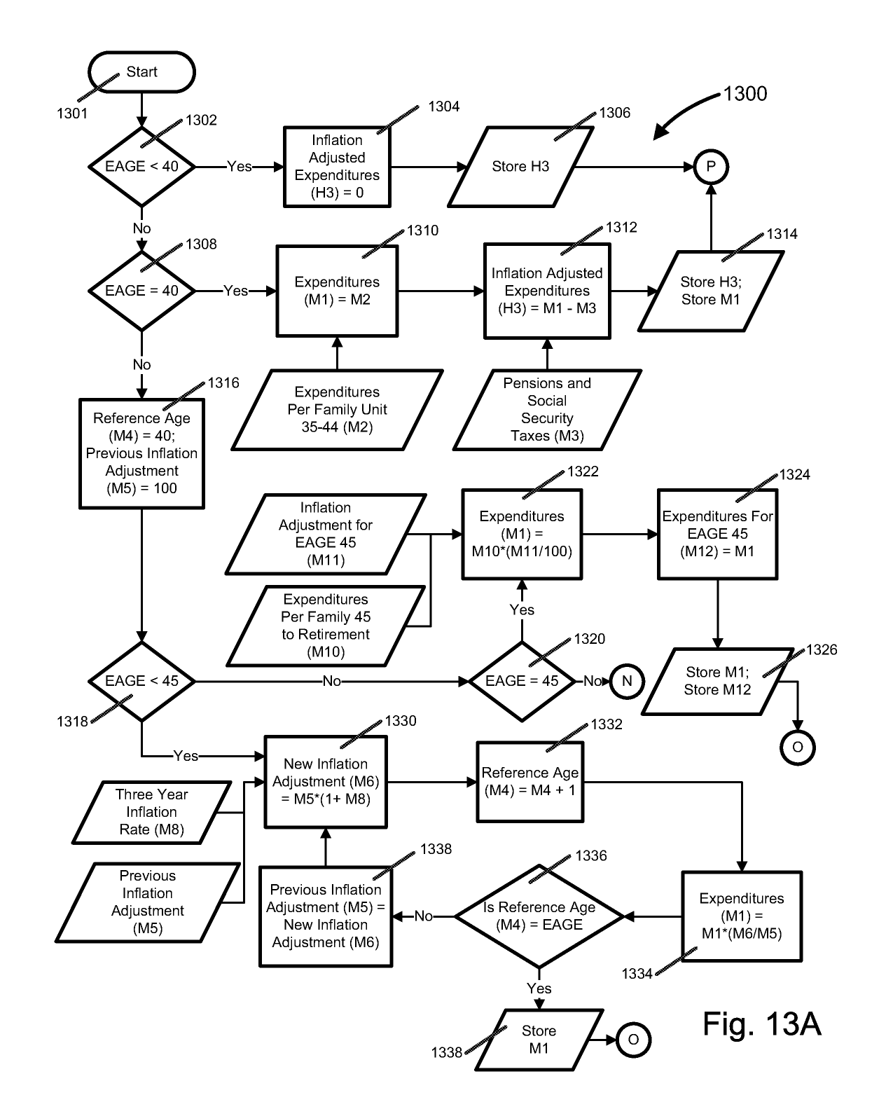

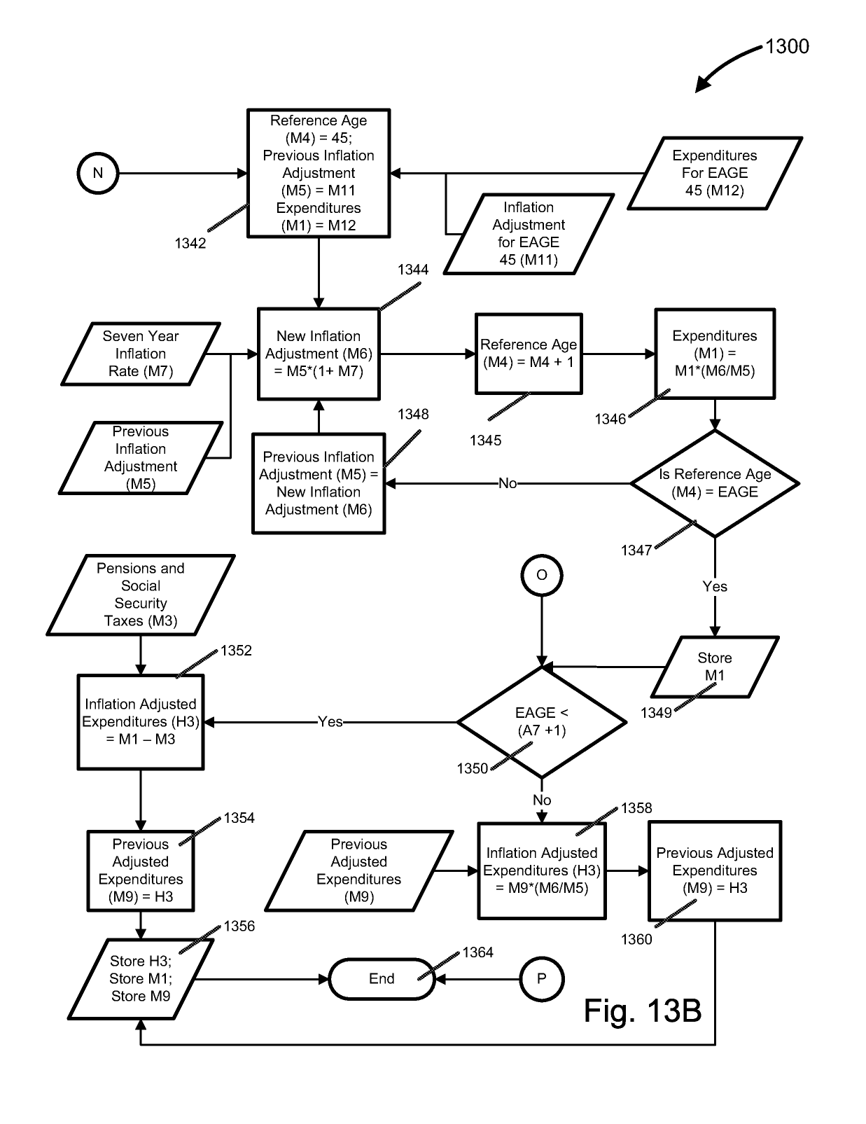

Referring now to FIGS. 13A and 13B, depicted is a process 1300 for calculating the value of the inflation adjusted expenditures variable (i.e., variable H3). Process 1300 begins at step 1301 after which it proceeds to 1302. At 1302, the value of the EAGE variable is compared to forty (40). If the value of the EAGE variable is less than forty, process 1300 proceeds to step 1304, at which it sets the value of variable H3 equal to zero. Process 1300 then proceeds to step 1306, at which it stores the value of variable H3 in a memory location for future use. Process 1300 then proceeds to 1364, at which it ends.

Conversely, if, at 1302, the value of the EAGE variable is greater than or equal to forty, process 1300 proceeds to step 1308. At step 1308, process 1300 determines whether the value of the EAGE variable is equal to forty (40). If yes, step 1310 sets the value of the expenditures variable MI to equal the value of the expenditures per family unit 35-44 variable M2. The value of variable M2 is initially input by the user or an automated processing unit and it is updated on an annual basis. The data for this variable is provided via the following Web site: http://www.bls.gov/cex/tables.htm. To access the data, the user clicks the PDF link for “Age of Reference Person”. On the first page of the document, the user selects the value listed for 35-44 years for “Average annual expenditures”. The user may also find the data required for the expenditures per family 45 to retirement variable (i.e., variable M10) from this Web site. Data for variable M10 is found under age 45-54 years for “Average annual expenditures”. It should be noted that data is also available for age 55-64 years and above. However, this data will be influenced by the retirement of many individuals in these age categories and, consequently, family expenditure patterns will be affected, or biased, by retirements that occur prior to the average retirement age. Therefore, in order to calculate the age at which retirement can occur, family expenditures data is not used for any age group above 45-54 years.

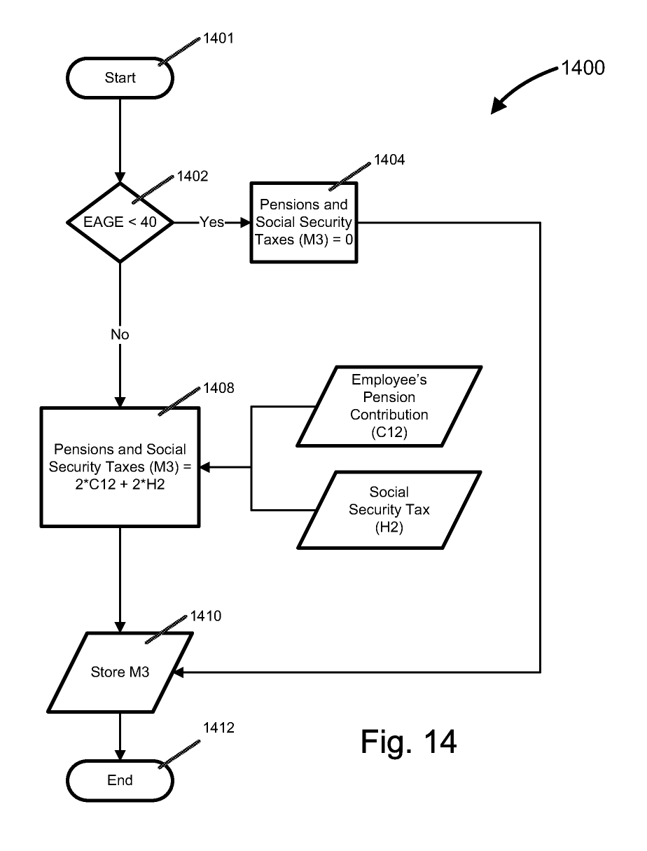

After setting the value of the variable M1 at step 1310, process 1300 proceeds to step 1312, at which the value of variable H3 is calculated by subtracting the value of the pensions and social security taxes variable (i.e., variable M3) from the value of variable M1. The value of variable M3 is calculated as depicted in FIG. 14 and as further discussed below. Process 1300 then proceeds to step 1314, at which it stores the values of variables H3 and M1 in a memory location for use in future calculations. The process then terminates at 1364.

Conversely, if, at step 1308, the value of the EAGE variable is not equal to 40, process 1300 proceeds to step 1316, at which the value of the reference age variable M4 is set to 40 and the value of the previous inflation adjustment variable M5 is set to 100 to establish starting values for these variables. Process 1300 then proceeds to 1318, at which the value of the EAGE variable is compared to 45. If it is found to be less than 45, process 1300 proceeds to steps 1330 through 1338. However, if the value of the EAGE variable is greater than or equal to 45, then steps 1320 through 1326 are completed instead. It should be noted that both of these pathways are required to account for incorporation of a Seven Year Inflation Rate (i.e., variable M7) or a Three Year Inflation Rate (i.e., variable M8). Variables M7 and M8 are determined as depicted in FIG. 20 and further discussed below. A seven year inflation rate is used for an EAGE having a value above 44 while a three year inflation rate is used for an EAGE having a value of 41 through 44.

If the value of the EAGE variable is greater than or equal to 45, process 1300 proceeds to step 1320, at which the value of the EAGE variable is queried to determine if it is equal to 45. From step 1320, if the value of the EAGE variable is not equal to forty-five, process 1300 proceeds to step 1342 as further discussed below. Alternatively, if the value of the EAGE variable is equal to forty-five, process 1300 proceeds to step 1322, at which expenditures (i.e., variable M1) is calculated as the product of the value of the expenditures per family 45 to retirement variable (i.e., variable M10) multiplied by the result of the value of the inflation adjustment for EAGE 45 variable (i.e., variable M11) divided by 100. The value of variable M11 is calculated as depicted in FIGS. 11A and 11B as further discussed above. Next, at step 1324, the value of the expenditures for EAGE 45 variable (i.e., variable M12) is set to equal the value of variable M1. Step 1326 of process 1300 then stores the value of variable M12 in a memory location for future use and stores the value of variable M1 in a table of values corresponding to the current value of the EAGE variable. Process 1300 then proceeds to step 1350, as discussed below.

As discussed above, if, at step 1318, the value of the EAGE variable is less than 45, process 1300 proceeds to step 1330, at which the value of the new inflation adjustment variable M6 is calculated to be the result of the multiplication of the value of variable M5 by the result of the sum of one plus the value of the three year inflation rate variable M8.

From step 1330, process 1300 proceeds to step 1332, at which the value of variable M4 is incremented by one. Process 1300 then proceeds to step 1334, at which the value of the expenditures variable (i.e., M1) is calculated for the current value of the EAGE variable by multiplying the value of variable M1 by the result of the value of variable M6 divided by the value of variable M5. In this instance, the value for M1 calculated from the previous EAGE value (i.e., the value calculated when this process was previously run and stored in a memory location) is adjusted for inflation rather than working from a known value. Next, at step 1336, the value of the reference age variable M4 is compared to the value of the EAGE variable. If they are equal, then the correct values have been established for variable M1 and the process continues to step 1338, at which the value of variable M1 is stored in a table of values corresponding to the current value of the EAGE variable. Process 1300 then proceeds to step 1350, as depicted in FIG. 13B as further discussed below.

If, at 1336, the value of the reference age variable M4 is not equal to the value of the EAGE variable, then a greater adjustment must be made for inflation, and process 1300 proceeds to step 1338. This step sets the value of variable M5 equal to the value of variable M6. In this manner, when step 1330 is completed again, variable M6 will be recalculated based upon the value of variable M5. Process 1300 will repeat steps 1330 to 1338 until the value of the variable M4 is equal to the value of the EAGE variable.

Turning now to FIG. 13B, process 1300 continues from step 1320 via step 1342, at which: the value of the reference age variable M4 is set to 45; the value of the expenditures variable M1 is set to equal the value of the expenditures for EAGE 45 variable M12; and the value of the previous inflation adjustment variable M5 is set to equal the value of the inflation adjustment for EAGE 45 variable (i.e., M11) to establish starting values for these variables. Next, at step 1344, the value of the new inflation adjustment variable M6 is calculated by multiplying the value of variable M5 by the result of the sum of one plus the value of the seven year inflation rate variable M7. Step 1345 then increments the value of the reference age variable M4 by one.

Process 1300 then proceeds to step 1346, at which value of the expenditures variable M1 is updated by multiplying the value of variable M1 by the result of the value of variable M6 divided by the value of variable M5. In this instance, the value calculated from the value at EAGE 45 (i.e., the value calculated when this process was previously run and stored in a memory location) is adjusted for inflation and is therefore more accurate as compared to using a fixed value such as the value of variables M2 or M10. Next, at 1347, the value of the reference age variable M4 is compared to the value of the EAGE variable. If they are equal, then the correct value has been established for the expenditures variable M1, and the process continues to step 1349, at which the value of variable MI is stored in a table of values corresponding to the current value of the EAGE variable. Process 1300 then proceeds to step 1350 as further discussed below.

If, at 1347, the value of the reference age variable M4 is not equal to the value of the EAGE variable, then a greater adjustment must be made for inflation, and process 1300 proceeds to step 1348. This step sets the value of the variable M5 equal to the value of variable M6. In this manner, when step 1346 is completed again, variable M6 will be recalculated based upon variable M5 to account for inflation adjustment. Steps 1344 through 1348 are repeated until, at 1347, the value of the reference age variable M4 is equal to the value of the EAGE variable. At this point, the value of variable MI is stored in step 1349 and process 1300 proceeds to 1350. It should be noted that step 1350 is completed after steps 1326, 1338, and 1349, all of which store the current value of the expenditures variable M1 after calculating the value of this variable based on various factors. Step 1350 queries the value of the EAGE variable to determine if it is less than the sum of one plus the value of the retirement age variable A7. If yes, process 1300 proceeds to step 1352, at which the value of the inflation adjusted expenditures variable H3 is calculated by subtracting the value of the pensions and social security taxes variable (i.e., variable M3) from the value of the expenditures variable M1. The value of variable M3 is calculated as depicted in FIG. 14 and as further discussed below. Process 1300 then proceeds to step 1354, at which the value of the previous adjusted expenditures variable M9 is set to equal the value of variable H3. This value is required for the next iteration of the calculation performed when the value of the EAGE variable is greater than or equal to the sum of the value of the retirement age variable A7 plus one. Process 1300 then proceeds to 1356, at which the values of variables H3, M1, and M9 are stored in memory locations for future use. The process then terminates at 1364.

If, at step 1350, the value of the EAGE variable is greater than or equal to the sum of the value of the retirement age variable A7 plus one, process 1300 proceeds to step 1358, at which the value of the inflation adjusted expenditures variable H3 is calculated by multiplying the value of variable M9 by the result of the division of the value of the variable M6 by the value of the variable M5. When the value of the EAGE variable is less than the sum of the value of the retirement age variable A7 plus one, the value of the pensions and social security taxes variable M3 must be subtracted from the value of variable M1. However, when the value of the EAGE variable is greater than the value of the retirement age variable A7 plus one, the value of the variable M3 will be zero. After calculating the value of variable H3, process 1300 proceeds to step 1360, at which it sets the value of the previous adjusted expenditures variable M9 equal to the value of variable H3. Process 1300 then proceeds to 1356, at which the values of variables H3, M1, and M9 are stored in memory locations for future use. The process then terminates at 1364.

Turning now to FIG. 14, depicted is a process 1400 for calculating the value of the pensions and social security taxes variable (i.e., variable M3). Process 1400 begins at step 1401 and proceeds to 1402, at which the value of the EAGE variable is queried to determine if it is less than 40. If yes, process 1400 proceeds to step 1404 and sets the value of variable M3 equal to zero. Process 1400 then proceeds to 1410, at which the value of variable M3 is stored in a memory location for future use. The process then terminates at 1412.

Conversely, if, at 1402, the value of the EAGE variable is greater than or equal to 40, process 1400 proceeds to step 1408, at which it calculates the value of variable M3 to be the sum of: the value of the wife's employee's pension contribution variable C12; the value of the husband's employee's pension contribution C12; and the result of two multiplied by the value of the social security tax variable H2. This calculation sums each partner's pension contribution and each partner's Social Security taxes. These variables are determined in FIGS. 3A, 3B, and 12, respectively, as discussed in greater detail above. After variable M3 is calculated, process 1400 proceeds to 1410, at which the value of variable M3 is stored in a memory location for future use. The process then terminates at 1412.

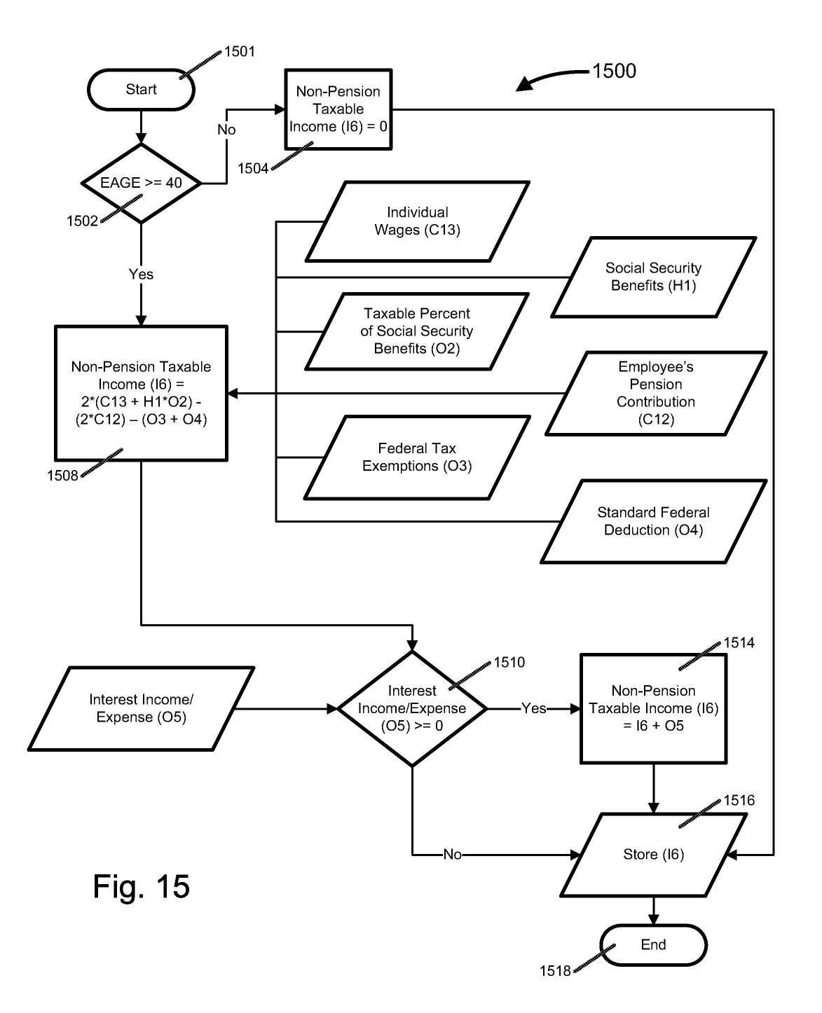

Referring now to FIG. 15, depicted is a process 1500 for calculating the value of the non-pension taxable income variable (i.e., variable I6). Process 1500 begins at 1501 and proceeds to step 1502, at which the value of the EAGE variable is queried. If the value of the EAGE variable is less than 40, process 1500 proceeds to step 1504, at which it sets the value of variable I6 equal to zero. Process 1500 then proceeds to 1516, at which the value of variable I6 is stored in a memory location for future use. The process then terminates at 1518.

Conversely, if, at 1502, the value of the EAGE variable is greater than or equal to 40, process 1500 proceeds to step 1508, at which it calculates the value of variable I6. This calculation first sums the value of variable C13 and the result of the multiplication of the values of variables H1 and O2. This value is then multiplied by two. From the resulting value, the sum of the values of variables O3 and O4 is subtracted. Two times the value of the employee's pension contribution variable C12 is also subtracted. The value of variable O2 is initially input by the user or an automated processing unit. In an exemplary embodiment of the present invention, the value of O2 is set to be the maximum percentage under the tax code (i.e., 85%). It is updated on an annual basis if there are changes in the laws regarding the portion of social security income that is taxable. However, other estimates for O2 could be employed without departing from the scope of the present invention. The values of variables O3 and O4 are initial input by the user or an automated processing unit and they are also updated on an annual basis. The data for these variables may be found at the following Web site: http://www.dinkytown.net/java/TaxMargin.html or can easily be obtained from the U.S. tax codes. At the Web site, the user must input the value of the wages per family aged 35-44 variable C3 into the “Wages, salaries, tips, etc:” field. The user must also select married filing jointly for filing status. Then the user selects “not a dependent” and enters zero for the number of dependents and itemized deductions. Finally, the user clicks the calculate button and then the view report button. The value listed for “Deduction for exemptions” should be input as the value of variable O3 and the value listed for “Standard deduction” should be input as the value of the variable O4. It should be noted that other deductions and exemptions under the tax code could be employed, such as exemptions for dependents, without departing from the scope of the present invention.

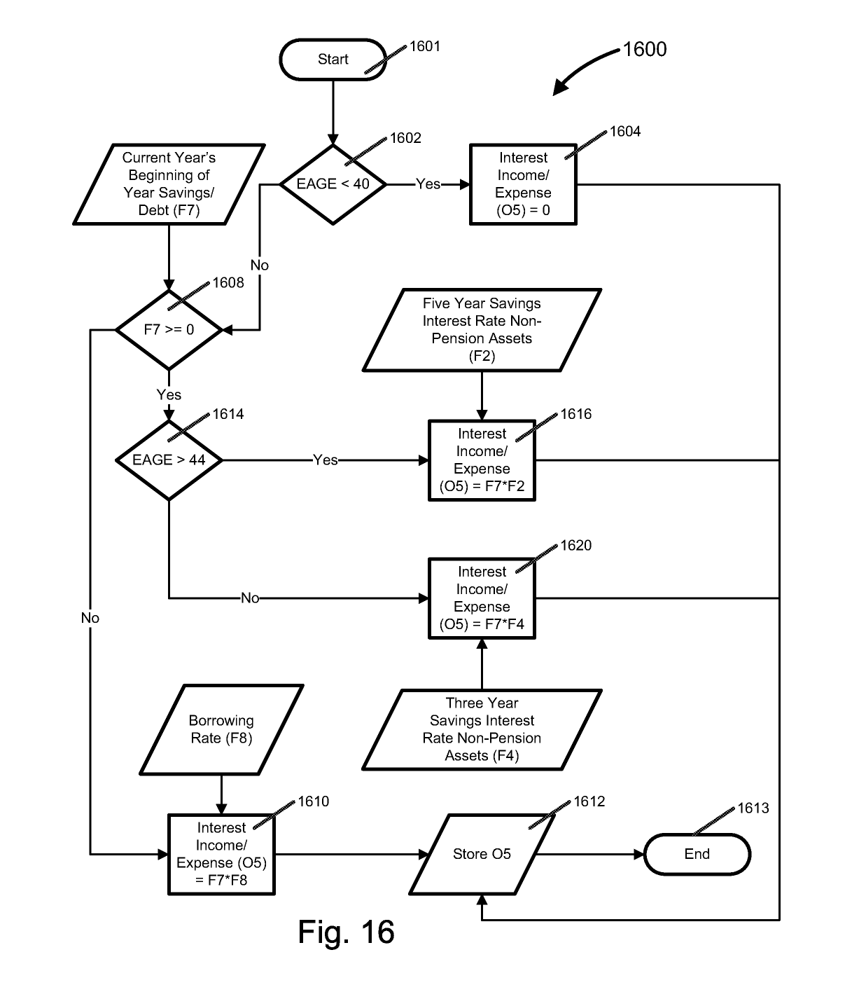

Process 1500 then proceeds to step 1510, at which the interest income/expense variable O5 is queried. Variable O5 is calculated as depicted in FIG. 16 and as further discussed below. If variable O5 is less than zero, process 1500 proceeds to 1516, at which the value of variable I6 is stored in a memory location for future use. The process then terminates at 1518.

Alternatively, if the value of variable O5 is greater than or equal to zero, process 1500 proceeds to step 1514, at which the value of variable I6 is set to the value of the sum of the values of variable I6 and O5. This calculation is required to account for the potential taxable income incurred due to interest paid on savings. If the value for interest is positive, it must be included when calculating taxable income. Process 1500 then proceeds to 1516, at which the value of variable I6 is stored in a memory location for future use. The process then terminates at 1518.

Referring now to FIG. 16, depicted is a process 1600 for calculating the value of the interest income/expense variable (i.e., variable O5). Process 1600 begins at step 1601 and proceeds to 1602, at which the value of the EAGE variable is queried. If the value of the EAGE variable is less than 40, process 1600 proceeds to step 1604, at which the value of variable O5 is set to equal zero. Process 1600 then proceeds to 1612, at which the value of variable O5 is stored in a memory location for future use. The process then terminates at 1613.

If the value of the EAGE variable is greater than or equal to 40, process 1600 proceeds to step 1608, at which the value of the current year's beginning of year savings/debt variable F7 is queried to determine if it is greater than or equal to zero. Variable F7 is calculated as depicted in FIGS. 7A and 7B and as further discussed above. If the value of variable F7 is less than zero, process 1600 proceeds to step 1610, at which the value of variable O5 is calculated by multiplying the values of variables F7 and F8. Variable F8 is initially input by the user or an automated processing unit as previously described above. This calculation is only performed if the savings value is negative, implying that money had to be borrowed. If money had to be borrowed, Interest Income/Expense would be an expense in this instance and the borrowing rate is used to calculate the interest expense. Process 1600 then proceeds to 1612, at which the value of variable O5 is stored in a memory location for future use. The process then terminates at 1613.

If, at step 1608, the value of variable F7 is greater than or equal to zero, then process 1600 proceeds to 1614. At step 1614, the value of the EAGE variable is queried to determine if it is greater than 44. If yes, process 1600 proceeds to step 1616, at which the value of variable O5 is calculated by multiplying the values of variables F7 and F2. Process 1600 then proceeds to 1612, at which the value of variable O5 is stored in a memory location for future use. The process then terminates at 1613.

Alternatively, if, at step 1614, the value of the EAGE variable is less than or equal to 44, process 1600 proceeds to step 1620, at which the value of variable O5 is calculated by multiplying the values of variables F7 and the three year savings interest rate non-pension assets variable F4. Process 1600 then proceeds to 1612, at which the value of variable O5 is stored in a memory location for future use. The process then terminates at 1613.

Turning now to FIG. 17, depicted is a process 1700 for calculating the value of the federal and state taxes excluding pension variable (i.e., variable J8). Process 1700 begins at 1701 and proceeds to step 1702, at which the non-pension taxable income variable (i.e., variable I6) is queried. Variable I6 is calculated as discussed in greater detail above with respect to FIG. 15. If it is less than or equal to zero, the value of variable J8 is set to equal zero at 1704. If it is greater than zero, process 1700 proceeds to step 1706 at which the value of variable I6 is queried to determine whether it is greater than zero and less than or equal to the lower bound second tax bracket variable I11. If yes, process 1700 proceeds to step 1708, at which it calculates the value of variable J8 as the sum of State Income Tax (i.e., variable I7) and the result of multiplying the value of variable I6 by the value of the first tax bracket rate variable I4. Process 1700 then proceeds to step 1730. It should be noted that although the non-federal income tax variable (i.e., State Income Tax variable I7) quantifies State Income Tax in the depicted embodiment, this variable may quantify one or more of any non-federal income taxes including, without limitation, state income tax, town income tax, city income tax, county income tax, local income tax, province income tax, and territory income tax.

If, at step 1706, the value of the non-pension taxable income variable I6 is not less than or equal to the value of the lower bound second tax bracket variable I11 and it is greater than zero, then process 1700 proceeds to step 1710, at which it queries the value of variable I6 again to determine if it is greater than the value of variable I11 and it is less than or equal to the value of the lower bound third tax bracket variable I13. If yes, process 1700 proceeds to 1712, at which the value of the federal and state taxes excluding pension variable (i.e., variable J8) is calculated. To calculate variable J8, process 1700 subtracts the value of variable I11 from the value of variable I6 and multiplies the result by the value of the second tax bracket rate variable 110. Then, the product is added to the value of the taxes payable at second bracket lower bound variable I25 and the value of the state income tax variable I7. The resulting value of variable J8 is the sum of state tax and the taxes for the income in the lower tax bracket plus any additional tax due on income in the current tax bracket. It should be noted that in any part of method 1700 in which state taxes are referenced, one or more other forms of non-federal taxes may be substituted for or combined with state taxes including, without limitation, province, town, city, county, local, and territory taxes. Process 1700 then proceeds to step 1730.

If, at step 1710, the value of the non-pension taxable income variable I6 is greater than the value of the lower bound third tax bracket variable I13 or less than or equal to the value of the lower bound second tax bracket variable I11, then process 1700 proceeds to step 1714, at which the value of variable I6 is queried to determine if it is greater than the value of variable I13 and less than or equal to the value of the lower bound fourth tax bracket variable 116. If variable I6 is found to be within this range, process 1700 proceeds to 1716, at which it calculates the value of the federal and state taxes excluding pension variable J8. To calculate variable J8, process 1700 subtracts the value of variable I13 from the value of variable I6 and multiplies the result by the value of the third tax bracket rate variable I14. Then, the product is added to the value of the taxes payable at third bracket lower bound variable I26 and the value of the state income tax variable I7. Process 1700 then proceeds to step 1730.

If, at 1714, the value of variable I6 does not fall in the aforementioned range, process 1700 proceeds to 1720, at which the value of variable I6 is queried to determine if it is greater than the value of variable I16 and less than or equal to the value of the lower bound fifth tax bracket variable I19. If variable I6 is found to be within this range, process 1700 proceeds to 1722, at which it calculates the value of the federal and state taxes excluding pension variable J8. To calculate variable J8, process 1700 subtracts the value of variable I16 from the value of variable I6 and multiplies the result by the value of the fourth tax bracket rate variable 117. Then, the product is added to the value of the taxes payable at fourth bracket lower bound variable I27 and the value of the state income tax variable I7. Process 1700 then proceeds to step 1730.

If, at 1720, the value of variable I6 does not fall in the aforementioned range, process 1700 proceeds to 1724, at which the value of variable I6 is queried to determine if it is greater than the value of variable I19 and less than or equal to the value of the lower bound sixth tax bracket variable I22. If variable I6 is found to be within this range, process 1700 proceeds to 1728, at which it calculates the value of the federal and state taxes excluding pension variable J8. To calculate variable J8, process 1700 subtracts the value of variable I19 from the value of variable I6 and multiplies the result by the value of the fifth tax bracket rate variable I20. Then, the product is added to the value of the taxes payable at fifth bracket lower bound variable I28 and the value of the state income tax variable I7. Process 1700 then proceeds to step 1730.

If, at 1724, the value of variable I6 does not fall in the aforementioned range, process 1700 proceeds to 1725, at which it calculates the value of the federal and state taxes excluding pension variable J8. To calculate variable J8, process 1700 subtracts the value of variable I22 from the value of variable I6 and multiplies the result by the value of the sixth tax bracket rate variable I23. Then, the product is added to the value of the taxes payable at sixth bracket lower bound variable I29 and the value of the state income tax variable I7. Process 1700 then proceeds to step 1730. At 1730, the value of variable J8 is stored for future use. Process 1700 then proceeds to 1732, at which it ends. Variables 125, 126, 127, 128 and 129 are calculated as discussed in greater detail below with reference to FIG. 21.

Turning now to FIG. 18, depicted is a method 1800 for calculating the value of the total income after taxes variable (i.e., variable I8). Process 1800 begins at step 1801 and proceeds to step 1802, at which the value of the income after taxes excluding pension variable (i.e., variable R1) is calculated by subtracting the value of the federal and state taxes excluding pension variable (i.e., variable J8) from the value of the non-pension taxable income variable 16. Variables 16 and J8 are calculated as depicted in FIGS. 15 and 17, respectively, as further discussed above.

Process 1800 then proceeds to step 1804, at which the value of variable I8 is calculated by subtracting the value of the after tax pension withdrawals variable A6 from the value of variable R1. Variable A6 is calculated as depicted in FIGS. 6A and 6B as further discussed above. The calculation of the total income after taxes variable I8 determines the family's entire income including pension income after subtracting all applicable federal and non-federal taxes. Non-federal taxes may include, but are not limited to, one or more of state taxes, town taxes, city taxes, county taxes, local taxes, province taxes, and territory taxes. After variable I8 is calculated, process 1800 proceeds to 1806, at which the value of variable I8 is stored in a memory location for future use. The process then terminates at 1808.

FIG. 19 depicts a method 1900 for calculating the value of the state income tax variable (i.e., variable I7). Although the depicted embodiment calculates the value of the state income tax, alternate embodiments are envisioned for other countries in which the state income tax is replaced or combined with one or more other non-federal income taxes such as town, city, county, local, province, or territory income taxes. Method 1900 begins at step 1901 and proceeds to step 1902, at which the value of the non-pension taxable income variable (i.e., variable I6) is queried. If the value of variable I6 is less than or equal to zero, process 1900 proceeds to step 1904, at which the value of the state income tax variable I7 is set equal to zero. In this manner, the value of the state income tax variable is set to zero because there is no non-pension taxable income. Process 1900 then proceeds to 1906, at which the value of variable I7 is stored in a memory location for future use. The process then terminates at 1907.

If, at step 1902, the value of the non-pension taxable income variable I6 is greater than zero, process 1900 proceeds to step 1908. Step 1908 calculates the value of the state tax rate variable S1 by first dividing the value of variable S3 by the value of variable S2. Then the result is multiplied by the value of variable S4 after it is divided by 1000. Variables S2, S3, and S4 are initially input by the user or an automated processing unit and may be updated periodically by the user or an automated processing unit. The data for variables S2 and S3 may be found on the Web site: http://www.census.gov/govs/estimate/0400ussl_{—}1.html. This Web site lists data from the U.S. Census Bureau for 2003-2004. The user inputs the value listed on the “Taxes” line under the State and Local Government Amount column for variable S2 and the value listed under the same column on the “Individual Income” line for variable S3. Variable S4 is also inputted by the user or an automated processing unit with data from the Web site: http://dor.wa.gov/docs/reports/2006/Compare06/Table1.pdf. The user inputs the value listed on the “U.S. Average” line under 2004 for variable S4. It should be noted that in the depicted embodiment, the non-federal tax rate variable (i.e., state tax rate variable S1) is calculated using data for both state and local taxes. However, alternate embodiments of the present invention are envisioned in which the non-federal tax rate variable includes state taxes only. Or, alternatively, one or more other forms of non-federal tax rate variables such as town, city, county, local, province, or territory tax rate variables may be substituted for or combined with the state tax rate variable without departing from the scope of the present invention.

Step 1908 calculates the State Tax Rate (i.e., variable S1) by finding the proportion of Total State and Local Taxes that are from individual taxes. Then, this fraction is multiplied by Average State and Local Taxes per $1000 Income divided by 1000 to find the U.S. average state and local income tax rate per dollar of income (i.e., variable S1).

Process 1900 then proceeds to step 1910, at which it calculates the value of the state income tax variable (i.e., variable I7) by multiplying the values of the non-pension taxable income variable (i.e., variable I6) and the state tax rate variable (i.e., variable S1), the latter of which is calculated in step 1908. Process 1900 then proceeds to 1912, at which the values of variables 17 and S1 are stored in memory locations for future use. The process then terminates at 1907. It should be noted that alternative methods for estimating the state tax rate variable (i.e., variable S1) could be employed without departing from the scope of the present invention.

Turning now to FIG. 20, depicted is a method 2000 for calculating the values of the consumer price index (“CPI”) inflation rate variables for both three and seven years. Process 2000 begins with step 2001 and proceeds to step 2002, at which the value of the seven year inflation rate variable (i.e., variable M7) is calculated using the values of the most recent CPI variable (i.e., variable T1) and the CPI 7 years ago variable (i.e., variable T2). The value of variable M7 is calculated by taking the geometric average of the CPI index over the past seven years. That is, the value of variable T1 is divided by the value of variable T2 and the resulting value is raised to the one-seventh ( 1/7) power and then reduced by one. Although the depicted embodiment uses a seven (7) year time period to calculate the value of variable M7, shorter or longer time periods may be substituted without departing from the scope of the present invention.

Process 2000 then proceeds to step 2004, at which the value of the three year inflation rate variable (i.e., variable M8) is determined as the geometric average of the CPI index over the past three years. That is, the value of variable T1 is divided by the value of the CPI 3 years ago variable (i.e., variable T3) and the resulting value is raised to the one-third (⅓) power and then reduced by one. Although the depicted embodiment uses a three (3) year time period to calculate the value of variable M8, shorter or longer time periods may be substituted without departing from the scope of the present invention.

In the above calculations of family expenditures, the three year inflation rate is used in calculations in which the value of the EAGE variable is between 41 and 44. When the value of the EAGE variable is greater than 44, the CPI inflation rate is based on the previous seven years. For these values of the EAGE variable, it is more appropriate to use a seven year average to provide a more accurate estimate of inflation for a longer period of time. However, it should be noted that a single average, rather than a three and seven year average, may be substituted without departing from the scope of the present invention. Process 2000 then proceeds to 2006, at which the values of variables M7 and M8 are stored in memory locations for future use. The process then terminates at 2008.

It should be noted that in the exemplary embodiment of the present invention, health care and similar costs are included in family expenditures. However, if significant changes occur in the laws such as the Medicare laws, the calculation of family expenditures may be reworked to account for such changes in the law without departing from the scope of the present invention. Similarly, as other government programs change, such as changes in Social Security or tax laws, the methods of the present invention may be modified as necessary to incorporate such changes without departing from the scope of the present invention.”

The data for Most Recent CPI (i.e., variable T1), CPI 7 Years Ago (i.e., variable T2), and CPI 3 Years Ago (i.e., variable T3) are initially input by the user or an automated processing unit and they are updated on a monthly basis. The data is found via the Web site: http://data.bls.gov/cgi-bin/surveymost?cu. The user checks the box for “U.S. All items, 1982-84 . . . ” and then selects “Retrieve data”. The value listed for the most recent month is input for variable T1; the value listed for the same month seven years prior is inputted for variable T2; and the value listed for the same month three years prior is inputted for variable T3.

Turning now to FIG. 21, depicted is a process 2100 for calculating the values of the taxes payable at the lower bound of each tax bracket. Process 2100 begins with step 2101 and proceeds to 2102, at which the value of the taxes payable at first bracket lower bound (i.e., variable I3) is set to equal zero. At the bottom of the first tax bracket the income will be zero, therefore, the taxes payable will also be zero.

Process 2100 then proceeds to step 2104, at which the value of the taxes payable at second bracket lower bound variable (i.e., variable I25) is calculated by multiplying the first tax bracket rate variable (i.e., variable I4) by the lower bound second tax bracket variable (i.e., variable I11). Process 2100 then proceeds to step 2106, at which the value of the taxes payable at third bracket lower bound variable (i.e., variable I26) is calculated. This calculation is performed by subtracting the value of the lower bound second tax bracket variable I11 from the lower bound third tax bracket variable I13 and multiplying the result by the value of the second tax bracket rate variable I10. The product is then summed with the value of the taxes payable at second bracket lower bound variable I25 to determine the value of variable I26. In this manner, variable I26 includes the taxes payable within the second tax bracket in addition to those payable within the first tax bracket.

Process 2100 then proceeds to step 2108, at which the value of the taxes payable at fourth bracket lower bound variable (i.e., variable I27) is calculated. This calculation is performed by subtracting the value of the lower bound third tax bracket variable I13 from the lower bound fourth tax bracket variable I16 and multiplying the result by the value of the third tax bracket rate variable I14. The product is then summed with the value of the taxes payable at third bracket lower bound variable I26 to determine the value of variable I27. In this manner, variable I27 includes the taxes payable within the first through third tax brackets.

Process 2100 then proceeds to step 2110, at which the value of the taxes payable at fifth bracket lower bound variable (i.e., variable I28) is calculated. This calculation is performed by subtracting the value of the lower bound fourth tax bracket variable I16 from the lower bound fifth tax bracket variable I19 and multiplying the result by the value of the fourth tax bracket rate variable I17. The product is then summed with the value of the taxes payable at fourth bracket lower bound variable I27 to determine the value of variable I28. In this manner, variable I28 includes the taxes payable within the first through fourth tax brackets.

Process 2100 then proceeds to step 2112, at which the value of the taxes payable at sixth bracket lower bound variable (i.e., variable I29) is calculated. This calculation is performed by subtracting the value of the lower bound fifth tax bracket variable I19 from the lower bound sixth tax bracket variable I22 and multiplying the result by the value of the fifth tax bracket rate variable I20. The product is then summed with the value of the taxes payable at fifth bracket lower bound variable I28 to determine the value of variable I29. In this manner, variable I29 includes the taxes payable within the first through fifth tax brackets.

Process 2100 then proceeds to 2114, at which the values of variables 13 and 125 through 129 are stored in a memory location for future use. Process 2100 then proceeds to 2116, at which it terminates. All six tax brackets of the tax code are incorporated in an exemplary embodiment of the present invention. Should the number of tax brackets change in the future, the methodology used to incorporate six tax brackets could be employed to incorporate fewer or more tax brackets without departing from the scope of the present invention.

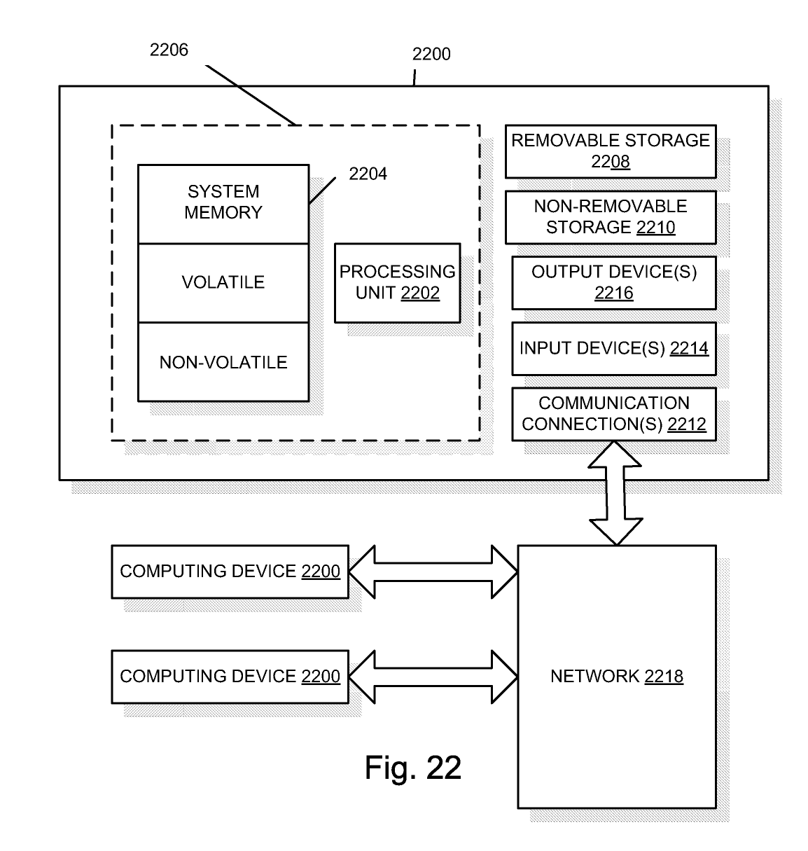

FIG. 22 is set forth herein as an exemplary computing environment in which various embodiments of the present invention may be implemented. The computing system environment is only one example of a suitable computing environment and is not intended to suggest any limitation as to the scope of use or functionality. Numerous other general purpose or special purpose computing system environments or configurations may be used. Examples of well-known computing systems, environments, and/or configurations that may be suitable for use include, but are not limited to, personal computers (PCs), server computers, handheld or laptop devices, multi-processor systems, microprocessor-based systems, network PCs, minicomputers, mainframe computers, embedded systems, distributed computing environments that include any of the above systems or devices, and the like.

Computer-executable instructions such as program modules executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 22, an exemplary system for implementing aspects described herein includes a computing device, such as computing device 2200. In its most basic configuration, computing device 2200 typically includes at least one processing unit 2202 and memory 2204. Depending on the exact configuration and type of computing device, memory 2204 may be volatile (such as random access memory (RAM)), non-volatile (such as read-only memory (ROM), flash memory, etc.), or some combination of the two. This most basic configuration is illustrated in FIG. 22 by dashed line 2206. Computing device 2200 may have additional features/functionality. For example, computing device 2200 may include additional storage (removable and/or non-removable) including, but not limited to, magnetic or optical disks or tape. Such additional storage is illustrated in FIG. 22 by removable storage 2208 and non-removable storage 2210.

Computing device 2200 typically includes or is provided with a variety of computer-readable media. Computer-readable media can be any available media that can be accessed by computing device 2200 and includes both volatile and non-volatile media, removable and non-removable media. By way of example, and not limitation, computer-readable media may comprise computer storage media and communication media.

Computer storage media includes volatile and non-volatile, removable and non-removable media implemented in any method or technology for storage of information such as computer-readable instructions, data structures, program modules or other data. Memory 2204, removable storage 2208, and non-removable storage 2210 are all examples of computer storage media. Computer storage media includes, but is not limited to, RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 2200. Any such computer storage media may be part of computing device 2200.

Computing device 2200 may also contain communications connection(s) 2212 that allow the device to communicate with other devices. Each such communications connection 2212 is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both storage media and communication media.

Computing device 2200 may also have input device(s) 2214 such as keyboard, mouse, pen, voice input device, touch input device, etc. Output device(s) 2216 such as a display, speakers, printer, etc. may also be included. All these devices are generally known to the relevant public and therefore need not be discussed in any detail herein except as provided.

Notably, computing device 2200 may be one of a plurality of computing devices 2200 inter-connected by a network 2218, as is shown in FIG. 22. As may be appreciated, the network 2218 may be any appropriate network, each computing device 2200 may be connected thereto by way of a connection 2212 in any appropriate manner, and each computing device 2200 may communicate with one or more of the other computing devices 2200 in the network 2218 in any appropriate manner. For example, the network 2218 may be a wired or wireless network within an organization or home or the like, and may include a direct or indirect coupling to an external network such as the Internet or the like. Likewise, the network 2218 may be such an external network.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter.

In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application-program interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language, and combined with hardware implementations.

Although exemplary embodiments may refer to utilizing aspects of the presently disclosed subject matter in the context of one or more stand-alone computer systems, the subject matter is not so limited, but rather may be implemented in connection with any computing environment, such as a network 2218 or a distributed computing environment. Still further, aspects of the presently disclosed subject matter may be implemented in or across a plurality of processing chips or devices, and storage may similarly be effected across a plurality of devices in a network 2218. Such devices might include personal computers, network servers, and handheld devices, for example.

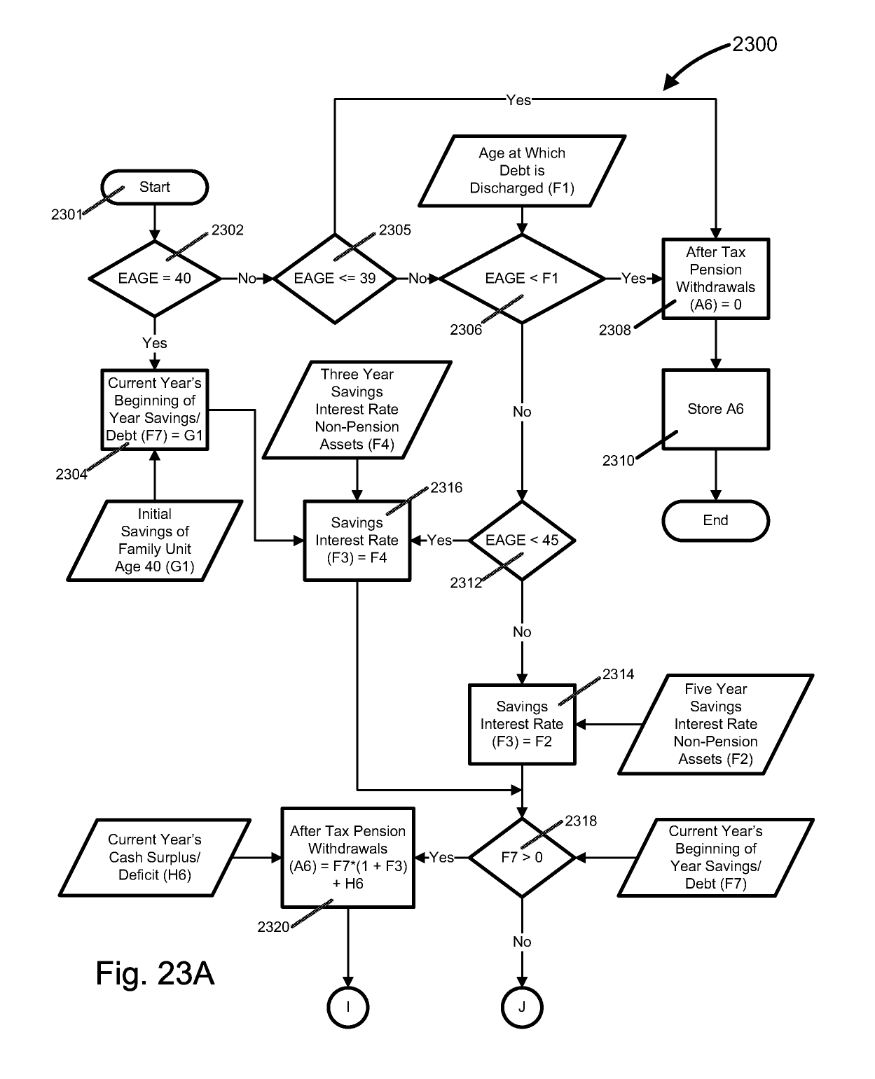

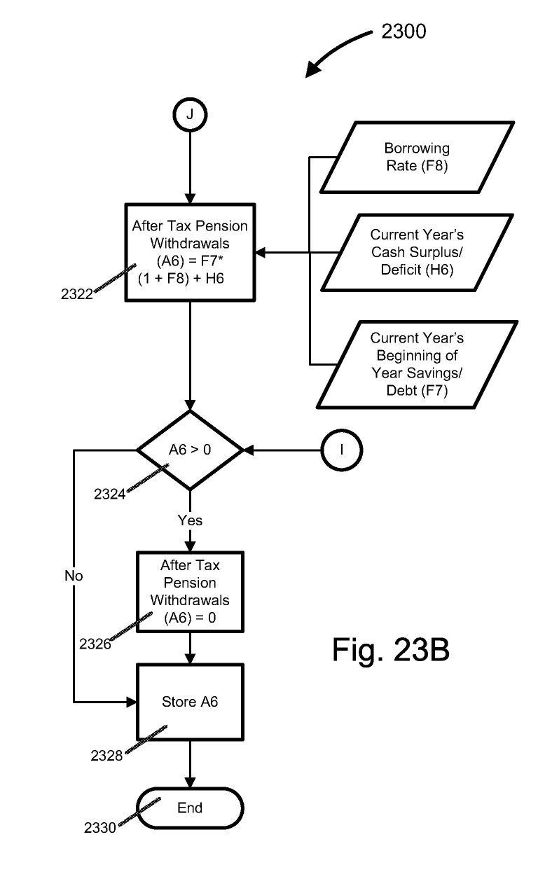

Turning now to FIGS. 23A-B and 24A-B, depicted are alternate processes 2300 and 2400 that may be substituted for processes 600 and 700, respectively, to implement an alternate embodiment of the present invention that allows a couple to have a positive value for the Current Year's Beginning of Year Savings/Debt variable (i.e., variable F7) after a first after-tax pension withdrawal occurs. This embodiment is in contrast to the embodiment of the present invention described in FIGS. 1-22 above, which does not allow a positive value to occur for this variable at any age after which an after-tax pension withdrawal has occurred. That is, in the embodiment of the present invention depicted in FIGS. 1-22, after a couple begins withdrawing from their pension, the value of the Current Year's Beginning of Year Savings/Debt variable will be equal to zero. In contrast, the alternate embodiment utilizing processes 2300 and 2400 in lieu of 600 and 700, respectively, allows this variable to be positive after an after-tax pension withdrawal has occurred to accommodate, for example, receipt of large monetary gifts and/or inheritances.

Turning now to FIGS. 23A and 23B, depicted is an alternate method for calculating the value of the After Tax Pension Withdrawals variable (i.e., variable A6) in accordance with the alternate embodiment of the present invention described above. Process 2300 is substantially identical to and operates in substantially the same manner as process 600 as described in greater detail above with respect to FIGS. 6A and 6B with the exception that the actions performed relating to the After Tax Pension Withdrawal Yes variable (i.e., variable F10) have been eliminated. That is, the differences between process 2300 and 600 occur subsequent to step 2324 (which is substantially identical to step 624 of FIG. 6B as described above), wherein process 2300 determines whether the value of variable A6 is greater than zero.

In process 2300, if the value of the After Tax Pension Withdrawals variable A6 is greater than zero, process 2300 continues directly to step 2326 (which is substantially identical to step 626 of FIG. 6B as described above), at which the value of the After Tax Pension Withdrawals variable (i.e., variable A6) is set to equal zero. If a positive value for the After Tax Pension Withdrawals variable is initially determined (i.e., as calculated in steps 2320 and 2322), then this indicates that no money must be withdrawn from a couple's pension and the value of A6, therefore, must be set to zero.

Alternatively, if step 2324 determines that the value of variable A6 is not greater than zero, process 2300 proceeds directly to step 2328, at which the value of variable A6 is stored. Thereafter, process 2300 terminates at 2330. As discussed in further detail below with respect to process 2400, the After Tax Pension Withdrawal Yes variable F10 is unnecessary in this embodiment of the present invention and, therefore, process 2300 may proceed directly from determining if the value of variable A6 is greater than zero to the steps for either modifying or storing the value of variable A6 without the need to utilize or set a Previous Year's Pension Withdrawal Yes variable such as variable F10 of process 600.

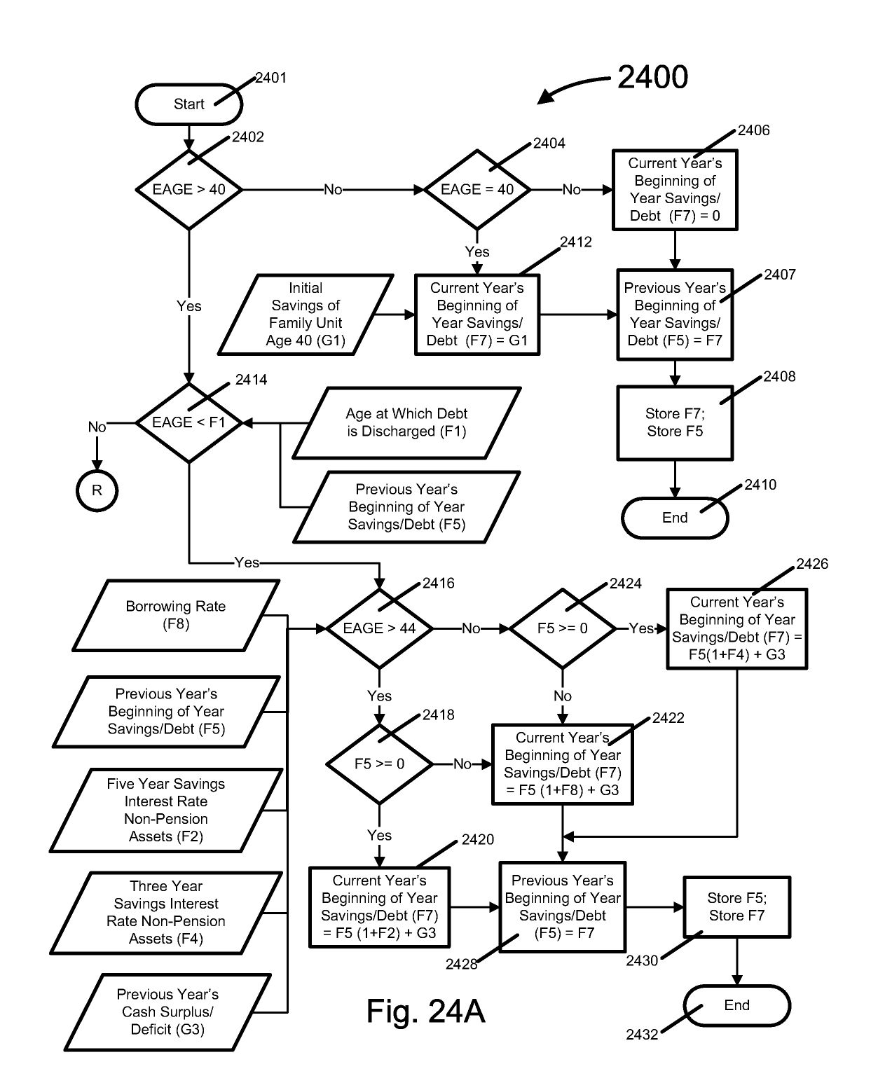

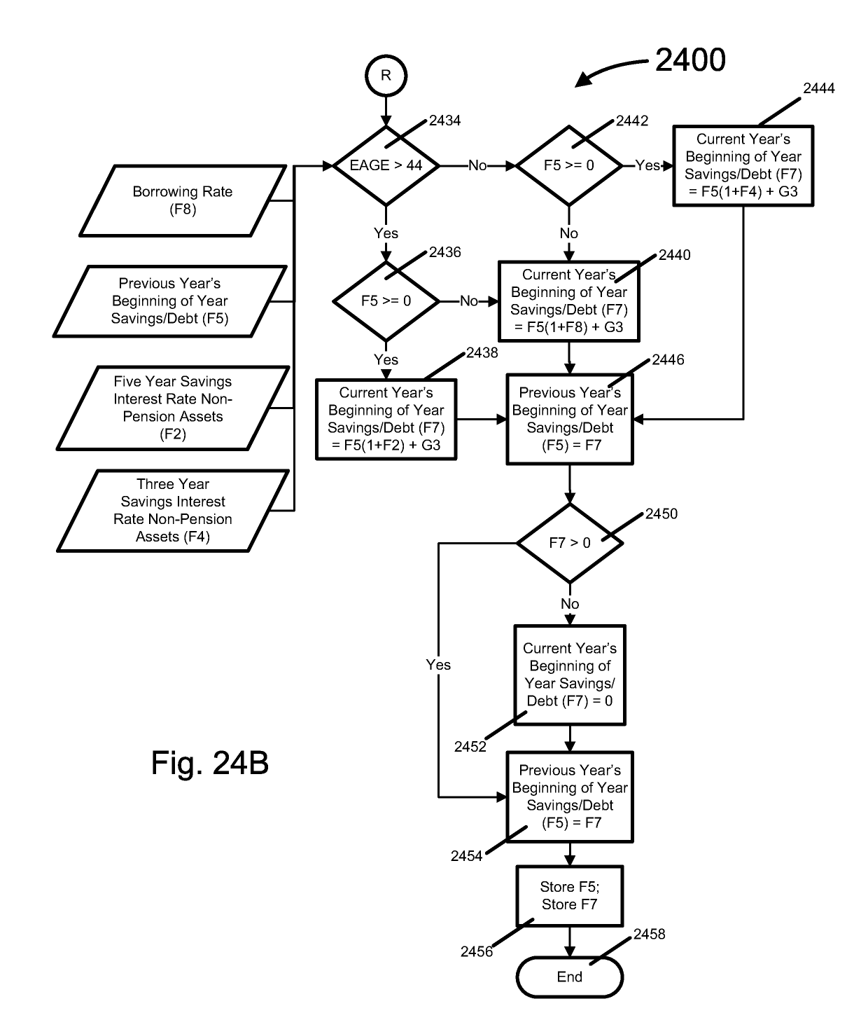

Turning now to FIGS. 24A and 24B, depicted is an alternate method for calculating the value of the Current Year's Beginning of Year Savings/Debt variable (i.e., variable F7) in accordance with the alternate embodiment of the present invention described above. Process 2400 is substantially identical to and operates in substantially the same manner as process 700 as described in greater detail above with respect to FIGS. 7A and 7B with the exception that the action performed relating to the After Tax Pension Withdrawal Yes variable (i.e., variable F10) has been eliminated. That is, the differences between process 2400 and 700 occur subsequent to step 2446 (which is substantially identical to step 746 of FIG. 7B as described above), wherein process 2400 sets the value of variable F5 equal to the value of the variable F7.

Process 2400 then proceeds to 2450, at which the value of the variable F7 is queried to determine whether it is greater than zero. Step 2450 is substantially identical to step 750 of FIG. 7B as described in detail above. After step 2450, steps 2452 through 2458 are completed. These steps are substantially identical to steps 752 through 758 of FIG. 7B as also described in detail above. Therefore, the only difference between process 2400 and 700 is the elimination of step 748 in the former. That is, since the After Tax Pension Withdrawal Yes variable F10 is unnecessary in this embodiment of the present invention, process 2400 may proceed directly from step 2446 to step 2450 without the need to utilize or set a Previous Year's Pension Withdrawal Yes variable such as variable HO of process 600. In this manner, the alternate embodiment of the present invention allows the value of the Current Year's Beginning of Year Savings/Debt variable to be positive after a first after-tax pension withdrawal occurs.

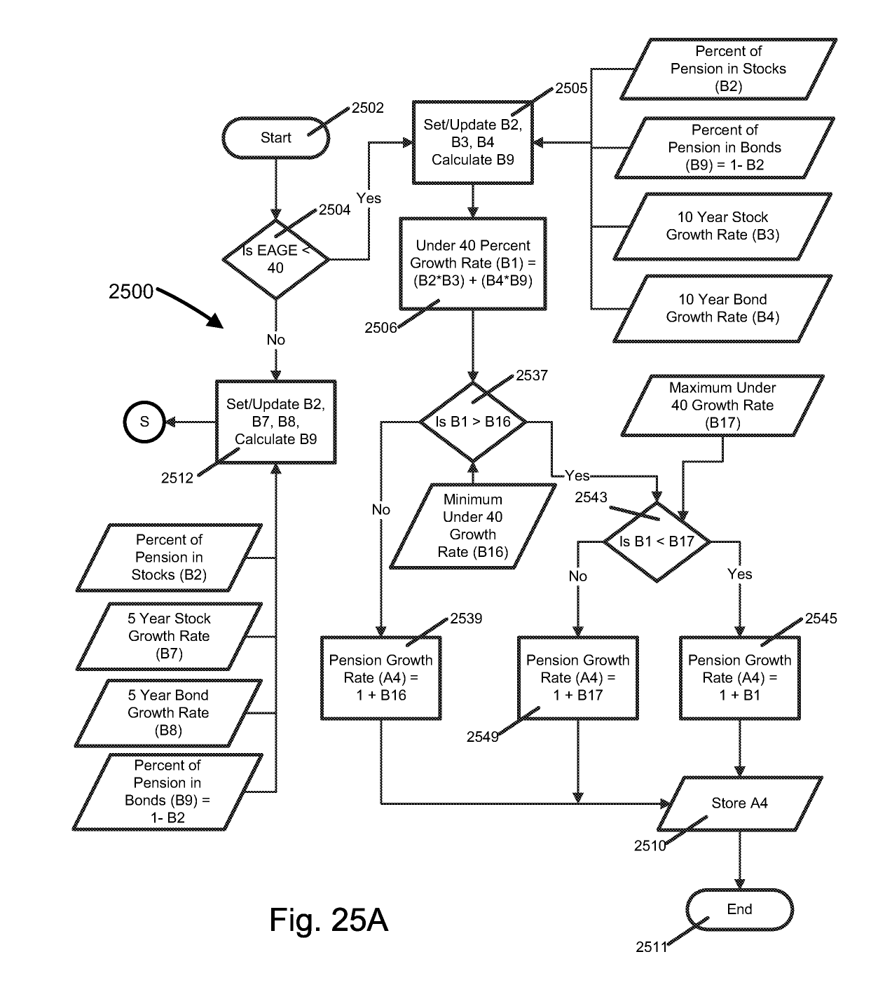

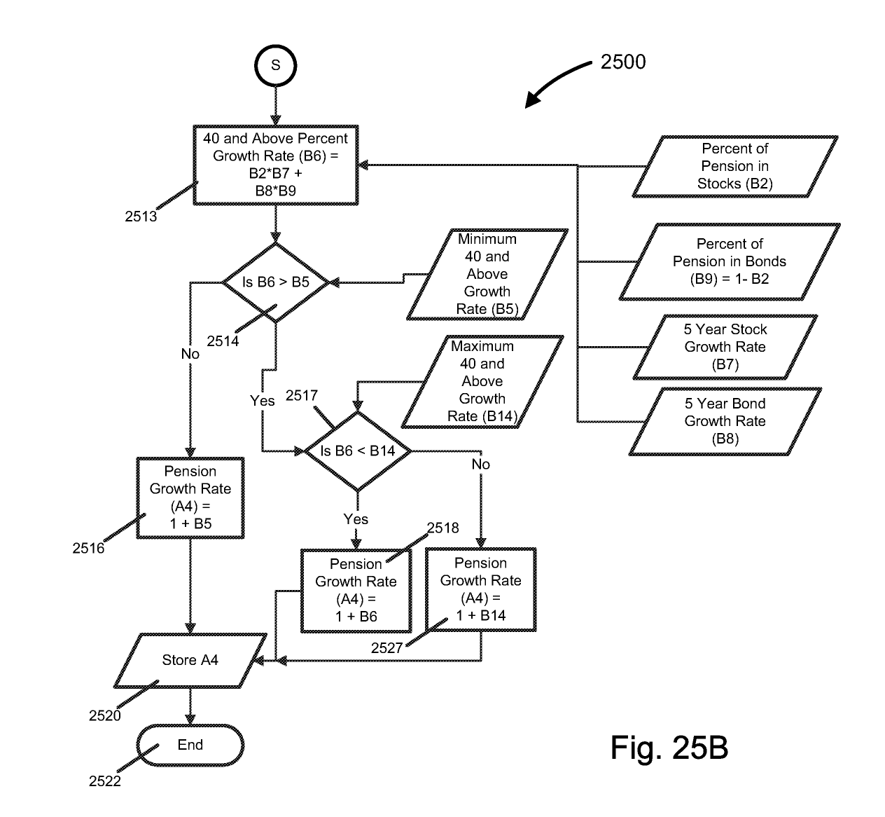

Referring next to FIGS. 25A and 25B, depicted is an alternate process 2500 for calculating the value of the Pension Growth Rate variable (i.e., variable A4) in accordance with an alternate embodiment of the present invention described above. Process 2500 is substantially identical to and operates in substantially the same manner as process 200 as described in greater detail above with respect to FIG. 2 with the exception that minimum and maximum values are implemented for the pension growth rate to account for dramatic increases or decreases in the stock and/or bond markets. In the depicted embodiment, different minimum and maximum growth rates are depicted for use when the value of the EAGE variable is less than 40 and when the value for the EAGE variable is equal to or greater than 40. However, alternate embodiments are envisioned in which the same minimum and maximum values are used for all EAGE values.

As discussed above, the pension growth rate is indicative of the return rate on stocks and bonds. Process 2500 begins at 2502 from which it proceeds to 2504. At 2504, process 2500 queries the value of the EAGE variable to determine if it is less than forty. If yes, process 2500 proceeds to 2505, at which the values of the variables B2, B3, and B4 are initially set or are updated with the latest available data, as described in greater detail above with regards to FIG. 2, and the value of B9 is calculated.

Once the values of variables B2, B3, and B4 have been set, or updated, and B9 has been calculated as described above with respect to FIG. 2, process 2500 proceeds to step 2506. At 2506, the value of the under 40 percent growth rate variable (i.e., variable B1) is calculated by summing weighted stock and bond growth rates. The weighted value for stock growth is determined by multiplying the percent of pension in stocks variable B2 by the 10 year stock growth rate variable B3. The weighted value for bond growth is determined by multiplying the percent of pension in bonds variable B9 by the 10 year bond growth rate variable B4.

After the under 40 percent, growth rate is determined at 2506, process 2500 proceeds to 2537, at which the value of the under 40 percent growth rate variable B1 is compared to the value of the minimum under 40 growth rate variable (i.e., variable B16). In the exemplary embodiment of the present invention, the value of the minimum under 40 growth rate variable B1 (i.e., for persons under forty years of age) is set to 0.02, or 2%. This value is used to prevent an unrealistic pension plan growth rate from being applied by process 2500 when the value of the EAGE variable is less than forty. Such an unrealistic growth rate could occur, for example, if the stock market were to decrease dramatically. Although 2% is used in the exemplary embodiment, other minimum growth rates may be substituted without departing from the scope of the present invention.

If the value of the under 40 percent growth rate variable B1 is less than or equal to the minimum under 40 growth rate variable B16, process 2500 proceeds to 2539. At 2539, the value of the pension growth rate variable A4 is calculated by adding 1 to the value of the minimum under 40 growth rate variable B16. Process 2500 then proceeds to 2510, at which the value of variable A4 is stored in a memory location for future use. Process 2500 then ends at 2511.

Alternatively, if the value of the under 40 percent growth rate variable B1 is greater than the minimum under 40 growth rate variable B16, process 2500 proceeds to 2543. At 2543, the value of the under 40 percent growth rate variable B1 is compared to the value of the maximum under 40 growth rate variable B17. In the exemplary embodiment of the present invention, the value of the maximum under 40 growth rate for persons under forty years of age is set to 0.08, or 8%. This value is used to prevent an unrealistic pension plan growth rate from being applied by process 2500 when the value of the EAGE variable is less than forty. Such an unrealistic growth rate could occur, for example, if the stock market were to increase dramatically. Although 8% is used in the exemplary embodiment, other maximum growth rates may be substituted without departing from the scope of the present invention.

If, at 2543, the value of the under 40 percent growth rate variable B1 is greater than or equal to the value of variable B17, process 2500 proceeds to 2549, at which the value of the pension growth rate variable A4 is calculated by adding 1 to the value of the maximum under 40 growth rate variable B17. Process 2500 then proceeds to 2510, at which the value of variable A4 is stored in a memory location for future use. Process 2500 then ends at 2511.

Alternatively, if, at 2543, the value of the under 40 percent growth rate variable B1 is less than the value of the maximum under 40 growth rate variable B17, then process 2500 proceeds to 2545. At 2545, the value of the pension growth rate variable A4 is calculated by adding 1 to the value of the under 40 percent growth rate variable B1. Process 2500 then proceeds to 2510, at which the value of variable A4 is stored in a memory location for future use. Process 2500 then ends at 2511.

Alternatively, if at 2504, the value of the EAGE variable is greater than or equal to forty, process 2500 proceeds to 2512. At 2512, the values of the variables B2, B7, and B8 are initially set or are updated with the latest available data, as described in greater detail above with regards to FIG. 2, and the value of B9 is calculated.

Once the values of variables B2, B7, and B8 have been set, or updated, and B9 has been calculated as described above with respect to FIG. 2, process 2500 proceeds to step 2513 as depicted in FIG. 25B. At 2513, the value of the 40 and above percent growth rate variable (i.e., variable B6) is calculated by summing weighted stock and bond growth rates. When the value of the EAGE variable is greater than or equal to forty, the weighted value for stock growth is determined by multiplying the percent of pension in stocks variable B2 by the 5 year stock growth rate variable B7, and the weighted value for bond growth is determined by multiplying the percent of pension in bonds variable B9 by the 5 year bond growth rate variable B8. That is, at 2513, the value of the 40 and above percent growth rate variable is calculated similar to the manner in which the under 40 percent growth rate value is calculated. However, the 40 and above percent growth rate utilizes 5 year data averages in lieu of 10 year data averages.

After the 40 and above percent growth rate is determined at 2513, process 2500 proceeds to 2514, at which the value of the 40 and above percent growth rate variable B6 is compared to the value of a minimum 40 and above growth rate variable (i.e., variable B5). In the exemplary embodiment of the present invention, the value of the minimum growth rate for persons forty and above is set to 0.03, or 3%. This value is used to prevent an unrealistic pension plan growth rate from being applied by process 2500 when the value of the EAGE variable is greater than or equal to forty. Such an unrealistic growth rate could occur, for example, if the stock market were to decrease dramatically. Although 3% is used in the exemplary embodiment, other minimum growth rates may be substituted without departing from the scope of the present invention.

If, at 2514, the value of the 40 and above percent growth rate variable B6 is greater than the value of the minimum 40 and above growth rate variable B5, process 2500 proceeds to 2517. At 2517, the value of the 40 and above percent growth rate variable B6 is compared to the value of the maximum 40 and above growth rate variable (i.e., variable B14). In the exemplary embodiment of the present invention, the value of the maximum 40 and above growth rate for persons over or equal to forty years of age is set to 0.06, or 6%. This value is used to prevent an unrealistic pension plan growth rate from being applied by process 2500 when the value of the EAGE variable is greater than or equal to forty. Such an unrealistic growth rate could occur, for example, if the stock market were to increase dramatically. Although 6% is used in the exemplary embodiment, other maximum growth rates may be substituted without departing from the scope of the present invention.

If the value of B6 is greater than or equal to the value of B14, then process 2500 proceeds to 2527. At 2527, the value of the pension growth rate variable A4 is calculated by adding 1 to the value of the maximum 40 and above growth rate variable B14. Process 2500 then proceeds to 2520, at which the value of variable A4 is stored in a memory location for future use and process 2500 ends at 2522.

Alternatively, if, at 2517, the value of the 40 and above percent growth rate variable B6 is less than the value of the maximum 40 and above growth rate variable B14, process 2500 proceeds to 2518. At 2518, the value of the pension growth rate variable A4 is calculated by adding 1 to the value of the 40 and above percent growth rate variable B6. Process 2500 then proceeds to 2520, at which the value of variable A4 is stored in a memory location for future use and process 2500 ends at 2522.

If, at 2514, the value of the 40 and above percent growth rate variable B6 is less than or equal to the value of the minimum 40 and above growth rate variable B5, process 2500 proceeds to 2516. At 2516, the value of the pension growth rate variable A4 is calculated by adding 1 to the value of the minimum 40 and above growth rate variable B5. Process 2500 then proceeds to 2520, at which the value of variable A4 is stored in a memory location for future use and process 2500 ends at 2522. It should be noted that a single average, rather than a five and ten average, may be substituted without departing from the scope of the present invention.

It should be noted that although the exemplary embodiment of the present invention discussed above uses calculated values for variables such as C11 (i.e., Overall Percent Contribution), D6 (i.e., Seven Year Wage Inflation Rate), D7 (i.e., Three Year Wage Inflation Rate), F2 (i.e., Five Year Savings Interest Rate Non-Pension Assets), F4 (i.e., Three Year Savings Interest Rate Non-Pension Assets), M8 (i.e., Three Year Inflation Rate), and M7 (i.e., Seven Year Inflation Rate), the present invention may be modified to include minimum and maximum values for one or more of such variables (or any other calculated variable) without departing from the scope of the present invention. That is, if the calculated value of a variable is determined to be above or below a corresponding maximum or minimum value, respectively, the value of the variable is set to the maximum or minimum value, respectively, rather than the calculated value. One manner of doing this is as described above with respect to FIGS. 25A and 25B for the under 40 percent growth rate and 40 and above percent growth rate variables B1 and B6, respectively. Minimum and maximum values may be used, for example, to ensure the accuracy of the model in the case of an unforeseen or atypical event.

Although the present invention has been described herein utilizing wages, interest income, social security benefits, and pension withdrawals as the sole sources of income, alternate embodiments of the present invention are envisioned that include a lesser or greater quantity of income sources or that include varying sources of income including, but not limited, self-employment income.

Furthermore, although the embodiments of the present invention described above calculate an average retirement age index for the U.S., the average retirement age index for any country may be calculated by simply substituting the desired country's data for the U.S. data cited herein.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A method for calculating an average retirement age index of a country comprising the steps of:
calculating, using a microprocessor, a wealth at death of an average couple living in said country for a first retirement age, said determining including the sub-steps of:
setting, using a microprocessor, an average employment age of said average couple to a first age value;
setting, using a microprocessor, an average retirement age of said average couple to a second age value;
setting, using a microprocessor, an age of death of said average couple to a third age value;
calculating, using a microprocessor, a cumulative combined pension of said average couple for each age of said average couple beginning with said first age value and ending with said third age value, said calculating performed upon cumulative combined pension data, at least a portion of said cumulative combined pension data selected from the group consisting of a contribution to pension of said average couple, a growth rate of said pension, withdrawals from said pension, and combinations thereof, at least a portion of said cumulative combined pension data derived from statistical data for an average family living in said country; and
calculating, using a microprocessor, a wealth at death value at said third age value based upon said calculated cumulative combined pension and said statistical data for said average family; and
decreasing said retirement age by one;
repeating said calculating said wealth at death value step and said decreasing said retirement age by one step until said wealth at death value is less than zero to determine a year prior to a year of said average retirement age index; and
determining said year of said average retirement age index by adding one to said year prior to said year of said average retirement age index;
wherein an initial value of said second age value is equal to said third age value.

2. A method according to claim 1 further comprising the step of:
determining a week of said average retirement age index via the following sub-steps:
calculating a wealth delta by subtracting said wealth at death value for said year prior to said year of said average retirement age index from said wealth at death value for said year of said average retirement age index;
dividing an opposite of said wealth at death value for said year prior to said year of said average retirement age index by said wealth delta to calculate a week divisor; and
multiplying said week divisor by fifty-two.

3. A method according to claim 1,
wherein said contribution to pension of said average couple for said each age of said average couple is calculated by summing one or more employee pension contributions with one or more employer contributions, said one or more employee pension contributions calculated based upon statistical pension and social security contribution data for said average family and statistical wage data for said average family, said one or more employer contributions calculated based upon statistical employer contribution data and said statistical wage data for said average family; and
wherein said statistical wage data for one or more of said age of said average couple is adjusted for inflation using one or more inflation adjustment values to create calculated inflation adjusted wage values.

4. A method according to claim 3, wherein said one or more inflation adjustment values are calculated based upon inflation adjustment data selected from the group consisting of a recent wage index for said country, a three year wage index for said country, a seven year wage index for said country, and
combinations thereof.

5. A method according to claim 1, wherein said growth rate of said pension for said each age of said average couple is calculated using a stock growth rate, a bond growth rate, at least one minimum growth rate, at least one maximum growth rate, said stock growth rate selected from the group consisting of a statistical five year stock growth rate and a statistical ten year stock growth rate for said each age of said average couple, said bond growth rate selected from the group consisting of a statistical five year bond growth rate and a statistical ten year bond growth rate of each age of said average couple.

6. A method according to claim 3, wherein said withdrawals from said pension for said each age of said average couple is calculated by summing after tax pension withdrawals and marginal tax on pension income.

7. A method according to claim 6, wherein said after tax pension withdrawal for said each age of said average couple is calculated based upon after tax pension withdrawal data, at least a portion of said after tax pension withdrawal data selected from the group consisting of statistical savings data for said average family, an assumed age at which debt is discharged for said average family, statistical five year savings interest rate data for said average family, statistical three year savings interest rate data for said average family, statistical borrowing interest rate data for said average family, a cash surplus/deficit value, and combinations thereof.

8. A method according to claim 7, wherein said cash surplus/deficit value for one or more of said age of said average couple is calculated based upon cash surplus/deficit data selected from the group consisting of said calculated inflation adjusted wage values, calculated social security benefits data, said employee pension contributions, social security taxes, calculated inflation adjusted expenditures data, federal income taxes, non-federal income taxes, and combinations thereof.

9. A method according to claim 8, wherein said non-federal income taxes include at least one of the group consisting of state income taxes, town income taxes, city income taxes, county income taxes, local income taxes, territory income taxes, and province income taxes.

10. A method according to claim 8, wherein said social security benefits data for one or more of said age of said average couple is adjusted using one or more of said inflation adjustment values.

11. A method according to claim 6, wherein said marginal tax on pension income is calculated by subtracting federal income taxes for non-pension income and non-federal income taxes for non-pension income from total taxes on total income.

12. A method according to claim 11, wherein said non-federal income taxes include at least one of the group consisting of state income taxes, town income taxes, city income taxes, county income taxes, local income taxes, territory income taxes, and province income taxes.

13. A method according to claim 8, wherein said calculated inflation adjusted expenditures data for said each age of said average couple is calculated by adjusting statistical family expenditures data for said country for inflation using one or more inflation adjustment values.
